(19) United States
(12) Patent Application Publication
(10) Pub. No.: US 2010/0278453 A1
(43) Pub. Date: Nov. 4, 2010

(54) CAPTURE AND DISPLAY OF ANNOTATIONS IN PAPER AND ELECTRONIC DOCUMENTS

(76) Inventor: Martin T. King, Vashon Island, WA (US)

Correspondence Address: Perkins Coie, LLP, P.O. Box 1247, Seattle, WA, 98111, US

(21) Appl. No.: 12/517,353

(22) PCT Filed: Sep. 17, 2007
(86) PCT No.: PCT/EP07/08075

§ 371 Date: Jul. 12, 2010

Related U.S. Application Data
(60) Provisional application No. 60/844,893, filed on Sep. 15, 2006.
(60) Provisional application No. 60/910,438, filed on Apr. 5, 2007.

(51) Int. Cl. G06F 17/00; G06K 7/10

(52) U.S. Cl. 382/321; 715/230

(57) ABSTRACT

A software and/or hardware facility that enables users to associate annotations with text segments contained in digital content. A capture client allows users to create annotations associated with text segments on content being viewed by the user. The annotations are stored in association with the text segments by an annotation server. When a user subsequently views content, text fragments in the viewed content are compared with the stored text segments by the facility. Text segments that are found to match the text fragments are identified by the facility, and the associated annotations displayed to the user on the viewed content by a display client. Because stored annotations are associated with a text segment, rather than the original content or an identifier associated with the original content from which the text segment was identified, annotations are able to be applied to any content that utilizes the text segment in the future.

### PRIORITY CLAIM

This application claims priority to U.S. Provisional Application No. 60/844,893 filed on Sep. 15, 2006 and U.S. Provisional Application No. 60/910,438 filed on Apr. 5, 2007, each of which is hereby incorporated by reference in its entirety.

### TECHNICAL FIELD

The disclosed technology relates to the field of annotations.

### BACKGROUND

Readers of printed works, such as books, newspapers, and magazines, have always had the ability to draw attention to portions of publications by writing annotations directly on the works. The annotations could be as simple as highlighting sections of text using underlining, circling, or a highlighter pen, thereby drawing a reader's attention to that portion of the text which appears in a different color or is otherwise distinguished from the rest of the work. Readers could also add more complex annotations, such as by writing text or drawing figures in the margins or other areas of the work. Annotations are particularly useful to the reader that recorded the annotations, as the annotations allow the reader to quickly recall important passages or ideas that are contained within a work. Annotations may also be beneficial to other readers of the work, as the additional information that is added to the work by the annotations may provide greater context to or indicate relative importance of portions of the work. For many readers, the ability to create and record annotations in printed material is therefore integral to being able to enjoy the use of the material.

Unfortunately, as more and more documents are created in or converted to digital form, the ability to annotate documents in a simple and meaningful way has become increasingly difficult. One cause of the difficulty is the challenge of providing a user interface that allows a reader to easily add annotations to a digital document. Since annotations are typically scrawled in margins and other blank spaces on a document, adding them to a digital document can be particularly challenging. A second cause of the difficulty is the challenge of maintaining a relationship between the annotation and the document on which the annotation is made. Documents in digital form can be easily changed, with portions being excised, copied, moved, and stored to a large number of different locations. Different versions of documents may exist, with earlier documents lacking annotations that are added to later documents. And documents in digital form can be easily (and sometimes inadvertently) deleted. Tracking documents and ensuring that annotations remain associated with the documents as the documents are constantly being modified is therefore a very challenging problem. Yet another cause of the difficulty is the wide variety of platforms in which a document may be viewed and manipulated. Readers may use personal computers, handheld computers, mobile devices, and dedicated reading devices in order to view digital documents. Each of the platforms may support a variety of software to allow a user to read, write, and edit documents. Developing cross-platform software that operates on each of these platforms, works with a wide range of software, and captures and displays annotations in a consistent and easy to use format is a challenging technical proposition. As a result, it would therefore be beneficial if ubiquitous annotation technology was developed to allow users to create and use annotations in the digital world as easily as they do in the physical world.

### BRIEF DESCRIPTION OF THE DRAWINGS

FIG. 1 is a block diagram of a facility for capturing and displaying annotations of content.

FIG. 2 is a screen shot of a user interface depicting the annotation to content.

FIGS. 3A and 3B are flow charts of a process of capturing annotations of a user at a capture client and storing annotations of a user at an annotation server.

FIGS. 4A and 4B are flow charts of a process of identifying annotations associated with content at the annotation server and displaying the identified annotations in association with the content at a display client.

FIG. 5 is a flow diagram showing steps typically performed by the system in order to perform an action in response to a user's capturing of a keyword.

FIG. 6 is a table diagram showing sample contents of the keyword action table.

FIG. 7 is a table diagram showing sample contents of a document action map for particular document.

### DETAILED DESCRIPTION

### Overview

A software and/or hardware facility that enables users to associate annotations with one or more words of content in a digital content is described. A capture client allows users to create annotations each associated with a text segment in content being viewed by the user called the “subject text” for the annotation. The annotations are stored in association with the subject text by an annotation server. When a user subsequently views content, the facility compares the viewed content with the stored annotation subject text. Where an annotation's subject text is found to match the viewed content, a display client displays the associated annotations to the user together with the viewed content.

In various embodiments, the facility uses various approaches to “anchor” each annotation to the associated subject text. In some embodiments, when the identity of a location in the document to which the annotation is being attached are both known, the facility anchors the annotation by storing this document identity, together with the location of the document, such as by storing the word offset from the beginning of the document.

In some embodiments, and particularly where the document identity and location are not both known, the facility anchors a new annotation by storing anchor text for the annotation. The anchor text for an annotation typically includes the subject text for the annotation. In some embodiments, the anchor text extends beyond the subject text in one or both directions. In these embodiments, because stored annotations are associated with anchor text segment, rather than the original content or an identifier associated with the original content from which the text segment was identified, annotations are able to be applied to any content that utilizes the text segment in the future. For example, if a document is copied in its entirety, or if a section of a document is copied, all annotations associated with the copied portion will be appropriately placed in the future because the annotations are associated with text segments in the document rather than the document itself. The disclosed facility thereby greatly improves the flexibility of using annotations in digital content.

In some embodiments, a presentation-layer capture client is provided to allow a user to add an annotation to content regardless of the format of the content being viewed by the user. For example, content may be displayed to a user on a web page, in a word processing document, in a .PDF document, as an image, or in other graphical or textual form. Rather than attempt to design an interface to each of these content formats, the facility relies upon a capture of the display depicting the content and a conversion of the captured image into text using optical character recognition (OCR) technology. Specifically, all or portions of the screen buffer of the viewing device used by the user are captured by the facility. The contents of the screen buffer are provided to an OCR component which processes the captured image and generates the corresponding text of any characters that are contained in the image. The facility automatically maps any content selected for annotation purposes by a user to the OCR text identified by the facility. In this fashion, the facility allows a user to annotate any content regardless of the format of the content.

In some embodiments, a hand-held optical scanner having voice input capability may be used as a capture client. In order to create an annotation with such a capture client, the user uses the hand-held scanner to optically capture the subject text to count on and speaks the content of the annotation. The facility uses voice recognition techniques to transform the spoken annotation into its symbolic text equivalent, which the facility then associates with the captured subject text.

In some embodiments, a presentation-layer display client is provided to allow annotations to be overlaid on any content regardless of format. When a user views content on a viewing device, all or portions of the screen buffer of the viewing device are captured by the facility. The contents of the screen buffer are provided to an OCR component which processes the captured image and, generates the corresponding text of any characters that are contained in the image. The facility identifies one or more text fragments in the captured text, and transmits a representation of the text fragments to the annotation server. The facility compares the received text fragments with the stored text segments, and identifies any stored text segments that match the received text fragments. Annotations corresponding to the matched text fragments are identified by the facility and transmitted to the display client. The display client determines the appropriate location of the annotations based on the location of the matched text fragments, and displays the annotations in a semi-transparent layer that is superimposed over the content that the user is viewing. In this fashion, annotations may be displayed to a user on any content regardless of the format of the content being viewed.

In some embodiments, where the operating system and/or the applications displaying text provide programmatic interfaces for supplying the text currently being displayed, mapping between displayed text and its display location, etc., the facility uses these interfaces to avoid the overhead of using OCR techniques to identify displayed text and its display location. Similarly, where programmatic interfaces are available to identify a document being displayed and a portion of the document currently displayed, the facility uses information obtained via these interfaces to associate displayed text with the underlying electronic document and position.

In some embodiments, the facility supports attaching a wide variety of types of associations other than annotations to portions of electronic documents. In various embodiments, the facility supports the creation, display and interaction with these associations using a wide variety of mechanisms, including those described herein in connection with annotations. By supporting these annotations, the facility provides a rich, cross-document and cross-platform level of interactivity with electronic documents. In some embodiments, the facility supports similar or the same associations for users of a text capture device. In these embodiments, the facility provides a rich, common experience for readers reading both paper and electronic documents.

In some embodiments, the facility uses its observations of text displayed on a monitor together with text captured by a hand-held text capture device to maintain a universal reading history for a user that potentially records all of the text read by the user with indications of the time at which it was read. In some embodiments, the facility provides a visual user interface for exploring this reading history such as a historical sequence of document thumbnails or bibliographic information about each document read. In some embodiments, the user can drill into one of these documents to see a visual map over time of the portions of the document that the user read.

In some embodiments, a security component is provided in the capture client and in the display client so that the annotation server is not provided with user-identifiable details of the content that the user is viewing. Instead, an encrypted, hashed, or other protected form of the text segment or text fragment is communicated with or stored by the annotation server. Storing a secure form of the text ensures that there is no user-readable record maintained by the annotation server of the content viewing habits of the user. The security component helps prevent the facility from being used in a manner that might be construed as an invasion of privacy of the user. Depending on the desired distribution of the annotation, the annotation may also be communicated and stored in an encrypted, hashed, or otherwise protected form.

By storing the annotation in association with the text segments and anchor text, the annotation becomes disassociated from the identity of the original source content to which it was added. For example, if an annotation was added by a user to a digital copy of a book, when the annotation is stored by the annotation server the identity of the book, would not be stored. When the user or other parties view the digital copy of the book in the future, any annotations stored by the user are identified by evaluating the text of the book and matching the text of the book with the stored text segments and anchor text. The disclosed method of annotation storage is therefore significantly different from traditional methods which associate the annotation with a particular document.

### Details

The following description provides specific details for a thorough understanding of, and enabling description for, various embodiments in the technology. One skilled in the art will understand that the technology may be practiced without many of these details. In some instances, well known structures and function have not been shown or described in detail to avoid unnecessarily obscuring the description of the embodiments of the technology. It is intended that the terminology used in the description presented below be interpreted in its broadest reasonable manner, even though it is being used in conjunction with the detailed description of certain embodiments of the technology. Although certain terms may be emphasized below, any terminology intended to be interpreted in any restricted manner will be overtly and specifically defined as such in this detailed description section.

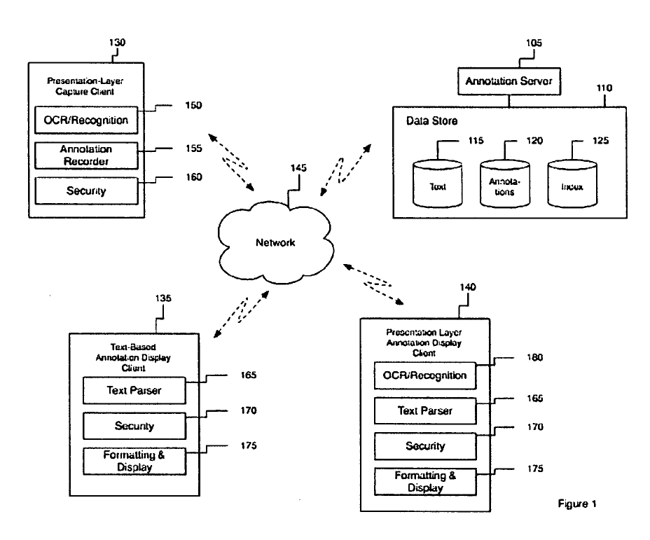

FIG. 1 is a block diagram of a hardware and/or software facility that enables annotations to be created and displayed on a wide variety of content. The facility comprises an annotation server 105 that is coupled to a data store 110. The annotation server manages the association of annotations with text segments and delivers relevant annotations for display on content. As will be described in additional detail herein, text segments are stored in a text database 115 and annotations are stored in an annotations database 120. Each annotation in the annotations database is associated with one of the text segments stored in the text database. One or more indices 125 is provided to enable the annotation server to quickly search the text database 115 and the annotation database 120 in order to identify desired text segments or annotations. While annotation server 105 is depicted as a single server, it will be appreciated that the annotation server may be comprised of a plurality of servers and the functionality described herein may be replicated or dispersed throughout the plurality of servers. Similarly, although data store 110 is indicated as a single data store containing a number of databases, it will be appreciated that one or more data stores may be use to store the data accessed by the facility. Moreover, the term “database” should be interpreted in its broadest sense as a structured way to store and access data within a computer.

The annotation server 105 communicates with annotation captures clients 130 and annotation display clients 135 and 140 via a network 145, such as a public or private network like the Internet or an intranet. The annotation capture clients 130 operate on a user's viewing device to allow a user to create annotations on content. The viewing device may be a computer, a portable computer, a mobile phone, a personal digital assistant, an ebook reader, or any other device having an interface to allow a user to interact with content. In some embodiments, a handheld optical and audio capture device is used to create annotations as described in U.S. Patent Application No. 60/653,899, hereby incorporated by reference in its entirety. As used herein, content refers to any audio-visual content containing text or convertible into text, including, but not limited to, documents, web pages, images, slideshows, presentations, videos, emails, spreadsheets, SMS messages, threaded discussions, chat rooms, etc. As will be described in additional detail herein, the annotation capture client 130 allows a user to create annotations and associate the annotations with text segments contained in content that is viewed by the user. In some embodiments, at least some clients perform functionality of both an annotation capture client and an annotation display client.

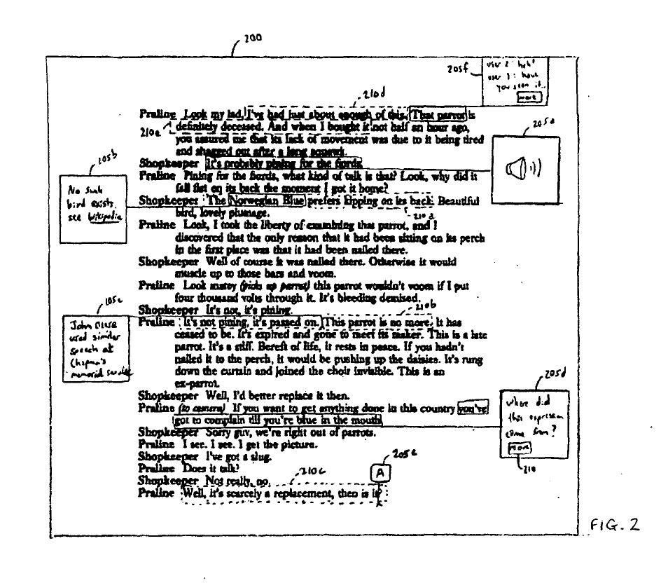

FIG. 2 is a screen shot of a representative user interface 200 such as may be presented to a user when viewing content. While the content depicted in FIG. 2 is exclusively textual, it will be appreciated that the displayed content may include text, graphics, video, animation, photos, and any other audio, visual, or audio-visual content. Five annotations 205a, 205b, 205c, 205d, 205e, and 205f are depicted as having been added to the content. The first annotation 205a is a sound annotation, such as recorded voice or music, associated with one sentence in the content. The sound annotation may be accessed by clicking on or otherwise selecting the annotation. The second annotation 205b is a text annotation associated with two words in the content, and includes a hyperlink or other link or pointer to additional information. The third annotation 205c is a text annotation associated with a location in the content, but not identified with any particular words in the content. The fourth annotation 205d is a text annotation associated with a phrase in the content, and includes a button 210 that, when selected, presents additional annotation content to the user. The fifth annotation 205e is a visual indication of an annotation, the contents of which may be viewed when the user selects the annotation by clicking on or otherwise hovering over the fifth annotation. The sixth annotation 205f is a discussion thread associated with a phrase of content. Users may post comments on the discussion that are viewable by other users. Additional discussion content may be viewed by clicking on the “more” button, which may link the user to a discussion board or may cause a pop-up or other change to the display that allows the user to view more of the discussion thread. The depicted annotations provide some indication of the form and type of annotations, but are merely examples and are not intending to be limiting in any way. Annotations can include text, image, movies, sounds, chats, URIs, polls, advertisements, etc. The annotations can be displayed in the margins surrounding the text, may be superimposed over the text, may be presented on different screens than the content, or may be presented in any combination of the preceding. Various other permutations of form and type of annotation will be readily apparent to those skilled in the art.

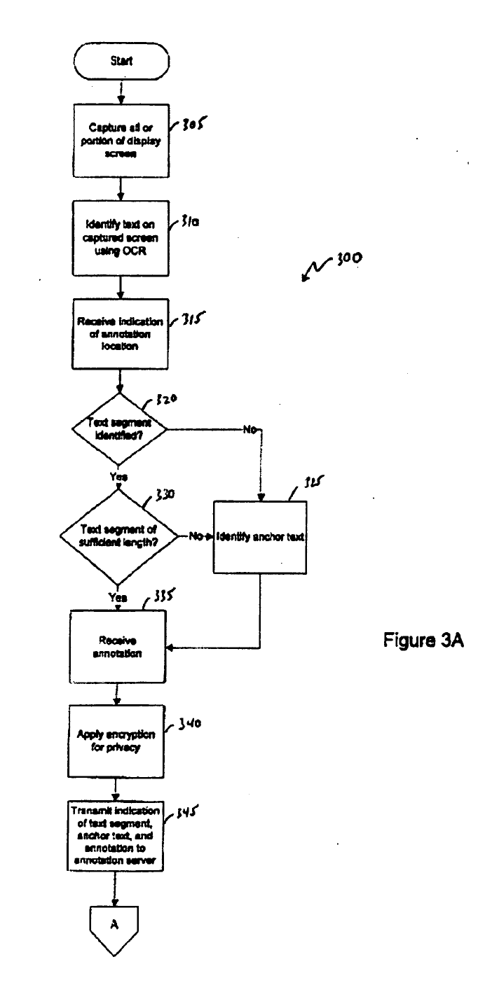

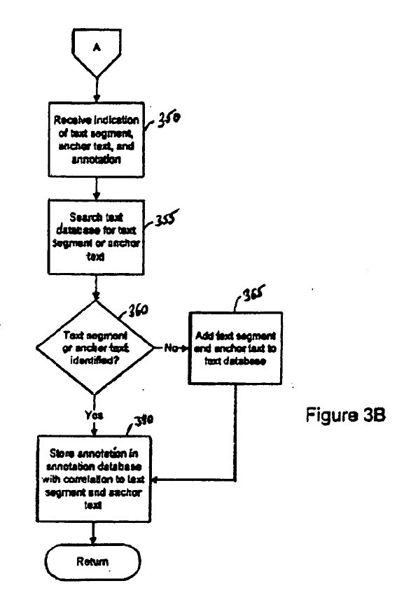

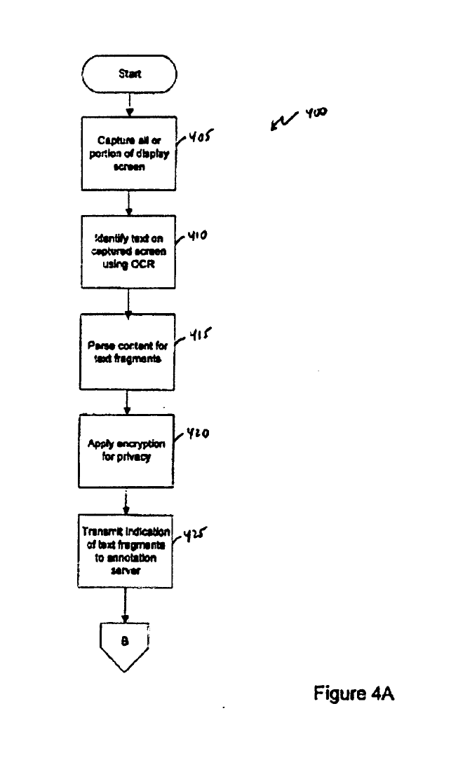

In order to allow a user to create and store annotations, the capture client 130 contains an optical character recognition (OCR) component 150, an annotation recorder 155, and a privacy component 160. The operation of each of these components will be described with respect to the process set forth in FIGS. 3A and 3B.

FIGS. 3A and 3B are flow charts of a capture process 300 implemented by the facility to allow a user to create and store annotations for any type of content. The capture process may be executed by the facility whenever a user desires to add one or more annotations to a particular piece of content that the user is viewing. One of the challenges in creating a cross-platform capture client that is operable with any type of content is the wide variety of formats in which content may be viewed by a user. For example, even a piece of content as universal as a document may be represented in a variety of formats, including Microsoft Word, Adobe PDF, Corel Word Perfect, OpenDocument, and others. While interfaces may be created to interface with content in each of these formats, to ensure the broad applicability of the annotation capture client 130 the client interacts with images of the content being displayed to the user rather than with the underlying format of the content dictated by the viewing application used by the user. At a block 305, all or a portion of the screen buffer containing content that is being displayed to the user is captured by the facility. At a block 310, the captured screen buffer data is processed by the OCR component 150 to identify the text being displayed to the user. As part of the OCR process, unwanted data, graphics, and display formatting is recognized and discarded. By extracting text from the display output of any application used by the user to view or manipulate content, the capture client 130 is able to identify all text in the content without having to understand or program to the APIs necessary to directly interface with each content-viewing application. While the OCR component is depicted as being in the presentation layer capture client 130 of the user's viewing device, those skilled in the art will appreciate that some or all of the OCR processing may be performed by a remote service. For example, the facility may perform initial processing at the capture client, but may transmit all or portions of the captured screen buffer data or of partially-processed data to a remote OCR service that may perform similar or more resource-intensive OCR processing. Processing remotely removes some or all of the computational burden from the user's device while allowing more sophisticated OCR processing to be performed.

Once the text contained in content being viewed by a user has been identified, the user is allowed to add one or more annotations to the text using the annotation recorder 155. At a block 315, the facility receives an indication from the user as to the location of the annotation within the content. As was noted with respect to FIG. 2, annotations may be associated with a point in the content or with one or more words of content. Using any input device (e.g., mouse, pen, cursor, touch screen, etc.) that is supported by the user's viewing device, the user is able to specify the location of an annotation within the displayed content. The location may be point, a single character or a range or characters, a single word or a range of words (e.g., a sentence or paragraph), or any combination thereof. The user may specify the location using any common location-designation mechanism, such as clicking, clicking and dragging, hovering and right-clicking, etc.

The facility depends on having text segments of sufficient length to ensure the proper placement of annotations when displayed in the future. If the user identifies only a point in the content as the location of an annotation, or if the user identifies a text segment that is insufficient in length to ensure accurate placement of an annotation in the future, the facility identifies additional text to associate with the annotation. At a block 320, the facility determines whether the user identified a text segment in the content as the location of an annotation, or merely a point in the content. At a block 330, the facility determines whether the text segment is of sufficient length to ensure accurate placement of the annotation in the future. If the test at blocks 320 and 330 indicates that further text is required for accurate placement of the annotation in the future, at a block 325 the facility identifies anchor text that may be used to ensure proper placement of the annotation. For example, with respect to FIG. 2, five instances of anchor text 210a, 210b, 210c, 210d, and 210e are depicted using dotted lines. The first instance of anchor text 210a extends on either side of the text segment “Norwegian Blue” selected by the user for association with annotation 205b. Anchor text 210a was selected by the facility to provide greater context to the selected text segment, which being composed of only two words may be too short of a text segment to ensure accurate placement of the annotation 205b in the future. Anchor text 210b was selected by the facility on either side of the location selected by a user for the placement of annotation 205c. Similarly, anchor text 210c was selected by the facility since it precedes the location for annotation 205e. Anchor text is selected by the facility at block 325 only if the text segment selected by the user is of insufficient length to ensure accurate placement of the annotation in the future.

In some embodiments, two segments of anchor text are identified by the facility. The first segment of anchor text is identified immediately prior to the user-identified location of the annotation in the content. The second segment of anchor text is identified immediately after the user-identified location of the annotation in the content. Each segment of anchor text is individually sufficient to ensure proper placement of the associated annotation. For example, in FIG. 2 the annotation 205f has two instances of anchor text associated with it. The first instance of anchor text 210d extends before the location of the annotation, and the second instance of anchor text 210e extends after the location of the annotation. Each instance of anchor text is selected so that the combination of the text selected by the user and the anchor text ensures proper placement of the annotation in the future. The use of two sets of anchor text with a single annotation may be beneficial in those situations where only one set of anchor text can be identified by the facility when attempting to properly place the annotation, as will be described in additional detail herein.

In some embodiments, rather than the facility selecting anchor text, the facility may provide instructions to the user to guide the user in selecting sufficient text to accurately locate an annotation. That is, when the user selects a location for an annotation, the facility may provide a visual or audible indication if the selected location is insufficient to accurately locate the annotation in the future. The visual or audible indication may remain until the user has selected sufficient text. For example, the facility may initially display an icon on a screen in red as a user begins to highlight text for purposes of placing an annotation, and may turn the icon green when the user has selected sufficient text to reliably locate the annotation. The visual or audible indication acts as feedback to ensure that the user provides adequate location information for the facility.

After the user has identified a location for an annotation, and any anchor text has been selected by the facility, at a block 335 the facility receives the annotation from the user. The annotation may be in any form (e.g., text, audio, video, etc.) and may be entered by a user using an appropriate input mechanism (e.g., keyboard, cutting and pasting, recording with a microphone or video camera, etc.). The annotation may take any form that may be captured or manipulated by the viewing device utilized by the user.

After the facility receives the annotation, in certain cases it may be important to mask the contents of the annotation or the contents of the text segment and anchor text that the annotation is associated with before transmission to the annotation server. For example, the capture client 130 may be remote from the annotation server 105 and any communications between the two may be over a public network. A certain level of security may therefore be appropriate to ensure that communications between the client and the annotation server are not intercepted. As another example, it may be important to mask the content of the annotation or the text segment when stored at the annotation server 105 to preserve the privacy of anyone using the annotation service. In such an event, at a block 340 the security component 160 may encrypt or otherwise mask the identity of the annotation and/or the text segment and anchor text. Various techniques may be applied to provide security, depending on the desired level of protection and the preferences of the user or the facility operator. For example, the annotation may be encrypted using a public key encryption algorithm, and transmitted to the annotation server where it may remain encrypted and viewable only by someone with the corresponding private key. As another example, a checksum of the text segment and anchor text may be calculated and transmitted with the annotation to the annotation server. As will be appreciated from the following discussion, the annotation may be accessed by presenting the same checksum to the annotation server. Because the annotation server only stores the checksum, however, and not the actual text associated with the checksum, only the annotation itself would be readily ascertainable to someone having access to the annotation server. The actual content that the annotation is associated with would remain hidden by the use of the checksum. Other methods of securely transmitting and storing the annotation and indication of the text segment will be readily apparent to those skilled in the art.

At a block 345, the capture client 130 transmits an indication of the text segment, anchor text, and annotation to the annotation server 105. If the annotation is to be accessed by a party other than the user of the capture client, then the entire annotation is sent to the annotation server. Storing the annotation at the annotation server allows the annotation to be subsequently distributed to users that utilize a display client 135 or 140. In contrast, if the annotation is only to be accessed by the user of the capture client, then the annotation may be stored local to the capture client. In some embodiments, the entire text segment and the anchor text is transmitted to the annotation server. In some embodiments, only an indication of the text segment and anchor text are transmitted. Such an indication may be a checksum, hash value, or other value that uniquely identifies the text segment and anchor text without disclosing the actual content of the text segment and anchor text. The annotation and associated information may be sent by the capture client at the time that the user creates the annotation, or may be cached by the capture client and periodically transmitted to the annotation server. The schedule of transmission to the annotation server may be dictated by network availability to make the transmission, or may be dictated by communication efficiency to minimize the amount of traffic between the various facility components.

At a block 350, the annotation and the indication of the text segment and the anchor text are received by the annotation server 105. The annotation server stores the received annotation in a fashion that allows the annotation to be subsequently identified based on the text segment and anchor text that is associated with the annotation. In some embodiments, the annotation may be stored in the annotations database 120 and the text segment and anchor text stored in the text database 115. Before storing the text segment and anchor text in the text database, at a block 335 the facility searches the text database to identify whether the text segment or anchor text already exists in the text database. If the text segment and anchor text are not identified by the facility at a decision block 360, the text segment and anchor text are added to the text database at a block 365. At a block 370, the annotation is stored in the annotation database with a reference or other link to the text segment and anchor text that is stored in the text database. In some embodiments, the text associated with the text segment and the anchor text is stored along with an indication of which part of the stored text corresponds to the text segment and which part corresponds to the anchor text. In this fashion, that exact text that was selected by the user (corresponding to the text segment) may be identified, whereas the full amount of stored text (corresponding to the text segment and the anchor text) may be used to ensure correct placement of the annotation. If the facility identifies that the text segment and anchor text are already stored in the text database at decision block 360, then processing by the facility may continue to block 370 where the annotation is stored with a reference or other link to the text segment and anchor text. In this fashion, a database of text segments and anchor text is constructed by the facility, each associated with one or more annotations.

In some embodiments, the text segment and the anchor text that are received by the annotation server 105 are compared with a corpus of stored electronic documents in order to identify the document or documents from which the text segment and anchor text were derived. A method of correlating the received text in order to identify an associated document or documents is disclosed in U.S. patent application Ser. No. 11/110,353, filed 19 Apr. 2005 and entitled “PROCESSING TECHNIQUES FOR VISUAL CAPTURE DATA FROM A RENDERED DOCUMENT,” which is hereby incorporated by reference in its entirety. The identity of the document or documents may be stored by the facility in association with the text segment, anchor text, and annotation.

Once stored by facility, annotations associated with text segments may be accessed for presentation to a user. To facilitate timely access to the annotations, on a periodic basis the facility may build or update one or more indices that are stored in the index database 125. The indices may be optimized to provide real-time or near real-time look-up of annotations by a display client. Those skilled in the art will appreciate that there are a variety of techniques that may be used to optimize access to the annotation and text databases.

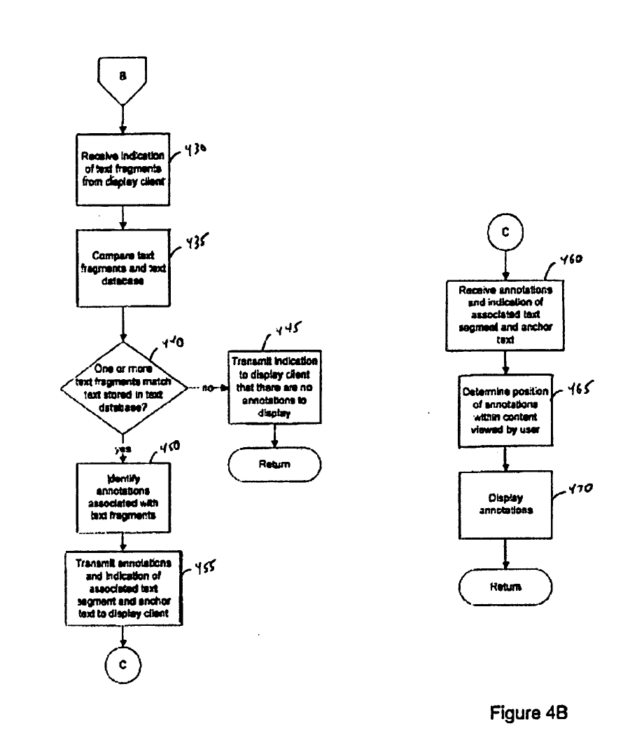

Returning to FIG. 1, after annotations have been stored in association with text segments and anchor text, the facility enables the annotations to be accessed by a user viewing any content that contains one or more text segments that are associated with annotations. To allow users to access annotations, annotation display clients 135 and 140 may operate on a user's viewing device. The text-based annotation display client 135 contains a text parser 165, a security component 170, and a formatting and display component 175. The presentation layer annotation display client 140 contains a text parser 165, a security component 170, and a formatting and display component 175, and in addition contains an optical character recognition (OCR) component 180. In general, each of the display clients will parse the content that is being accessed by a user in order to identify one or more text fragments that are contained in the content. An indication of the identified text fragments is sent to the annotation server 105, which identifies any annotations that are associated with the text fragments. The annotations are transmitted by the annotation server to the display client where they are displayed to the user. The operation of each of the components in the annotation clients 135 and 140 will be described with respect to the display process set forth in FIGS. 4A and 4B.

FIGS. 4A and 4B are flow charts of a display process 400 implemented by the facility to allow a user to access annotations that are associated with content being viewed by the user. The display process may be executed by the facility whenever a user desires to view one or more annotations that are associated with a particular piece of content that the user is viewing. The facility initially identifies text contained in the content that is being viewed by the user. The text-based annotation display client 135 may be used in circumstances in which the content being viewed is in a format that may be easily parsed to identify text fragments in the content. The presentation-layer annotation display client 140 may be used in circumstances in which the content being viewed is in a format that is not easily parsed to identify text fragments in the content. The display process 400 depicts the operation of the presentation-layer display client 140, with differences between the presentation-layer display client and text-based display client noted thereafter.

In a similar manner to the operation of the capture client 130, the display client takes interacts with images of the content being displayed to the user, rather than with the underlying format of the content dictated by the viewing application used by the user, in order to ensure that the display client is operable with a wide variety of formats in which content may be viewed by a user. At a block 405, all or a portion of the screen buffer containing content that is being displayed to the user on the user's viewing device is captured by the facility. At a block 410, the captured screen buffer data is processed by the OCR component 180 to identify the text being displayed to the user. As part of the OCR process, unwanted data, graphics, and display formatting is recognized and discarded. By extracting text from the display output of any application used to view or manipulate content, the display client 140 is able to identify text in content viewed by a user without having to understand the APIs necessary to directly interface with each content-viewing application.

Once the text being viewed by a user has been identified, the facility attempts to identify one or more annotations that are associated with the text. At a block 415, the text parser 165 parses the content being viewed by the user to identify one or more text fragments. Text fragments are one or more contiguous words that are contained in the content. Those skilled in the art will appreciate that various algorithms may be used to parse the text and identify which text fragments to send to the annotation server for comparison purposes. In some embodiments, a representation of each and every word of text in the content may be sent to the annotation server for comparison purposes. In some embodiments, a representation of only distinctive words or groups of words may be sent to the annotation server for comparison purposes. Other algorithms for transmitting only selected text fragments to the annotation server may be implemented as well.

At a block 420, the security component 170 may encrypt or otherwise mask the identity of the text fragment. Various techniques may be applied to provide security, depending on the desired level of protection and the preferences of the user or the facility operator. For example, the text fragment may be encrypted using a public key encryption algorithm, and transmitted to the annotation server where it is decrypted using a private key. As another example, a hash value of the text fragment may be calculated and transmitted to the annotation server. By transmitting only the hash value, anyone intercepting the transmission would be unable to ascertain what text fragment the user was viewing. Other methods of securely transmitting the text fragment will be readily apparent to those skilled in the art.

At a block 425, the facility transmits an identification of each text fragment to the annotation server where it can be compared with the text stored in the text database. The text fragments may be transmitted by the facility individually or in groups, and on a regular or a sporadic basis. For example, all text fragments may be transmitted for an entire document when a user first views the document, or only those text fragments corresponding to portions of the document that are being viewed by the user may be transmitted as the user views each portion. As another example, text fragments may be sent when the user opts to turn on annotation functionality for certain content, or when the user affirmatively requests to receive annotations for a particular piece of content.

At a block 430, the annotation server 105 receives the indication of the text fragments from the display client 140. At a block 435, the facility compares the indication of the received text fragments with the database of text segments and anchor text that is stored in the text database 115 in order to match the received text with the stored text. If the received text fragments are in textual form, then a search tree may be used by the facility to traverse the received text and compare it with the stored text. If the received text fragments are represented in coded form, such as a hash or other value associated with the text fragments, then the facility may compare the received coded form with a table of coded values representing the stored text in order to identify any corresponding text segments and anchor text. One or more indices stored in the index database 125 may be utilized by the facility to ensure that the comparison is done in a quick and efficient manner. The algorithm used by the facility to compare the received text with the stored text may require exact matching, or may allow relative or close matching. Since text fragments may be captured as a user scrolls forward or backward in a document, the use of two sets, rather than one set, of anchor text may have certain advantages. By storing sufficient text both before and after the annotation to accurately identify the location of the annotation, the annotation may be quickly identified as anchor text is scrolled onto the screen. For example, the anchor text before the annotation placement will be identified first as a user scrolls forward in a document, and the anchor text after the annotation placement will be identified first as a user scrolls backward in a document. The detection of the first set of anchor text by the facility allows the corresponding annotation to be displayed, even if the second set of anchor text is not yet detected (such as when the second set of anchor text remains hidden beyond the edge of the viewable display).

At a block 440, a test is made by the facility to determine if one or more of the received text fragments match text that is stored in the text database. If none of the text fragments match text that is stored in the text database, then at a block 445 a message is transmitted to the display client indicating that there are no annotations to display. The display client may provide an indication to the user that no annotations exist for the content being viewed, such as an icon or message that indicates the lack of annotations. Alternatively, the display client may merely continue to display the content without annotations to the user, with user operating under the understanding that annotations are only displayed when they are found to match the viewed content.

If one or more text fragments that are received by the annotation server match text that is stored in the text database, at a block 450 the facility identifies annotations that are associated with the text fragments. Such annotations are identified by the facility by relying on the stored association between the text segments and anchor text in the text database 115 and the annotations in the annotation database 120. For each of the text segments and anchor text that is found as matching a text fragment, the annotation is identified for transmission to the display client. At a block 455, the facility transmits to the display client the annotation as well as the associated text segment and/or anchor text with which the annotation is associated. As will be described in additional detail below, the text segment and anchor text are transmitted to allow the display client to appropriately position the annotation and any annotation highlighting over the displayed content. It will be appreciated that if the received text fragment exactly matches the text segment and anchor text, and if the facility manages an association between each sent text fragment and the results of the search by the annotation server, it may be possible to only transmit the annotation to the display client and omit the transmission of the text segment and anchor text.

At a block 460, the display client 140 receives the annotations and indication of associated text segment and anchor text from the annotation server 105. At a block 465, the display client determines the location of the annotations with respect to the content being viewed by the user. A mapping of the text generated by the OCR component 180 to the location of the corresponding viewed content from which the text was derived is maintained by the facility. The precise location of each annotation is therefore determined by comparing the received text segment and anchor text for each annotation with the text identified by the OCR component, and then determining where the matching OCR text appears in the content.

Once the location of each annotation has been determined, at a block 470 the facility displays the annotations at the identified locations within the content. The annotations are displayed by the display client by inserting the annotations in a display layer that overlays the existing application program used by the user to view the content. The display layer is a transparent layer that allows the content viewing application to be examined in all areas other than those areas that contain the annotation. By inserting the annotations into a display layer that is controlled separately from the content viewing application, the facility is able to add annotations to a broader range of content formats. FIG. 2 depicts a representative example of how such annotations may appear to a user when layered over textual content.

As part of various display options, a user is allowed to specify a number of parameters that control how annotations are displayed. For example, a user may be allowed to specify whether the anchor text should be displayed to the user or not displayed to the user. If displayed, the anchor text may be presented using highlighting that is different from the highlighting used to display the text segment, to allow the user to distinguish between the two. As another example, the user may be allowed to specify whether annotations should be displayed in the same context, similar context, or different context as compared to the context in which the annotation was initially recorded. The same context is where the text segment and the anchor text exactly match the text fragment. A similar context is where the text segment matches a portion of the text fragment exactly, but the anchor text is a reasonable (but not exact) match. A different context is where the text segment matches a portion of the text fragment exactly, but the anchor text does not match the remainder of the text fragment. By specifying the type of match, a user is able to indirectly adjust the number of annotations that are displayed to the user. Various parameters may also be set by the user to determine how the annotations will be visually displayed to the user. For example, the facility may allow the user to indicate that an icon (rather than the annotation itself) should be displayed on a piece of content to indicate the presence of an annotation. Clicking-on or otherwise hovering over the icon would then result in the display of the annotation. In another example, annotations may not be indicated on content unless the user selects a passage of text (e.g., a paragraph) and requests that annotations be displayed. In still another example, only a portion of the display visible to a user may be configured to display annotations. For example, the bottom half of the display may be configured to show annotations, while the top half of the display may not be configured to show annotations. As a user scrolls within a document and as text enters the display area, the annotations would be displayed. As the text leaves the display area, the annotations would be removed. Other display options should be readily apparent to those skilled in the art.

While the process 400 depicted in FIGS. 4A and 4B was described with respect to the operation of the presentation-layer annotation display client 140, the majority of the process is also equally applicable to the text-based annotation display client 135 as well. The text-based display client operates in an environment where the textual form of the content may be readily ascertained by the display client. In this type of environment, it is not necessary to perform the capture and OCR steps represented in blocks 405 and 410. Other than those two steps, starting with block 415 and continuing to the end of the process, the text-based annotation display client 135 may implement the same process 400 as the presentation-layer annotation display client 140.

In addition to displaying annotations to users, the facility may also provide notice to a user when an annotation that was previously presented to the user has been changed. For example, the facility may maintain a record of all annotations that have been displayed to a user. If one of the annotations that has been displayed to the user is modified, such as by text being added to the annotation or text being deleted from the annotation, the facility may notify the user of such a modification. The notification may be immediately conveyed by the facility to the user, such as in the form of an email, instant message, or other notification of the change. The notification may also or alternatively be conveyed to the user the next time that the user views the annotation. For example, if the user views content having annotations that have previously been presented to the user, the annotations may be displayed by the facility in a fashion that highlights the modifications that have been made to the annotations as measured from the previous time that the user viewed the annotations. Changed text may be displayed to the user in a variety of ways, such as by displaying the text in a bold font, with highlighting, etc.

It will be appreciated that application programming interfaces (APIs) may be provided to enable devices to interact with the capture, display, and storage capabilities provided by the facility. For example, an interface may be provided to enable a portable scanning device to scan portions of text and attach a text, sound, or voice annotation to the scanned portion. Such scanned portion and associated annotation may then be transmitted to the annotation server for storage. A representative portable scanning device may be found in U.S. patent application Ser. No. 11/209,333, filed 11 May 2006, and entitled “A PORTABLE SCANNING AND MEMORY DEVICE,” which is hereby incorporated by this reference in its entirety. As another example, a word processing program such as Microsoft Word may incorporate the text display client functionality in order to access and display annotations that are stored in an annotation data store area.

While the discussion herein contemplates user-generated annotations, a variant of the facility may operate with facility-generated annotations. Facility-generated annotations may come in a variety of forms. In one form, the facility may include a network crawling component that crawls networks such as the Internet in order to locate textual resources such as articles, blogs, and other content. When the web crawling component locates a quotation, title, author name, URI or other unique string in the crawled content, the facility may capture text associated with the unique string and use the captured text as an annotation for the unique string. For example, if the network crawling component identifies a blog that includes John F. Kennedy's quote “Ich bin ein Berliner,” then the facility may store the text surrounding the quote as an annotation that is associated with the quote. The blog entry thereby becomes an annotation that may be viewed wherever the quote is displayed.

Another alternative form of annotation is an advertising annotation, which advertises goods or services. Advertising annotations may be user-placed, such as by a user that wants to associate an advertisement with a particular phrase. For example, a user may annotate the phrase “rainbow salmon” with an advertisement for fly-fishing trips. Advertising annotations may also be system-placed. For example, a user seeking to sell inflatable boats may submit an advertising request to the facility. Using a matching algorithm, the facility may display an advertising annotation for inflatable boats in association with content that describes rafting on rivers. Advertising annotations may also be automatically associated by the facility with certain content. For example, a company name such as “Amazon.com” may always have an annotation associated with it that provides a link or other advertisement about the company.

### Additional Details

### 1. Nature of the System

For every paper document that has an electronic counterpart, there exists a discrete amount of information in the paper document that can identify the electronic counterpart. In some embodiments, the system uses a sample of text captured from a paper document, for example using a handheld scanner, to identify and locate an electronic counterpart of the document. In most cases, the amount of text needed by the facility is very small in that a few words of text from a document can often function as an identifier for the paper document and as a link to its electronic counterpart. In addition, the system may use those few words to identify not only the document, but also a location within the document.

Thus, paper documents and their digital counterparts can be associated in many useful ways using the system discussed herein.

1.1. A Quick Overview of the Future

Once the system has associated a piece of text in a paper document with a particular digital entity has been established, the system is able to build a huge amount of functionality on that association.

It is increasingly the case that most paper documents have an electronic counterpart that is accessible on the World Wide Web or from some other online database or document corpus, or can be made accessible, such as in response to the payment of a fee or subscription. At the simplest level, then, when a user scans a few words in a paper document, the system can retrieve that electronic document or some part of it, or display it, email it to somebody, purchase it, print it or post it to a web page. As additional examples, scanning a few words of a book that a person is reading over breakfast could cause the audio-book version in the person's car to begin reading from that point when s/he starts driving to work, or scanning the serial number on a printer cartridge could begin the process of ordering a replacement.

The system implements these and many other examples of “paper/digital integration” without requiring changes to the current processes of writing, printing and publishing documents, giving such conventional rendered documents a whole new layer of digital functionality.

1.2. Terminology

A typical use of the system begins with using an optical scanner to scan text from a paper document, but it is important to note that other methods of capture from other types of document are equally applicable. The system is therefore sometimes described as scanning or capturing text from a rendered document, where those terms are defined as follows:

A rendered document is a printed document or a document shown on a display or monitor. It is a document that is perceptible to a human, whether in permanent form or on a transitory display.

Scanning or capturing is the process of systematic examination to obtain information from a rendered document. The process may involve optical capture using a scanner or camera (for example a camera in a cellphone), or it may involve reading aloud from the document into an audio capture device or typing it on a keypad or keyboard. In some embodiments, optical capture is achieved by determining what data is optically visible to a user (e.g., rendered) on all or part of a dynamic display. This optical capture of visible data may be accomplished by analyzing a storage buffer of the display (for example, by performing optical character recognition or other image analysis on an image stored in the display buffer), by intercepting and analyzing changes being made to a dynamic display (for example by analyzing new data being written to a display when the user changes the data being viewed by scrolling within a window), by requesting information about the displayed data from the application or operating system components responsible for generating the displayed data or having access to the displayed data, or by otherwise determining what keywords and other content are currently in view of the user. In some embodiments text rendered on a dynamic display is converted to a sequence of signatures (for example by taking successive groups of 100 characters in a sliding window), and a database is consulted to determine whether there are associated actions or content for any of these signatures. For more examples of scanning and capturing, see Section 15.

### 2. Introduction to the System

This section describes some of the devices, processes and systems that constitute a system for paper/digital integration. In various embodiments, the system builds a wide variety of services and applications on this underlying core that provides the basic functionality.

2.1. The Processes

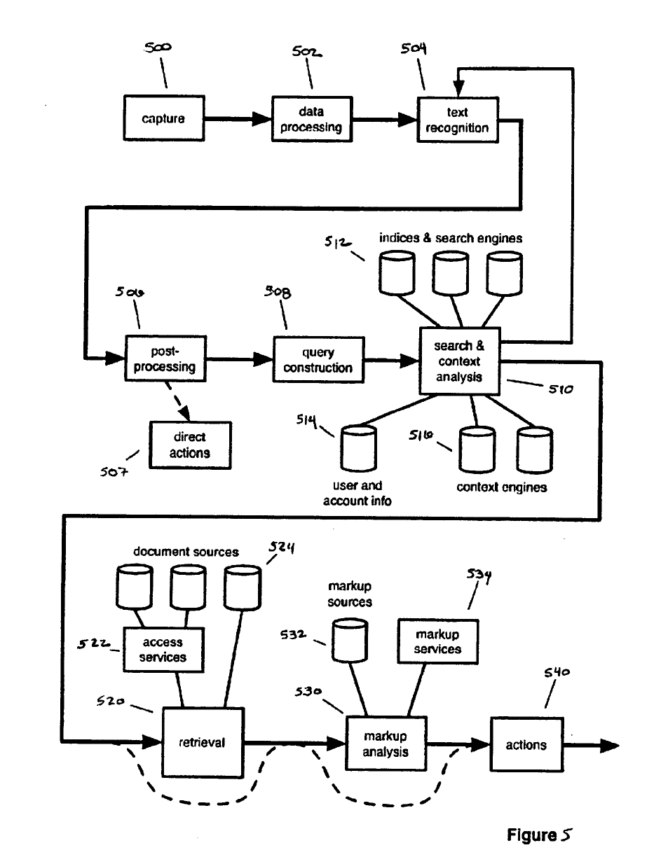

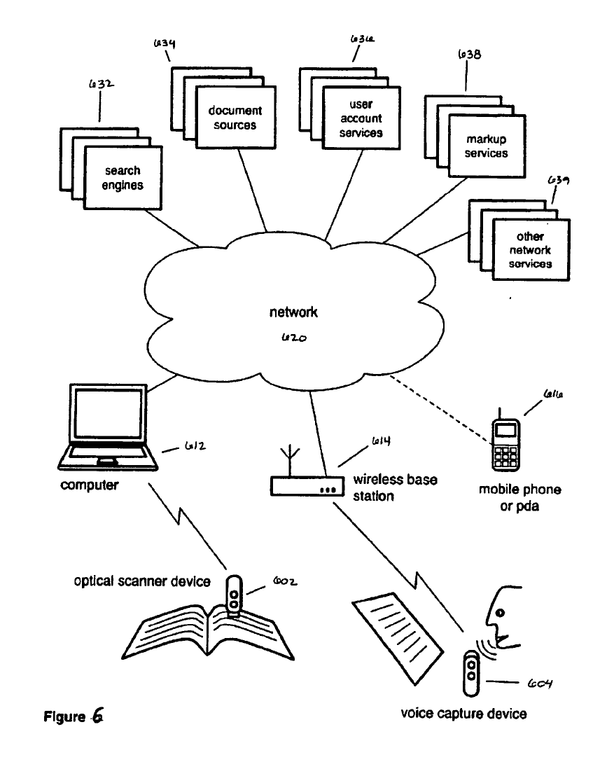

FIG. 5 is a data flow diagram that illustrates the flow of information in one embodiment of the core system. Other embodiments may not use all of the stages or elements illustrated here, while some will use many more.

Text from a rendered document is captured 500, typically in optical form by an optical scanner or audio form by a voice recorder, and this image or sound data is then processed 502, for example to remove artifacts of the capture process or to improve the signal-to-noise ratio. A recognition process 504 such as OCR, speech recognition, or autocorrelation then optionally converts the data into one or more signatures, comprised in some embodiments of text, text offsets, or other symbols. Alternatively, the system performs an alternate form of extracting document signature from the rendered document. The signature represents a set of possible text transcriptions in some embodiments. This process may be influenced by feedback from other stages, for example, if the search process and context analysis 510 have identified some candidate documents from which the capture may originate, thus narrowing the possible interpretations of the original capture.

A post-processing 506 stage may take the output of the recognition process and filter it or perform such other operations upon it as may be useful. Depending upon the embodiment implemented, it may be possible at this stage to deduce some direct actions 507 to be taken immediately without reference to the later stages, such as where a phrase or symbol has been captured which contains sufficient information in itself to convey the user's intent. In these cases no digital counterpart document need be referenced, or even known to the system.

Typically, however, the next stage will be to construct a query 508 or a set of queries for use in searching. Some aspects of the query construction may depend on the search process used and so cannot be performed until the next stage, but there will typically be some operations, such as the removal of obviously misrecognized or irrelevant characters, which can be performed in advance.

The query or queries are then passed to the search and context analysis stage 510. Here, the system optionally attempts to identify the document from which the original data was captured. To do so, the system typically uses search indices and search engines 512, knowledge about the user 514 and knowledge about the user's context or the context in which the capture occurred 516. Search engine 512 may employ and/or index information specifically about rendered documents, about their digital counterpart documents, and about documents that have a web (internet) presence). It may write to, as well as read from, many of these sources and, as has been mentioned, it may feed information into other stages of the process, for example by giving the recognition system 504 information about the language, font, rendering and likely next words based on its knowledge of the candidate documents.

In some circumstances the next stage will be to retrieve 520 a copy of the document or documents that have been identified. The sources of the documents 524 may be directly accessible, for example from a local filing system or database or a web server, or they may need to be contacted via some access service 522 which might enforce authentication, security or payment or may provide other services such as conversion of the document into a desired format.

Applications of the system may take advantage of the association of extra functionality or data with part or all of a document. For example, advertising applications discussed in Section 10.4 may use an association of particular advertising messages or subjects with portions of a document. This extra associated functionality or data can be thought of as one or more overlays on the document, and is referred to herein as “markup.” The next stage of the process 530, then, is to identify any markup relevant to the captured data. Such markup may be provided by the user, the originator, or publisher of the document, or some other party, and may be directly accessible from some source 532 or may be generated by some service 534. In various embodiments, markup can be associated with, and apply to, a rendered document and/or the digital counterpart to a rendered document, or to groups of either or both of these documents.

Lastly, as a result of the earlier stages, some actions may be taken 540. These may be default actions such as simply recording the information found, they may be dependent on the data or document, or they may be derived from the markup analysis. Sometimes the action will simply be to pass the data to another system. In some cases the various possible actions appropriate to a capture at a specific point in a rendered document will be presented to the user as a menu on an associated display, for example on a local display 732, on a computer display 612 or a mobile phone or PDA display 616. If the user doesn't respond to the menu, the default actions can be taken.

2.2. The Components

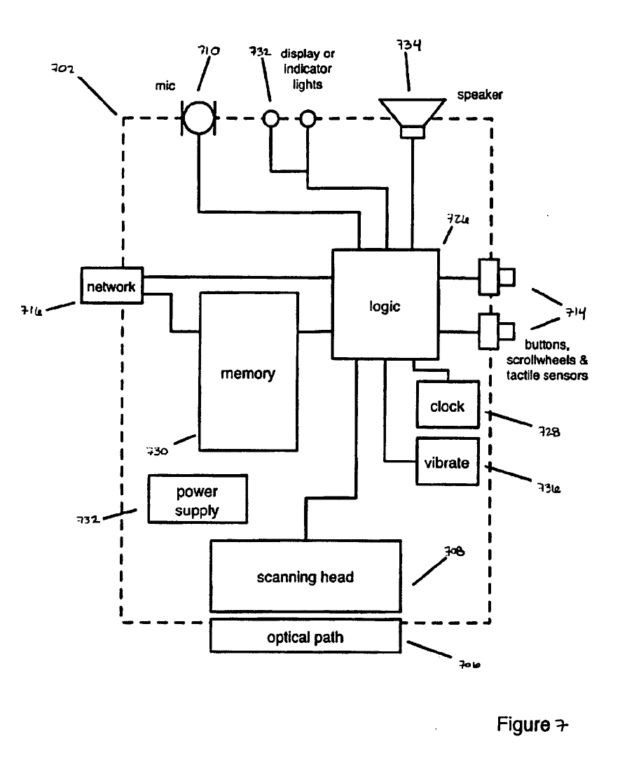

FIG. 6 is a component diagram of components included in a typical implementation of the system in the context of a typical operating environment. As illustrated, the operating environment includes one or more optical scanning capture devices 602 or voice capture devices 604. In some embodiments, the same device performs both functions. Each capture device is able to communicate with other parts of the system such as a computer 612 and a mobile station 616 (e.g., a mobile phone or PDA) using either a direct wired or wireless connection, or through the network 620, with which it can communicate using a wired or wireless connection, the latter typically involving a wireless base station 614. In some embodiments, the capture device is integrated in the mobile station, and optionally shares some of the audio and/or optical components used in the device for voice communications and picture-taking.

Computer 612 may include a memory containing computer executable instructions for processing an order from scanning devices 602 and 604. As an example, an order can include an identifier (such as a serial number of the scanning device 602/604 or an identifier that partially or uniquely identifies the user of the scanner), scanning context information (e.g., time of scan, location of scan, etc.) and/or scanned information (such as a text string) that is used to uniquely identify the document being scanned. In alternative embodiments, the operating environment may include more or less components.

Also available on the network 620 are search engines 632, document sources 634, user account services 636, markup services 638 and other network services 639. The network 620 may be a corporate intranet, the public Internet, a mobile phone network or some other network, or any interconnection of the above.

Regardless of the manner by which the devices are coupled to each other, they may all may be operable in accordance with well-known commercial transaction and communication protocols (e.g., Internet Protocol (IP)). In various embodiments, the functions and capabilities of scanning device 602, computer 612, and mobile station 616 may be wholly or partially integrated into one device. Thus, the terms scanning device, computer, and mobile station can refer to the same device depending upon whether the device incorporates functions or capabilities of the scanning device 602, computer 612 and mobile station 616. In addition, some or all of the functions of the search engines 632, document sources 634, user account services 636, markup services 638 and other network, services 639 may be implemented on any of the devices and/or other devices not shown.

2.3. The Capture Device

As described above, the capture device may capture text using an optical scanner that captures image data from the rendered document, or using an audio recording device that captures a user's spoken reading of the text, or other methods. Some embodiments of the capture device may also capture images, graphical symbols and icons, etc., including machine readable codes such as barcodes. The device may be exceedingly simple, consisting of little more than the transducer, some storage, and a data interface, relying on other functionality residing elsewhere in the system, or may be a more full-featured device. For illustration, this section describes a device based around an optical scanner and with a reasonable number of features.

Scanners are well known devices that capture and digitize images. An offshoot of the photocopier industry, the first scanners were relatively large devices that captured an entire document page at once. Recently, portable optical scanners have been introduced in convenient form factors, such as a pen-shaped handheld device.

In some embodiments, the portable scanner is used to scan text, graphics, or symbols from rendered documents. The portable scanner has a scanning element that captures text, symbols, graphics, etc., from rendered documents. In addition to documents that have been printed on paper, in some embodiments, rendered documents include documents that have been displayed on a screen such as a CRT monitor or LCD display.

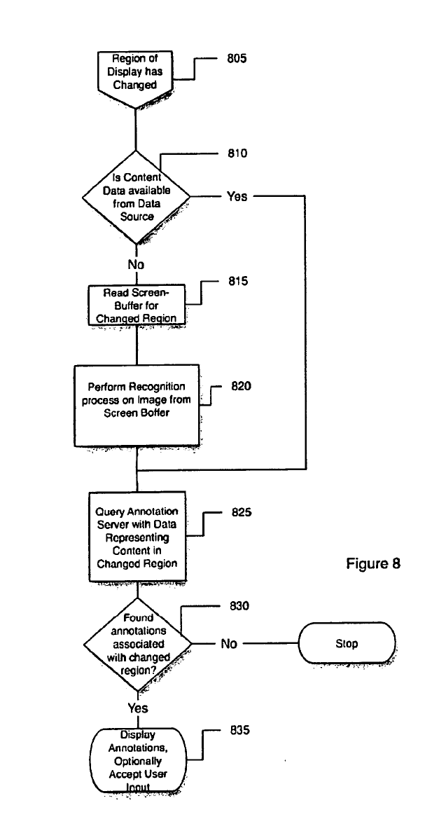

FIG. 7 is a block diagram of an embodiment of a scanner 702. The scanner 702 comprises an optical scanning head 708 to scan information from rendered documents and convert it to machine-compatible data, and an optical path 706, typically a lens, an aperture or an image conduit to convey the image from the rendered document to the scanning head. The scanning head 708 may incorporate a Charge-Coupled Device (CCD), a Complementary Metal Oxide Semiconductor (CMOS) imaging device, or an optical sensor of another type.

A microphone 710 and associated circuitry convert the sound of the environment (including spoken words) into machine-compatible signals, and other input facilities exist in the form of buttons, scroll-wheels or other tactile sensors such as touch-pads 714.

Feedback to the user is possible through a visual display or indicator lights 732, through a loudspeaker or other audio transducer 734 and through a vibrate module 736.

The scanner 702 comprises logic 726 to interact with the various other components, possibly processing the received signals into different formats and/or interpretations. Logic 726 may be operable to read and write data and program instructions stored in associated storage 730 such as RAM, ROM, flash, or other suitable memory. It may read a time signal from the clock unit 728. The scanner 702 also includes an interface 716 to communicate scanned information and other signals to a network and/or an associated computing device. In some embodiments, the scanner 702 may have an on-board power supply 732. In other embodiments, the scanner 702 may be powered from a tethered connection to another device, such as a Universal Serial Bus (USB) connection.

As an example of one use of scanner 702, a reader may scan some text from a newspaper article with scanner 702. The text is scanned as a bit-mapped image via the scanning head 708. Logic 726 causes the bit-mapped image to be stored in memory 730 with an associated time-stamp read from the clock unit 728. Logic 726 may also perform optical character recognition (OCR) or other post-scan processing on the bit-mapped image to convert it to text. Logic 726 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 726) to an associated computer via interface 716.

As an example of another use of scanner 702, a reader may capture some text from an article as an audio file by using microphone 710 as an acoustic capture port. Logic 726 causes audio file to be stored in memory 728. Logic 726 may also perform voice recognition or other post-scan processing on the audio file to convert it to text. As above, the reader may then upload the audio file (or text produced by post-scan processing performed by logic 726) to an associated computer via interface 716.

Part II—Overview of the Areas of the Core System

As paper-digital integration becomes more common, there are many aspects of existing technologies that can be changed to take better advantage of this integration, or to enable it to be implemented more effectively. This section highlights some of those issues.

### 3. Search

Searching a corpus of documents, even so large a corpus as the World Wide Web, has become commonplace for ordinary users, who use a keyboard to construct a search query which is sent to a search engine. This section and the next discuss the aspects of both the construction of a query originated by a capture from a rendered document, and the search engine that handles such a query.

3.1. Scan/Speak/Type as Search Query

Use of the described system typically starts with a few words being captured from a rendered document using any of several methods, including those mentioned in Section 1.2 above. Where the input needs some interpretation to convert it to text, for example in the case of OCR or speech input, there may be end-to-end feedback in the system so that the document corpus can be used to enhance the recognition process. End-to-end feedback can be applied by performing an approximation of the recognition or interpretation, identifying a set of one or more candidate matching documents, and then using information from the possible matches in the candidate documents to further refine or restrict the recognition or interpretation. Candidate documents can be weighted according to their probable relevance (for example, based on then number of other users who have scanned in these documents, or their popularity on the Internet), and these weights can be applied in this iterative recognition process.

3.2. Short Phrase Searching

Because the selective power of a search query based on a few words is greatly enhanced when the relative positions of these words are known, only a small amount of text need be captured for the system to identify the text's location in a corpus. Most commonly, the input text will be a contiguous sequence of words, such as a short phrase.

3.2.1. Finding Document and Location in Document from Short Capture

In addition to locating the document from which a phrase originates, the system can identify the location in that document and can take action based on this knowledge.

3.2.2. Other Methods of Finding Location

The system may also employ other methods of discovering the document and location, such as by using watermarks or other special markings on the rendered document.

3.3. Incorporation of Other Factors in Search Query

In addition to the captured text, other factors (i.e., information about user identity, profile, and context) may form part of the search query, such as the time of the capture, the identity and geographical location of the user, knowledge of the user's habits and recent activities, etc.

The document identity and other information related to previous captures, especially if they were quite recent, may form part of a search query.

The identity of the user may be determined from a unique identifier associated with a capturing device, and/or biometric or other supplemental information (speech patterns, fingerprints, etc.).

3.4. Knowledge of Nature of Unreliability in Search Query (OCR Errors Etc.)

The search query can be constructed taking into account the types of errors likely to occur in the particular capture method used. One example of this is an indication of suspected errors in the recognition of specific characters; in this instance a search engine may treat these characters as wildcards, or assign them a lower priority.

3.5. Local Caching of Index for Performance/Offline Use

Sometimes the capturing device may not be in communication with the search engine or corpus at the time of the data capture. For this reason, information helpful to the offline use of the device may be downloaded to the device in advance, or to some entity with which the device can communicate. In some cases, all or a substantial part of an index associated with a corpus may be downloaded. This topic is discussed further in Section 15.3.

3.6. Queries, in Whatever Form, May be Recorded and Acted on Later

If there are likely to be delays or cost associated with communicating a query or receiving the results, this pre-loaded information can improve the performance of the local device, reduce communication costs, and provide helpful and timely user feedback.

In the situation where no communication is available (the local device is “offline”), the queries may be saved and transmitted to the rest of the system at such a time as communication is restored.

In these cases it may be important to transmit a timestamp with each query. The time of the capture can be a significant factor in the interpretation of the query. For example, Section 13.1 discusses the importance of the time of capture in relation to earlier captures. It is important to note that the time of capture will not always be the same as the time that the query is executed.

3.7. Parallel Searching

For performance reasons, multiple queries may be launched in response to a single capture, either in sequence or in parallel. Several queries may be sent in response to a single capture, for example as new words are added to the capture, or to query multiple search engines in parallel.

For example, in some embodiments, the system sends queries to a special index for the current document, to a search engine on a local machine, to a search engine on the corporate network, and to remote search engines on the Internet.

The results of particular searches may be given higher priority than those from others.

The response to a given query may indicate that other pending queries are superfluous; these may be cancelled before completion.

### 4. Paper and Search Engines

Often it is desirable for a search engine that handles traditional online queries also to handle those originating from rendered documents. Conventional search engines may be enhanced or modified in a number of ways to make them more suitable for use with the described system.

The search engine and/or other components of the system may create and maintain indices that have different or extra features. The system may modify an incoming paper-originated query or change the way the query is handled in the resulting search, thus distinguishing these paper-originated queries from those coming from queries typed into web browsers and other sources. And the system may take different actions or offer different options when the results are returned by the searches originated from paper as compared to those from other sources. Each of these approaches is discussed below.

4.1. Indexing

Often, the same index can be searched using either paper-originated or traditional queries, but the index may be enhanced for use in the current system in a variety of ways.

4.1.1. Knowledge about the Paper Form

Extra fields can be added to such an index that will help in the case of a paper-based search.

### Index Entry Indicating Document Availability in Paper Form

The first example is a field indicating that the document is known to exist or be distributed in paper form. The system may give such documents higher priority if the query comes from paper.

### Knowledge of Popularity Paper Form

In this example statistical data concerning the popularity of paper documents (and, optionally, concerning sub-regions within these documents)—for example the amount of scanning activity, circulation numbers provided by the publisher or other sources, etc. —is used to give such documents higher priority, to boost the priority of digital counterpart documents (for example, for browser-based queries or web searches), etc.

### Knowledge of Rendered Format

Another important example may be recording information about the layout of a specific rendering of a document.

For a particular edition of a book, for example, the index may include information about where the line breaks and page breaks occur, which fonts were used, any unusual capitalization.

The index may also include information about the proximity of other items on the page, such as images, text boxes, tables and advertisements.

### Use of Semantic Information in Original

Lastly, semantic information that can be deduced from the source markup but is not apparent in the paper document, such as the fact that a particular piece of text refers to an item offered for sale, or that a certain paragraph contains program code, may also be recorded in the index.

4.1.2. Indexing in the Knowledge of the Capture Method

A second factor that may modify the nature of the index is the knowledge of the type of capture likely to be used. A search initiated by an optical scan may benefit if the index takes into account characters that are easily confused in the OCR process, or includes some knowledge of the fonts used in the document. Similarly, if the query is from speech recognition, an index based on similar-sounding phonemes may be much more efficiently searched. An additional factor that may affect the use of the index in the described model is the importance of iterative feedback during the recognition process. If the search engine is able to provide feedback from the index as the text is being captured, it can greatly increase the accuracy of the capture.

### Indexing Using Offsets

If the index is likely to be searched using the offset-based/autocorrelation OCR methods described in Section 9, in some embodiments, the system stores the appropriate offset or signature information in an index.

4.1.3. Multiple Indices

Lastly, in the described system, it may be common to conduct searches on many indices. Indices may be maintained on several machines on a corporate network. Partial indices may be downloaded to the capture device, or to a machine close to the capture device. Separate indices may be created for users or groups of users with particular interests, habits or permissions. An index may exist for each file system, each directory, even each file on a user's hard disk. Indexes are published and subscribed to by users and by systems. It will be important, then, to construct indices that can be distributed, updated, merged and separated efficiently.

4.2. Handling the Queries

4.2.1. Knowing the Capture is from Paper

A search engine may take different actions when it recognizes that a search query originated from a paper document. The engine might handle the query in a way that is more tolerant to the types of errors likely to appear in certain capture methods, for example.

It may be able to deduce this from some indicator included in the query (for example a flag indicating the nature of the capture), or it may deduce this from the query itself (for example, it may recognize errors or uncertainties typical of the OCR process).

Alternatively, queries from a capture device can reach the engine by a different channel or port or type of connection than those from other sources, and can be distinguished in that way. For example, some embodiments of the system will route queries to the search engine by way of a dedicated gateway. Thus, the search engine knows that all queries passing through the dedicated gateway were originated from a paper document.

4.2.2. Use of Context

Section 13 below describes a variety of different factors which are external to the captured text itself, yet which can be a significant aid in identifying a document. These include such things as the history of recent scans, the longer-term reading habits of a particular user, the geographic location of a user and the user's recent use of particular electronic documents. Such factors are referred to herein as “context.”

Some of the context may be handled by the search engine itself, and be reflected in the search results. For example, the search engine may keep track of a user's scanning history, and may also cross-reference this scanning history to conventional keyboard-based queries. In such cases, the search engine maintains and uses more state information about each individual user than do most conventional search engines, and each interaction with a search engine may be considered to extend over several searches and a longer period of time than is typical today.

Some of the context may be transmitted to the search engine in the search query (Section 3.3), and may possibly be stored at the engine so as to play a part in future queries. Lastly, some of the context will best be handled elsewhere, and so becomes a filter or secondary search applied to the results from the search engine.

### Data-Stream Input to Search

An important input into the search process is the broader context of how the community of users is interacting with the rendered version of the document—for example, which documents are most widely read and by whom. There are analogies with a web search returning the pages that are most frequently linked to, or those that are most frequently selected from past search results. For further discussion of this topic, see Sections 13.4 and 14.2.

4.2.3. Document Sub-Regions

The described system can emit and use not only information about documents as a whole, but also information about sub-regions of documents, even down to individual words. Many existing search engines concentrate simply on locating a document or file that is relevant to a particular query. Those that can work on a finer grain and identify a location within a document will provide a significant benefit for the described system.

4.3. Returning the Results

The search engine may use some of the further information it now maintains to affect the results returned.

The system may also return certain documents to which the user has access only as a result of being in possession of the paper copy (Section 7.4).

The search engine may also offer new actions or options appropriate to the described system, beyond simple retrieval of the text.

### 5. Markup, Annotations and Metadata

In addition to performing the capture-search-retrieve process, the described system also associates extra functionality with a document, and in particular with specific locations or segments of text within a document. This extra functionality is often, though not exclusively, associated with the rendered document by being associated with its electronic counterpart. As an example, hyperlinks in a web page could have the same functionality when a printout of that web page is scanned. In some cases, the functionality is not defined in the electronic document, but is stored or generated elsewhere.

This layer of added functionality is referred to herein as “markup.”

5.1. Overlays, Static and Dynamic

One way to think of the markup is as an “overlay” on the document, which provides further information about—and may specify actions associated with—the document or some portion of it. The markup may include human-readable content, but is often invisible to a user and/or intended for machine use. Examples include options to be displayed in a popup-menu on a nearby display when a user captures text from a particular area in a rendered document, or audio samples that illustrate the pronunciation of a particular phrase.

5.1.1. Several Layers, Possibly from Several Sources

Any document may have multiple overlays simultaneously, and these may be sourced from a variety of locations. Markup data may be created or supplied by the author of the document, or by the user, or by some other party.

Markup data may be attached to the electronic document or embedded in it. It may be found in a conventional location (for example, in the same place as the document but with a different filename suffix). Markup data may be included in the search results of the query that located the original document, or may be found by a separate query to the same or another search engine. Markup data may be found using the original captured text and other capture information or contextual information, or it may be found using already-deduced information about the document and location of the capture. Markup data may be found in a location specified in the document, even if the markup itself is not included in the document.

The markup may be largely static and specific to the document, similar to the way links on a traditional html web page are often embedded as static data within the html document, but markup may also be dynamically generated and/or applied to a large number of documents. An example of dynamic markup is information attached to a document that includes the up-to-date share price of companies mentioned in that document. An example of broadly applied markup is translation information that is automatically available on multiple documents or sections of documents in a particular language.

5.1.2. Personal “Plug-in” Layers

Users may also install, or subscribe to particular sources of, markup data, thus personalizing the system's response to particular captures.

5.2. Keywords and Phrases, Trademarks and Logos

Some elements in documents may have particular “markup” or functionality associated with them based on their own characteristics rather than their location in a particular document. Examples include special marks that are printed in the document purely for the purpose of being scanned, as well as logos and trademarks that can link the user to further information about the organization concerned. The same applies to “keywords” or “key phrases” in the text. Organizations might register particular phrases with which they are associated, or with which they would like to be associated, and attach certain markup to them that would be available wherever that phrase was scanned.

Any word, phrase, etc. may have associated markup. For example, the system may add certain items to a pop-up menu (e.g., a link to an online bookstore) whenever the user captures the word “book,” or the title of a book, or a topic related to books. In some embodiments, of the system, digital counterpart documents or indices are consulted to determine whether a capture occurred near the word “book,” or the title of a book, or a topic related to books—and the system behavior is modified in accordance with this proximity to keyword elements. In the preceding example, note that markup enables data captured from non-commercial text or documents to trigger a commercial transaction.

5.3. User-Supplied Content

5.3.1. User Comments and Annotations, Including Multimedia

Annotations are another type of electronic information that may be associated with a document. For example, a user can attach an audio file of his/her thoughts about a particular document for later retrieval as voice annotations. As another example of a multimedia annotation, a user may attach photographs of places referred to in the document. The user generally supplies annotations for the document but the system can associate annotations from other sources (for example, other users in a work group may share annotations).

5.3.2. Notes from Proof-Reading

An important example of user-sourced markup is the annotation of paper documents as part of a proofreading, editing or reviewing process.

5.4. Third-Party Content

As mentioned earlier, markup data may often be supplied by third parties, such as by other readers of the document. Online discussions and reviews are a good example, as are community-managed information relating to particular works, volunteer-contributed translations and explanations.

Another example of third-party markup is that provided by advertisers.

5.5. Dynamic Markup Based on Other Users' Data Streams

By analyzing the data captured from documents by several or all users of the system, markup can be generated based on the activities and interests of a community. An example might be an online bookstore that creates markup or annotations that tell the user, in effect, “People who enjoyed this book also enjoyed . . . .” The markup may be less anonymous, and may tell the user which of the people in his/her contact list have also read this document recently. Other examples of data stream analysis are included in Section 14.

5.6. Markup Based on External Events and Data Sources

Markup will often be based on external events and data sources, such as input from a corporate database, information from the public Internet, or statistics gathered by the local operating system.

Data sources may also be more local, and in particular may provide information about the user's context—his/her identity, location and activities. For example, the system might communicate with the user's mobile phone and offer a markup layer that gives the user the option to send a document to somebody that the user has recently spoken to on the phone.

### 6. Authentication, Personalization and Security

In many situations, the identity of the user will be known. Sometimes this will be an “anonymous identity,” where the user is identified only by the serial number of the capture device, for example. Typically, however, it is expected that the system will have a much more detailed knowledge of the user, which can be used for personalizing the system and to allow activities and transactions to be performed in the user's name.

6.1. User History and “Life Library”

One of the simplest and yet most useful functions that the system can perform is to keep a record for a user of the text that s/he has captured and any further information related to that capture, including the details of any documents found, the location within that document any actions taken as a result.

This stored history is beneficial for both the user and the system.

6.1.1. For the User

The user can be presented with a “Life Library,” a record of everything s/he has read and captured. This may be simply for personal interest, but may be used, for example, in a library by an academic who is gathering material for the bibliography of his next paper.

In some circumstances, the user may wish to make the library public, such as by publishing it on the web in a similar manner to a weblog, so that others may see what s/he is reading and finds of interest.

Lastly, in situations where the user captures some text and the system cannot immediately act upon the capture (for example, because an electronic version of the document is not yet available) the capture can be stored in the library and can be processed later, either automatically or in response to a user request. A user can also subscribe to new markup services and apply them to previously captured scans.

6.1.2. For the System

A record of a user's past captures is also useful for the system. Many aspects of the system operation can be enhanced by knowing the user's reading habits and history. The simplest example is that any scan made by a user is more likely to come from a document that the user has scanned in the recent past, and in particular if the previous scan was within the last few minutes it is very likely to be from the same document. Similarly, it is more likely that a document is being read in start-to-finish order. Thus, for English documents, it is also more likely that later scans will occur farther down in the document. Such factors can help the system establish the location of the capture in cases of ambiguity, and can also reduce the amount of text that needs to be captured.

6.2. Scanner as Payment, Identity and Authentication Device

Because the capture process generally begins with a device of some sort, typically an optical scanner or voice recorder, this device may be used as a key that identifies the user and authorizes certain actions.

6.2.1. Associate Scanner with Phone or Other Account

The device may be embedded in a mobile phone or in some other way associated with a mobile phone account. For example, a scanner may be associated with a mobile phone account by inserting a SIM card associated with the account into the scanner. Similarly, the device may be embedded in a credit card or other payment card, or have the facility for such a card to be connected to it. The device may therefore be used as a payment token, and financial transactions may be initiated by the capture from the rendered document.

6.2.2. Using Scanner Input for Authentication

The scanner may also be associated with a particular user or account through the process of scanning some token, symbol or text associated with that user or account. In addition, scanner may be used for biometric identification, for example by scanning the fingerprint of the user. In the case of an audio-based capture device, the system may identify the user by matching the voice pattern of the user or by requiring the user to speak a certain password or phrase.

For example, where a user scans a quote from a book and is offered the option to buy the book from an online retailer, the user can select this option, and is then prompted to scan his/her fingerprint to confirm the transaction.

See also Sections 15.5 and 15.6.

6.2.3. Secure Scanning Device

When the capture device is used to identify and authenticate the user, and to initiate transactions on behalf of the user, it is important that communications between the device and other parts of the system are secure. It is also important to guard against such situations as another device impersonating a scanner, and so-called “man in the middle” attacks where communications between the device and other components are intercepted.

Techniques for providing such security are well understood in the art; in various embodiments, the hardware and software in the device and elsewhere in the system are configured to implement such techniques.

### 7. Publishing Models and Elements

An advantage of the described system is that there is no need to alter the traditional processes of creating, printing or publishing documents in order to gain many of the system's benefits. There are reasons, though, that the creators or publishers of a document—hereafter simply referred to as the “publishers”—may wish to create functionality to support the described system.

This section is primarily concerned with the published documents themselves. For information about other related commercial transactions, such as advertising, see Section 10 entitled “P-Commerce.”

7.1. Electronic Companions to Printed Documents

The system allows for printed documents to have an associated electronic presence. Conventionally publishers often ship a CD-ROM with a book that contains further digital information, tutorial movies and other multimedia data, sample code or documents, or further reference materials. In addition, some publishers maintain web sites associated with particular publications which provide such materials, as well as information which may be updated after the time of publishing, such as errata, further comments, updated reference materials, bibliographies and further sources of relevant data, and translations into other languages. Online forums allow readers to contribute their comments about the publication.

The described system allows such materials to be much more closely tied to the rendered document than ever before, and allows the discovery of and interaction with them to be much easier for the user. By capturing a portion of text from the document, the system can automatically connect the user to digital materials associated with the document, and more particularly associated with that specific part of the document. Similarly, the user can be connected to online communities that discuss that section of the text, or to annotations and commentaries by other readers. In the past, such information would typically need to be found by searching for a particular page number or chapter.

An example application of this is in the area of academic textbooks (Section 17.5).

7.2. “Subscriptions” to Printed Documents

Some publishers may have mailing lists to which readers can subscribe if they wish to be notified of new relevant matter or when a new edition of the book is published. With the described system, the user can register an interest in particular documents or parts of documents more easily, in some cases even before the publisher has considered providing any such functionality. The reader's interest can be fed to the publisher, possibly affecting their decision about when and where to provide updates, further information, new editions or even completely new publications on topics that have proved to be of interest in existing books.

7.3. Printed Marks with Special Meaning or Containing Special Data

Many aspects of the system are enabled simply through the use of the text already existing in a document. If the document is produced in the knowledge that it may be used in conjunction with the system, however, extra functionality can be added by printing extra information in the form of special marks, which may be used to identify the text or a required action more closely, or otherwise enhance the document's interaction with the system. The simplest and most important example is an indication to the reader that the document is definitely accessible through the system. A special icon might be used, for example, to indicate that this document has an online discussion forum associated with it.

Such symbols may be intended purely for the reader, or they may be recognized by the system when scanned and used to initiate some action. Sufficient data may be encoded in the symbol to identify more than just the symbol: it may also store information, for example about the document, edition, and location of the symbol, which could be recognized and read by the system.

7.4. Authorization Through Possession of the Paper Document

There are some situations where possession of or access to the printed document would entitle the user to certain privileges, for example, the access to an electronic copy of the document or to additional materials. With the described system, such privileges could be granted simply as a result of the user capturing portions of text from the document, or scanning specially printed symbols. In cases where the system needed to ensure that the user was in possession of the entire document, it might prompt the user to scan particular items or phrases from particular pages, e.g. “the second line of page 46.”

7.5. Documents which Expire

If the printed document is a gateway to extra materials and functionality, access to such features can also be time-limited. After the expiry date, a user may be required to pay a fee or obtain a newer version of the document to access the features again. The paper document will, of course, still be usable, but will lose some of its enhanced electronic functionality. This may be desirable, for example, because there is profit for the publisher in receiving fees for access to electronic materials, or in requiring the user to purchase new editions from time to time, or because there are disadvantages associated with outdated versions of the printed document remaining in circulation. Coupons are an example of a type of commercial document that can have an expiration date.

7.6. Popularity Analysis and Publishing Decisions

Section 10.5 discusses the use of the system's statistics to influence compensation of authors and pricing of advertisements.

In some embodiments, the system deduces the popularity of a publication from the activity in the electronic community associated with it as well as from the use of the paper document. These factors may help publishers to make decisions about what they will publish in future. If a chapter in an existing book, for example, turns out to be exceedingly popular, it may be worth expanding into a separate publication.

### 8. Document Access Services

An important aspect of the described system is the ability to provide to a user who has access to a rendered copy of a document access to an electronic version of that document. In some cases, a document is freely available on a public network or a private network to which the user has access. The system uses the captured text to identify, locate and retrieve the document, in some cases displaying it on the user's screen or depositing it in their email inbox.

In some cases, a document will be available in electronic form, but for a variety of reasons may not be accessible to the user. There may not be sufficient connectivity to retrieve the document, the user may not be entitled to retrieve it, there may be a cost associated with gaining access to it, or the document may have been withdrawn and possibly replaced by a new version, to name just a few possibilities. The system typically provides feedback to the user about these situations.

As mentioned in Section 7.4, the degree or nature of the access granted to a particular user may be different if it is known that the user already has access to a printed copy of the document.

8.1. Authenticated Document Access

Access to the document may be restricted to specific users, or to those meeting particular criteria, or may only be available in certain circumstances, for example when the user is connected to a secure network. Section 6 describes some of the ways in which the credentials of a user and scanner may be established.

8.2. Document Purchase—Copyright-Owner Compensation

Documents that are not freely available to the general public may still be accessible on payment of a fee, often as compensation to the publisher or copyright-holder. The system may implement payment facilities directly or may make use of other payment methods associated with the user, including those described in Section 6.2.

8.3. Document Escrow and Proactive Retrieval

Electronic documents are often transient; the digital source version of a rendered document may be available now but inaccessible in future. The system may retrieve and store the existing version on behalf of the user, even if the user has not requested it, thus guaranteeing its availability should the user request it in future. This also makes it available for the system's use, for example for searching as part of the process of identifying future captures.

In the event that payment is required for access to the document, a trusted “document escrow” service can retrieve the document on behalf of the user, such as upon payment of a modest fee, with the assurance that the copyright holder will be fully compensated in future if the user should ever request the document from the service.

Variations on this theme can be implemented if the document is not available in electronic form at the time of capture. The user can authorize the service to submit a request for or make a payment for the document on his/her behalf if the electronic document should become available at a later date.

8.4. Association with Other Subscriptions and Accounts

Sometimes payment may be waived, reduced or satisfied based on the user's existing association with another account or subscription. Subscribers to the printed version of a newspaper might automatically be entitled to retrieve the electronic version, for example.

In other cases, the association may not be quite so direct: a user may be granted access based on an account established by their employer, or based on their scanning of a printed copy owned by a friend who is a subscriber.

8.5. Replacing Photocopying with Scan-and-Print

The process of capturing text from a paper document, identifying an electronic original, and printing that original, or some portion of that original associated with the capture, forms an alternative to traditional photocopying with many advantages:
the paper document need not be in the same location as the final printout, and in any case need not be there at the same time
the wear and damage caused to documents by the photocopying process, especially to old, fragile and valuable documents, can be avoided
the quality of the copy is typically be much higher
records may be kept about which documents or portions of documents are the most frequently copied
payment may be made to the copyright owner as part of the process
unauthorized copying may be prohibited

8.6. Locating Valuable Originals from Photocopies

When documents are particularly valuable, as in the case of legal instruments or documents that have historical or other particular significance, people may typically work from copies of those documents, often for many years, while the originals are kept in a safe location.

The described system could be coupled to a database which records the location of an original document, for example in an archiving warehouse, making it easy for somebody with access to a copy to locate the archived original paper document.

### 9. Text Recognition Technologies

Optical Character Recognition (OCR) technologies have traditionally focused on images that include a large amount of text, for example from a flat-bed scanner capturing a whole page. OCR technologies often need substantial training and correcting by the user to produce useful text. OCR technologies often require substantial processing power on the machine doing the OCR, and, while many systems use a dictionary, they are generally expected to operate on an effectively infinite vocabulary.

All of the above traditional characteristics may be improved upon in the described system.

While this section focuses on OCR, many of the issues discussed map directly onto other recognition technologies, in particular speech recognition. As mentioned in Section 3.1, the process of capturing from paper may be achieved by a user reading the text aloud into a device which captures audio. Those skilled in the art will appreciate that principles discussed here with respect to images, fonts, and text fragments often also apply to audio samples, user speech models and phonemes.

9.1. Optimization for Appropriate Devices

A scanning device for use with the described system will often be small, portable, and low power. The scanning device may capture only a few words at a time, and in some implementations does not even capture a whole character at once, but rather a horizontal slice through the text, many such slices being stitched together to form a recognizable signal from which the text may be deduced. The scanning device may also have very limited processing power or storage so, while in some embodiments it may perform all of the OCR process itself, many embodiments will depend on a connection to a more powerful device, possibly at a later time, to convert the captured signals into text. Lastly, it may have very limited facilities for user interaction, so may need to defer any requests for user input until later, or operate in a “best-guess” mode to a greater degree than is common now.

9.2. “Uncertain” OCR

The primary new characteristic of OCR within the described system is the fact that it will, in general, examine images of text which exists elsewhere and which may be retrieved in digital form. An exact transcription of the text is therefore not always required from the OCR engine. The OCR system may output a set or a matrix of possible matches, in some cases including probability weightings, which can still be used to search for the digital original.

9.3. Iterative OCR—Guess, Disambiguate, Guess . . . .

If the device performing the recognition is able to contact the document index at the time of processing, then the OCR process can be informed by the contents of the document corpus as it progresses, potentially offering substantially greater recognition accuracy.

Such a connection will also allow the device to inform the user when sufficient text has been captured to identify the digital source.

9.4. Using Knowledge of Likely Rendering

When the system has knowledge of aspects of the likely printed rendering of a document—such as the font typeface used in printing, or the layout of the page, or which sections are in italics—this too can help in the recognition process. (Section 4.1.1)

9.5. Font Caching—Determine Font on Host, Download to Client

As candidate source texts in the document corpus are identified, the font, or a rendering of it, may be downloaded to the device to help with the recognition.

9.6. Autocorrelation and Character Offsets

While component characters of a text fragment may be the most recognized way to represent a fragment of text that may be used as a document signature, other representations of the text may work sufficiently well that the actual text of a text fragment need not be used when attempting to locate the text fragment in a digital document and/or database, or when disambiguating the representation of a text fragment into a readable form. Other representations of text fragments may provide benefits that actual text representations lack. For example, optical character recognition of text fragments is often prone to errors, unlike other representations of captured text fragments that may be used to search for and/or recreate a text fragment without resorting to optical character recognition for the entire fragment. Such methods may be more appropriate for some devices used with the current system.

Those of ordinary skill in the art and others will appreciate that there are many ways of describing the appearance of text fragments. Such characterizations of text fragments may include, but are not limited to, word lengths, relative word lengths, character heights, character widths, character shapes, character frequencies, token frequencies, and the like. In some embodiments, the offsets between matching text tokens (i.e., the number of intervening tokens plus one) are used to characterize fragments of text.

Conventional OCR uses knowledge about fonts, letter structure and shape to attempt to determine characters in scanned text. Embodiments of the present invention are different; they employ a variety of methods that use the rendered text itself to assist in the recognition process. These embodiments use characters (or tokens) to “recognize each other.” One way to refer to such self-recognition is “template matching,” and is similar to “convolution.” To perform such self-recognition, the system slides a copy of the text horizontally over itself and notes matching regions of the text images. Prior template matching and convolution techniques encompass a variety of related techniques. These techniques to tokenize and/or recognize characters/tokens will be collectively referred to herein as “autocorrelation,” as the text is used to correlate with its own component parts when matching characters/tokens.

When autocorrelating, complete connected regions that match are of interest. This occurs when characters (or groups of characters) overlay other instances of the same character (or group). Complete connected regions that match automatically provide tokenizing of the text into component tokens. As the two copies of the text are slid past each other, the regions where perfect matching occurs (i.e., all pixels in a vertical slice are matched) are noted. When a character/token matches itself, the horizontal extent of this matching (e.g., the connected matching portion of the text) also matches.

Note that at this stage there is no need to determine the actual identity of each token (i.e., the particular letter, digit or symbol, or group of these, that corresponds to the token image), only the offset to the next occurrence of the same token in the scanned text. The offset number is the distance (number of tokens) to the next occurrence of the same token. If the token is unique within the text string, the offset is zero (0). The sequence of token offsets thus generated is a signature that can be used to identify the scanned text.

In some embodiments, the token offsets determined for a string of scanned tokens are compared to an index that indexes a corpus of electronic documents based upon the token offsets of their contents (Section 4.1.2). In other embodiments, the token offsets determined for a string of scanned tokens are converted to text, and compared to a more conventional index that indexes a corpus of electronic documents based upon their contents

As has been noted earlier, a similar token-correlation process may be applied to speech fragments when the capture process consists of audio samples of spoken words.

9.7. Font/Character “Self-Recognition”

Conventional template-matching OCR compares scanned images to a library of character images. In essence, the alphabet is stored for each font and newly scanned images are compared to the stored images to find matching characters. The process generally has an initial delay until the correct font has been identified. After that the OCR process is relatively quick because most documents use the same font throughout. Subsequent images can therefore be converted to text by comparison with the most recently identified font library.

The shapes of characters in most commonly used fonts are related. For example, in most fonts, the letter “c” and the letter “e” are visually related—as are “t” and “f,” etc. The OCR process is enhanced by use of this relationship to construct templates for letters that have not been scanned yet. For example, where a reader scans a short string of text from a paper document in a previously unencountered font such that the system does not have a set of image templates with which to compare the scanned images the system can leverage the probable relationship between certain characters to construct the font template library even though it has not yet encountered all of the letters in the alphabet. The system can then use the constructed font template library to recognize subsequent scanned text and to further refine the constructed font library.

9.8. Send Anything Unrecognized (Including Graphics) to Server

When images cannot be machine-transcribed into a form suitable for use in a search process, the images themselves can be saved for later use by the user, for possible manual transcription, or for processing at a later date when different resources may be available to the system.

### 10. P-Commerce

Many of the actions made possible by the system result in some commercial transaction taking place. The phrase p-commerce is used herein to describe commercial activities initiated from paper via the system.

10.1. Sales of Documents from their Physical Printed Copies.

When a user captures text from a document, the user may be offered that document for purchase either in paper or electronic form. The user may also be offered related documents, such as those quoted or otherwise referred to in the paper document, or those on a similar subject, or those by the same author.

10.2. Sales of Anything Else Initiated or Aided by Paper

The capture of text may be linked to other commercial activities in a variety of ways. The captured text may be in a catalog that is explicitly designed to sell items, in which case the text will be associated fairly directly with the purchase of an item (Section 18.2). The text may also be part of an advertisement, in which case a sale of the item being advertised may ensue.

In other cases, the user captures other text from which their potential interest in a commercial transaction may be deduced. A reader of a novel set in a particular country, for example, might be interested in a holiday there. Someone reading a review of a new car might be considering purchasing it. The user may capture a particular fragment of text knowing that some commercial opportunity will be presented to them as a result, or it may be a side-effect of their capture activities.

10.3. Capture of Labels, Icons, Serial Numbers, Barcodes on an Item Resulting in a Sale

Sometimes text or symbols are actually printed on an item or its packaging. An example is the serial number or product id often found on a label on the back or underside of a piece of electronic equipment. The system can offer the user a convenient way to purchase one or more of the same items by capturing that text. They may also be offered manuals, support or repair services.

10.4. Contextual Advertisements

In addition to the direct capture of text from an advertisement, the system allows for a new kind of advertising which is not necessarily explicitly in the rendered document, but is nonetheless based on what people are reading.

10.4.1. Advertising Based on Scan Context and History

In a traditional paper publication, advertisements generally consume a large amount of space relative to the text of a newspaper article, and a limited number of them can be placed around a particular article. In the described system, advertising can be associated with individual words or phrases, and can selected according to the particular interest the user has shown by capturing that text and possibly taking into account their history of past scans.

With the described system, it is possible for a purchase to be tied to a particular printed document and for an advertiser to get significantly more feedback about the effectiveness of their advertising in particular print publications.

10.4.2. Advertising Based on User Context and History

The system may gather a large amount of information about other aspects of a user's context for its own use (Section 13); estimates of the geographical location of the user are a good example. Such data can also be used to tailor the advertising presented to a user of the system.

10.5. Models of Compensation

The system enables some new models of compensation for advertisers and marketers. The publisher of a printed document containing advertisements may receive some income from a purchase that originated from their document. This may be true whether or not the advertisement existed in the original printed form; it may have been added electronically either by the publisher, the advertiser or some third party, and the sources of such advertising may have been subscribed to by the user.

10.5.1. Popularity-Based Compensation

Analysis of the statistics generated by the system can reveal the popularity of certain parts of a publication (Section 14.2). In a newspaper, for example, it might reveal the amount of time readers spend looking at a particular page or article, or the popularity of a particular columnist. In some circumstances, it may be appropriate for an author or publisher to receive compensation based on the activities of the readers rather than on more traditional metrics such as words written or number of copies distributed. An author whose work becomes a frequently read authority on a subject might be considered differently in future contracts from one whose books have sold the same number of copies but are rarely opened. (See also Section 7.6)

10.5.2. Popularity-Based Advertising

Decisions about advertising in a document may also be based on statistics about the readership. The advertising space around the most popular columnists may be sold at a premium rate. Advertisers might even be charged or compensated some time after the document is published based on knowledge about how it was received.

10.6. Marketing Based on Life Library

The “Life Library” or scan history described in Sections 6.1 and 16.1 can be an extremely valuable source of information about the interests and habits of a user. Subject to the appropriate consent and privacy issues, such data can inform offers of goods or services to the user. Even in an anonymous form, the statistics gathered can be exceedingly useful.

10.7. Sale/Information at Later Date (when Available)

Advertising and other opportunities for commercial transactions may not be presented to the user immediately at the time of text capture. For example, the opportunity to purchase a sequel to a novel may not be available at the time the user is reading the novel, but the system may present them with that opportunity when the sequel is published.

A user may capture data that relates to a purchase or other commercial transaction, but may choose not to initiate and/or complete the transaction at the time the capture is made. In some embodiments, data related to captures is stored in a user's Life Library, and these Life Library entries can remain “active” (i.e., capable of subsequent interactions similar to those available at the time the capture was made). Thus a user may review a capture at some later time, and optionally complete a transaction based on that capture. Because the system can keep track of when and where the original capture occurred, all parties involved in the transaction can be properly compensated. For example, the author who wrote the story—and the publisher who published the story—that appeared next to the advertisement from which the user captured data can be compensated when, six months later, the user visits their Life Library, selects that particular capture from the history, and chooses “Purchase this item at Amazon” from the pop-up menu (which can be similar or identical to the menu optionally presented at the time of the capture).

### 11. Operating System and Application Integration

Modern Operating Systems (OSs) and other software packages have many characteristics that can be advantageously exploited for use with the described system, and may also be modified in various ways to provide an even better platform for its use.

11.1. Incorporation of Scan and Print-Related Information in Metadata and Indexing

New and upcoming file systems and their associated databases often have the ability to store a variety of metadata associated with each file. Traditionally, this metadata has included such things as the ID of the user who created the file, the dates of creation, last modification, and last use. Newer file systems allow such extra information as keywords, image characteristics, document sources and user comments to be stored, and in some systems this metadata can be arbitrarily extended. File systems can therefore be used to store information that would be useful in implementing the current system. For example, the date when a given document was last printed can be stored by the file system, as can details about which text from it has been captured from paper using the described system, and when and by whom.

Operating systems are also starting to incorporate search engine facilities that allow users to find local files more easily. These facilities can be advantageously used by the system. It means that many of the search-related concepts discussed in Sections 3 and 4 apply not just to today's Internet-based and similar search engines, but also to every personal computer.

In some cases specific software applications will also include support for the system above and beyond the facilities provided by the OS.

11.2. OS Support for Capture Devices

As the use of capture devices such as pen scanners becomes increasingly common, it will become desirable to build support for them into the operating system, in much the same way as support is provided for mice and printers, since the applicability of capture devices extends beyond a single software application. The same will be true for other aspects of the system's operation. Some examples are discussed below. In some embodiments, the entire described system, or the core of it, is provided by the OS. In some embodiments, support for the system is provided by Application Programming Interfaces (APIs) that can be used by other software packages, including those directly implementing aspects of the system.

11.2.1. Support for OCR and Other Recognition Technologies

Most of the methods of capturing text from a rendered document require some recognition software to interpret the source data, typically a scanned image or some spoken words, as text suitable for use in the system. Some OSs include support for speech or handwriting recognition, though it is less common for OSs to include support for OCR, since in the past the use of OCR has typically been limited to a small range of applications.

As recognition components become part of the OS, they can take better advantage of other facilities provided by the OS. Many systems include spelling dictionaries, grammar analysis tools, internationalization and localization facilities, for example, all of which can be advantageously employed by the described system for its recognition process, especially since they may have been customized for the particular user to include words and phrases that he/she would commonly encounter.

If the operating system includes full-text indexing facilities, then these can also be used to inform the recognition process, as described in Section 9.3.

11.2.2. Action to be Taken on Scans

If an optical scan or other capture occurs and is presented to the OS, it may have a default action to be taken under those circumstances in the event that no other subsystem claims ownership of the capture. An example of a default action is presenting the user with a choice of alternatives, or submitting the captured text to the OS's built-in search facilities.

11.2.3. OS has Default Action for Particular Documents or Document Types

If the digital source of the rendered document is found, the OS may have a standard action that it will take when that particular document, or a document of that class, is scanned. Applications and other subsystems may register with the OS as potential handlers of particular types of capture, in a similar manner to the announcement by applications of their ability to handle certain file types.

Markup data associated with a rendered document, or with a capture from a document, can include instructions to the operating system to launch specific applications, pass applications arguments, parameters, or data, etc.

11.2.4. Interpretation of Gestures and Mapping into Standard Actions

In Section 12.1.3 the use of “gestures” is discussed, particularly in the case of optical scanning, where particular movements made with a handheld scanner might represent standard actions such as marking the start and end of a region of text.

This is analogous to actions such as pressing the shift key on a keyboard while using the cursor keys to select a region of text, or using the wheel on a mouse to scroll a document. Such actions by the user are sufficiently standard that they are interpreted in a system-wide way by the OS, thus ensuring consistent behavior. The same is desirable for scanner gestures and other scanner-related actions.

11.2.5. Set Response to Standard (and Non-Standard) Iconic/Text Printed Menu Items

In a similar way, certain items of text or other symbols may, when scanned, cause standard actions to occur, and the OS may provide a selection of these. An example might be that scanning the text “[print]” in any document would cause the OS to retrieve and print a copy of that document. The OS may also provide a way to register such actions and associate them with particular scans.

11.3. Support in System GUI Components for Typical Scan-Initiated Activities

Most software applications are based substantially on standard Graphical User Interface components provided by the OS.

Use of these components by developers helps to ensure consistent behavior across multiple packages, for example that pressing the left-cursor key in any text-editing context should move the cursor to the left, without every programmer having to implement the same functionality independently.

A similar consistency in these components is desirable when the activities are initiated by text-capture or other aspects of the described system. Some examples are given below.

11.3.1. Interface to Find Particular Text Content

A typical use of the system may be for the user to scan an area of a paper document, and for the system to open the electronic counterpart in a software package that is able to display or edit it, and cause that package to scroll to and highlight the scanned text (Section 12.2.1). The first part of this process, finding and opening the electronic document, is typically provided by the OS and is standard across software packages. The second part, however—locating a particular piece of text within a document and causing the package to scroll to it and highlight it—is not yet standardized and is often implemented differently by each package. The availability of a standard API for this functionality could greatly enhance the operation of this aspect of the system.

11.3.2. Text Interactions

Once a piece of text has been located within a document, the system may wish to perform a variety of operations upon that text. As an example, the system may request the surrounding text, so that the user's capture of a few words could result in the system accessing the entire sentence or paragraph containing them. Again, this functionality can be usefully provided by the OS rather than being implemented in every piece of software that handles text.

11.3.3. Contextual (Popup) Menus

Some of the operations that are enabled by the system will require user feedback, and this may be optimally requested within the context of the application handling the data. In some embodiments, the system uses the application pop-up menus traditionally associated with clicking the right mouse button on some text. The system inserts extra options into such menus, and causes them to be displayed as a result of activities such as scanning a paper document.

11.4. Web/Network Interfaces

In today's increasingly networked world, much of the functionality available on individual machines can also be accessed over a network, and the functionality associated with the described system is no exception. As an example, in an office environment, many paper documents received by a user may have been printed by other users' machines on the same corporate network. The system on one computer, in response to a capture, may be able to query those other machines for documents which may correspond to that capture, subject to the appropriate permission controls.

11.5. Printing of Document Causes Saving

An important factor in the integration of paper and digital documents is maintaining as much information as possible about the transitions between the two. In some embodiments, the OS keeps a simple record of when any document was printed and by whom. In some embodiments, the OS takes one or more further actions that would make it better suited for use with the system. Examples include:
Saving the digital rendered version of every document printed along with information about the source from which it was printed
Saving a subset of useful information about the printed version—for example, the fonts used and where the line breaks occur—which might aid future scan interpretation
Saving the version of the source document associated with any printed copy
Indexing the document automatically at the time of printing and storing the results for future searching

11.6. My (Printed/Scanned) Documents

An OS often maintains certain categories of folders or files that have particular significance. A user's documents may, by convention or design, be found in a “My Documents” folder, for example. Standard file-opening dialogs may automatically include a list of recently opened documents.

On an OS optimized for use with the described system, such categories may be enhanced or augmented in ways that take into account a user's interaction with paper versions of the stored files. Categories such as “My Printed Documents” or “My Recently-Read Documents” might usefully be identified and incorporated in its operations.

11.7. OS-Level Markup Hierarchies

Since important aspects of the system are typically provided using the “markup” concepts discussed in Section 5, it would clearly be advantageous to have support for such markup provided by the OS in a way that was accessible to multiple applications as well as to the OS itself. In addition, layers of markup may be provided by the OS, based on its own knowledge of documents under its control and the facilities it is able to provide.

11.8. Use of OS DRM facilities

An increasing number of operating systems support some form of “Digital Rights Management”: the ability to control the use of particular data according to the rights granted to a particular user, software entity or machine. It may inhibit unauthorized copying or distribution of a particular document, for example.

### 12. User Interface

The user interface of the system may be entirely on a PC, if the capture device is relatively dumb and is connected to it by a cable, or entirely on the device, if it is sophisticated and with significant processing power of its own. In some cases, some functionality resides in each component. Part, or indeed all, of the system's functionality may also be implemented on other devices such as mobile phones or PDAs.

The descriptions in the following sections are therefore indications of what may be desirable in certain implementations, but they are not necessarily appropriate for all and may be modified in several ways.

12.1. On the Capture Device

With all capture devices, but particularly in the case of an optical scanner, the user's attention will generally be on the device and the paper at the time of scanning. It is very desirable, then, that any input and feedback needed as part of the process of scanning do not require the user's attention to be elsewhere, for example on the screen of a computer, more than is necessary.

12.1.1. Feedback on Scanner

A handheld scanner may have a variety of ways of providing feedback to the user about particular conditions. The most obvious types are direct visual, where the scanner incorporates indicator lights or even a full display, and auditory, where the scanner can make beeps, clicks or other sounds. Important alternatives include tactile feedback, where the scanner can vibrate, buzz, or otherwise stimulate the user's sense of touch, and projected feedback, where it indicates a status by projecting onto the paper anything from a colored spot of light to a sophisticated display.

Important immediate feedback that may be provided on the device includes:
feedback on the scanning process—user scanning too fast, at too great an angle, or drifting too high or low on a particular line
sufficient content—enough has been scanned to be pretty certain of finding a match if one exists—important for disconnected operation
context known—a source of the text has been located
unique context known—one unique source of the text has been located
availability of content—indication of whether the content is freely available to the user, or at a cost

Many of the user interactions normally associated with the later stages of the system may also take place on the capture device if it has sufficient abilities, for example, to display part or all of a document.

12.1.2. Controls on Scanner

The device may provide a variety of ways for the user to provide input in addition to basic text capture. Even when the device is in close association with a host machine that has input options such as keyboards and mice, it can be disruptive for the user to switch back and forth between manipulating the scanner and using a mouse, for example.

The handheld scanner may have buttons, scroll/jog-wheels, touch-sensitive surfaces, and/or accelerometers for detecting the movement of the device. Some of these allow a richer set of interactions while still holding the scanner.

For example, in response to scanning some text, the system presents the user with a set of several possible matching documents. The user uses a scroll-wheel on the side of the scanner is to select one from the list, and clicks a button to confirm the selection.

12.1.3. Gestures

The primary reason for moving a scanner across the paper is to capture text, but some movements may be detected by the device and used to indicate other user intentions. Such movements are referred to herein as “gestures.”

As an example, the user can indicate a large region of text by scanning the first few words in conventional left-to-right order, and the last few in reverse order, i.e. right to left. The user can also indicate the vertical extent of the text of interest by moving the scanner down the page over several lines. A backwards scan might indicate cancellation of the previous scan operation.

12.1.4. Online/Offline behavior

Many aspects of the system may depend on network connectivity, either between components of the system such as a scanner and a host laptop, or with the outside world in the form of a connection to corporate databases and Internet search. This connectivity may not be present all the time, however, and so there will be occasions when part or all of the system may be considered to be “offline.” It is desirable to allow the system to continue to function usefully in those circumstances.

The device may be used to capture text when it is out of contact with other parts of the system. A very simple device may simply be able to store the image or audio data associated with the capture, ideally with a timestamp indicating when it was captured. The various captures may be uploaded to the rest of the system when the device is next in contact with it, and handled then. The device may also upload other data associated with the captures, for example voice annotations associated with optical scans, or location information.

More sophisticated devices may be able to perform some or all of the system operations themselves despite being disconnected. Various techniques for improving their ability to do so are discussed in Section 15.3. Often it will be the case that some, but not all, of the desired actions can be performed while offline. For example, the text may be recognized, but identification of the source may depend on a connection to an Internet-based search engine. In some embodiments, the device therefore stores sufficient information about how far each operation has progressed for the rest of the system to proceed efficiently when connectivity is restored.

The operation of the system will, in general, benefit from immediately available connectivity, but there are some situations in which performing several captures and then processing them as a batch can have advantages. For example, as discussed in Section 13 below, the identification of the source of a particular capture may be greatly enhanced by examining other captures made by the user at approximately the same time. In a fully connected system where live feedback is being provided to the user, the system is only able to use past captures when processing the current one. If the capture is one of a batch stored by the device when offline, however, the system will be able to take into account any data available from later captures as well as earlier ones when doing its analysis.

12.2. On a Host Device

A scanner will often communicate with some other device, such as a PC, PDA, phone or digital camera to perform many of the functions of the system, including more detailed interactions with the user.

12.2.1. Activities Performed in Response to a Capture

When the host device receives a capture, it may initiate a variety of activities. An incomplete list of possible activities performed by the system after locating and electronic counterpart document associated with the capture and a location within that document follows.
The details of the capture may be stored in the user's history. (Section 6.1)
The document may be retrieved from local storage or a remote location. (Section 8)
The operating system's metadata and other records associated with the document may be updated. (Section 11.1)
Markup associated with the document may be examined to determine the next relevant operations. (Section 5)
A software application may be started to edit, view or otherwise operate on the document. The choice of application may depend on the source document, or on the contents of the scan, or on some other aspect of the capture. (Section 11.2.2, 11.2.3)
The application may scroll to, highlight, move the insertion point to, or otherwise indicate the location of the capture. (Section 11.3)
The precise bounds of the captured text may be modified, for example to select whole words, sentences or paragraphs around the captured text. (Section 11.3.2)
The user may be given the option to copy the capture text to the clipboard or perform other standard operating system or application-specific operations upon it.
Annotations may be associated with the document or the captured text. These may come from immediate user input, or may have been captured earlier, for example in the case of voice annotations associated with an optical scan. (Section 19.4)
Markup may be examined to determine a set of further possible operations for the user to select.

12.2.2. Contextual Popup Menus

Sometimes the appropriate action to be taken by the system will be obvious, but sometimes it will require a choice to be made by the user. One good way to do this is through the use of “popup menus” or, in cases where the content is also being displayed on a screen, with so-called “contextual menus” that appear close to the content. (See Section 11.3.3). In some embodiments, the scanner device projects a popup menu onto the paper document. A user may select from such menus using traditional methods such as a keyboard and mouse, or by using controls on the capture device (Section 12.1.2), gestures (Section 12.1.3), or by interacting with the computer display using the scanner (Section 12.2.4). In some embodiments, the popup menus which can appear as a result of a capture include default items representing actions which occur if the user does not respond—for example, if the user ignores the menu and makes another capture.

12.2.3. Feedback on Disambiguation

When a user starts capturing text, there will initially be several documents or other text locations that it could match. As more text is captured, and other factors are taken into account (Section 13), the number of candidate locations will decrease until the actual location is identified, or further disambiguation is not possible without user input. In some embodiments, the system provides a real-time display of the documents or the locations found, for example in list, thumbnail-image or text-segment form, and for the number of elements in that display to reduce in number as capture continues. In some embodiments, the system displays thumbnails of all candidate documents, where the size or position of the thumbnail is dependent on the probability of it being the correct match.

When a capture is unambiguously identified, this fact may be emphasized to the user, for example using audio feedback.

Sometimes the text captured will occur in many documents and will be recognized to be a quotation. The system may indicate this on the screen, for example by grouping documents containing a quoted reference around the original source document.

12.2.4. Scanning from Screen

Some optical scanners may be able to capture text displayed on a screen as well as on paper. Accordingly, the term rendered document is used herein to indicate that printing onto paper is not the only form of rendering, and that the capture of text or symbols for use by the system may be equally valuable when that text is displayed on an electronic display.

The user of the described system may be required to interact with a computer screen for a variety of other reasons, such as to select from a list of options. It can be inconvenient for the user to put down the scanner and start using the mouse or keyboard. Other sections have described physical controls on the scanner (Section 12.1.2) or gestures (Section 12.1.3) as methods of input which do not require this change of tool, but using the scanner on the screen itself to scan some text or symbol is an important alternative provided by the system.

In some embodiments, the optics of the scanner allow it to be used in a similar manner to a light-pen, directly sensing its position on the screen without the need for actual scanning of text, possibly with the aid of special hardware or software on the computer.

### 13. Context Interpretation

An important aspect of the described system is the use of other factors, beyond the simple capture of a string of text, to help identify the document in use. A capture of a modest amount of text may often identify the document uniquely, but in many situations it will identify a few candidate documents. One solution is to prompt the user to confirm the document being scanned, but a preferable alternative is to make use of other factors to narrow down the possibilities automatically. Such supplemental information can dramatically reduce the amount of text that needs to be captured and/or increase the reliability and speed with which the location in the electronic counterpart can be identified. This extra material is referred to as “context,” and it was discussed briefly in Section 4.2.2. We now consider it in more depth.

13.1. System and Capture Context

Perhaps the most important example of such information is the user's capture history.

It is highly probable that any given capture comes from the same document as the previous one, or from an associated document, especially if the previous capture took place in the last few minutes (Section 6.1.2). Conversely, if the system detects that the font has changed between two scans, it is more likely that they are from different documents.

Also useful are the user's longer-term capture history and reading habits. These can also be used to develop a model of the user's interests and associations.

13.2. User's Real-World Context

Another example of useful context is the user's geographical location. A user in Paris is much more likely to be reading Le Monde than the Seattle Times, for example. The timing, size and geographical distribution of printed versions of the documents can therefore be important, and can to some degree be deduced from the operation of the system.

The time of day may also be relevant, for example in the case of a user who always reads one type of publication on the way to work, and a different one at lunchtime or on the train going home.

13.3. Related Digital Context

The user's recent use of electronic documents, including those searched for or retrieved by more conventional means, can also be a helpful indicator.

In some cases, such as on a corporate network, other factors may be usefully considered:
Which documents have been printed recently?
Which documents have been modified recently on the corporate file server?
Which documents have been emailed recently?

All of these examples might suggest that a user was more likely to be reading a paper version of those documents. In contrast, if the repository in which a document resides can affirm that the document has never been printed or sent anywhere where it might have been printed, then it can be safely eliminated in any searches originating from paper.

13.4. Other Statistics—the Global Context

Section 14 covers the analysis of the data stream resulting from paper-based searches, but it should be noted here that statistics about the popularity of documents with other readers, about the timing of that popularity, and about the parts of documents most frequently scanned are all examples of further factors which can be beneficial in the search process. The system brings the possibility of Google-type page-ranking to the world of paper.

See also Section 4.2.2 for some other implications of the use of context for search engines.

### 14. Data-Stream Analysis

The use of the system generates an exceedingly valuable data-stream as a side effect. This stream is a record of what users are reading and when, and is in many cases a record of what they find particularly valuable in the things they read. Such data has never really been available before for paper documents.

Some ways in which this data can be useful for the system, and for the user of the system, are described in Section 6.1. This section concentrates on its use for others. There are, of course, substantial privacy issues to be considered with any distribution of data about what people are reading, but such issues as preserving the anonymity of data are well known to those of skill in the art.

14.1. Document Tracking

When the system knows which documents any given user is reading, it can also deduce who is reading any given document. This allows the tracking of a document through an organization, to allow analysis, for example, of who is reading it and when, how widely it was distributed, how long that distribution took, and who has seen current versions while others are still working from out-of-date copies.

For published documents that have a wider distribution, the tracking of individual copies is more difficult, but the analysis of the distribution of readership is still possible.

14.2. Read Ranking—Popularity of Documents and Sub-Regions

In situations where users are capturing text or other data that is of particular interest to them, the system can deduce the popularity of certain documents and of particular sub-regions of those documents. This forms a valuable input to the system itself (Section 4.2.2) and an important source of information for authors, publishers and advertisers (Section 7.6, Section 10.5). This data is also useful when integrated in search engines and search indices—for example, to assist in ranking search results for queries coming from rendered documents, and/or to assist in ranking conventional queries typed into a web browser.

14.3. Analysis of Users—Building Profiles

Knowledge of what a user is reading enables the system to create a quite detailed model of the user's interests and activities. This can be useful on an abstract statistical basis—“35% of users who buy this newspaper also read the latest book by that author”—but it can also allow other interactions with the individual user, as discussed below.

14.3.1. Social Networking

One example is connecting one user with others who have related interests. These may be people already known to the user. The system may ask a university professor, “Did you know that your colleague at XYZ University has also just read this paper?” The system may ask a user, “Do you want to be linked up with other people in your neighborhood who are also how reading Jane Eyre?” Such links may be the basis for the automatic formation of book clubs and similar social structures, either in the physical world or online.

14.3.2. Marketing

Section 10.6 has already mentioned the idea of offering products and services to an individual user based on their interactions with the system. Current online booksellers, for example, often make recommendations to a user based on their previous interactions with the bookseller. Such recommendations become much more useful when they are based on interactions with the actual books.

14.4. Marketing Based on Other Aspects of the Data-Stream

We have discussed some of the ways in which the system may influence those publishing documents, those advertising through them, and other sales initiated from paper (Section 10). Some commercial activities may have no direct interaction with the paper documents at all and yet may be influenced by them. For example, the knowledge that people in one community spend more time reading the sports section of the newspaper than they do the financial section might be of interest to somebody setting up a health club.

14.5. Types of Data that May be Captured

In addition to the statistics discussed, such as who is reading which bits of which documents, and when and where, it can be of interest to examine the actual contents of the text captured, regardless of whether or not the document has been located.

In many situations, the user will also not just be capturing some text, but will be causing some action to occur as a result. It might be emailing a reference to the document to an acquaintance, for example. Even in the absence of information about the identity of the user or the recipient of the email, the knowledge that somebody considered the document worth emailing is very useful.

In addition to the various methods discussed for deducing the value of a particular document or piece of text, in some circumstances the user will explicitly indicate the value by assigning it a rating.

Lastly, when a particular set of users are known to form a group, for example when they are known to be employees of a particular company, the aggregated statistics of that group can be used to deduce the importance of a particular document to that group.

### 15. Device Features and Functions

A capture device for use with the system needs little more than a way of capturing text from a rendered version of the document. As described earlier (Section 1.2), this capture may be achieved through a variety of methods including taking a photograph of part of the document or typing some words into a mobile phone keypad. This capture may be achieved using a small hand-held optical scanner capable of recording a line or two of text at a time, or an audio capture device such as a voice-recorder into which the user is reading text from the document. The device used may be a combination of these—an optical scanner which could also record voice annotations, for example—and the capturing functionality may be built into some other device such as a mobile phone, PDA, digital camera or portable music player.

15.1. Input and Output

Many of the possibly beneficial additional input and output facilities for such a device have been described in Section 12.1. They include buttons, scroll-wheels and touch-pads for input, and displays, indicator lights, audio and tactile transducers for output. Sometimes the device will incorporate many of these, sometimes very few. Sometimes the capture device will be able to communicate with another device that already has them (Section 15.6), for example using a wireless link, and sometimes the capture functionality will be incorporated into such other device (Section 15.7).

15.2. Connectivity

In some embodiments, the device implements the majority of the system itself. In some embodiments, however, it often communicates with a PC or other computing device and with the wider world using communications facilities.

Often these communications facilities are in the form of a general-purpose data network such as Ethernet, 802.11 or UWB or a standard peripheral-connecting network such as USB, IEEE-1394 (Firewire), Bluetooth™ or infra-red. When a wired connection such as Firewire or USB is used, the device may receive electrical power though the same connection. In some circumstances, the capture device may appear to a connected machine to be a conventional peripheral such as a USB storage device.

Lastly, the device may in some circumstances “dock” with another device, either to be used in conjunction with that device or for convenient storage.

15.3. Caching and Other Online/Offline Functionality

Sections 3.5 and 12.1.4 have raised the topic of disconnected operation. When a capture device has a limited subset of the total system's functionality, and is not in communication with the other parts of the system, the device can still be useful, though the functionality available will sometimes be reduced. At the simplest level, the device can record the raw image or audio data being captured and this can be processed later. For the user's benefit, however, it can be important to give feedback where possible about whether the data captured is likely to be sufficient for the task in hand, whether it can be recognized or is likely to be recognizable, and whether the source of the data can be identified or is likely to be identifiable later. The user will then know whether their capturing activity is worthwhile. Even when all of the above are unknown, the raw data can still be stored so that, at the very least, the user can refer to them later. The user may be presented with the image of a scan, for example, when the scan cannot be recognized by the OCR process.

To illustrate some of the range of options available, both a rather minimal optical scanning device and then a much more full-featured one are described below. Many devices occupy a middle ground between the two.

15.3.1. The SimpleScanner—a Low-End Offline Example

The SimpleScanner has a scanning head able to read pixels from the page as it is moved along the length of a line of text. It can detect its movement along the page and record the pixels with some information about the movement. It also has a clock, which allows each scan to be time-stamped. The clock is synchronized with a host device when the SimpleScanner has connectivity. The clock may not represent the actual time of day, but relative times may be determined from it so that the host can deduce the actual time of a scan, or at worst the elapsed time between scans.

The SimpleScanner does not have sufficient processing power to perform any OCR itself, but it does have some basic knowledge about typical word-lengths, word-spacings, and their relationship to font size. It has some basic indicator lights which tell the user whether the scan is likely to be readable, whether the head is being moved too fast, too slowly or too inaccurately across the paper, and when it determines that sufficient words of a given size are likely to have been scanned for the document to be identified.

The SimpleScanner has a USB connector and can be plugged into the USB port on a computer, where it will be recharged. To the computer it appears to be a USB storage device on which time-stamped data files have been recorded, and the rest of the system software takes over from this point.

15.3.2. The SuperScanner—a High-End Offline Example

The SuperScanner also depends on connectivity for its full operation, but it has a significant amount of on-board storage and processing which can help it make better judgments about the data captured while offline.

As it moves along the line of text, the captured pixels are stitched together and passed to an OCR engine that attempts to recognize the text. A number of fonts, including those from the user's most-read publications, have been downloaded to it to help perform this task, as has a dictionary that is synchronized with the user's spelling-checker dictionary on their PC and so contains many of the words they frequently encounter. Also stored on the scanner is a list of words and phrases with the typical frequency of their use—this may be combined with the dictionary. The scanner can use the frequency statistics both to help with the recognition process and also to inform its judgment about when a sufficient quantity of text has been captured; more frequently used phrases are less likely to be useful as the basis for a search query.

In addition, the full index for the articles in the recent issues of the newspapers and periodicals most commonly read by the user are stored on the device, as are the indices for the books the user has recently purchased from an online bookseller, or from which the user has scanned anything within the last few months. Lastly, the titles of several thousand of the most popular publications which have data available for the system are stored so that, in the absence of other information the user can scan the title and have a good idea as to whether or not captures from a particular work are likely to be retrievable in electronic form later.

During the scanning process, the system informs user that the captured data has been of sufficient quality and of a sufficient nature to make it probable that the electronic copy can be retrieved when connectivity is restored. Often the system indicates to the user that the scan is known to have been successful and that the context has been recognized in one of the on-board indices, or that the publication concerned is known to be making its data available to the system, so the later retrieval ought to be successful.

The SuperScanner docks in a cradle connected to a PC's Firewire or USB port, at which point, in addition to the upload of captured data, its various onboard indices and other databases are updated based on recent user activity and new publications. It also has the facility to connect to wireless public networks or to communicate via Bluetooth to a mobile phone and thence with the public network when such facilities are available.

15.4. Features for Optical Scanning

We now consider some of the features that may be particularly desirable in an optical scanner device.

15.4.1. Flexible Positioning and Convenient Optics

One of the reasons for the continuing popularity of paper is the ease of its use in a wide variety of situations where a computer, for example, would be impractical or inconvenient. A device intended to capture a substantial part of a user's interaction with paper should therefore be similarly convenient in use. This has not been the case for scanners in the past; even the smallest hand-held devices have been somewhat unwieldy. Those designed to be in contact with the page have to be held at a precise angle to the paper and moved very carefully along the length of the text to be scanned. This is acceptable when scanning a business report on an office desk, but may be impractical when scanning a phrase from a novel while waiting for a train. Scanners based on camera-type optics that operate at a distance from the paper may similarly be useful in some circumstances.

Some embodiments of the system use a scanner that scans in contact with the paper, and which, instead of lenses, uses an image conduit a bundle of optical fibers to transmit the image from the page to the optical sensor device. Such a device can be shaped to allow it to be held in a natural position; for example, in some embodiments, the part in contact with the page is wedge-shaped, allowing the user's hand to move more naturally over the page in a movement similar to the use of a highlighter pen. The conduit is either in direct contact with the paper or in close proximity to it, and may have a replaceable transparent tip that can protect the image conduit from possible damage. As has been mentioned in Section 12.2.4, the scanner may be used to scan from a screen as well as from paper, and the material of the tip can be chosen to reduce the likelihood of damage to such displays.

Lastly, some embodiments of the device will provide feedback to the user during the scanning process which will indicate through the use of light, sound or tactile feedback when the user is scanning too fast, too slow, too unevenly or is drifting too high or low on the scanned line.

15.5. Security, Identity, Authentication, Personalization and Billing

As described in Section 6, the capture device may form an important part of identification and authorization for secure transactions, purchases, and a variety of other operations. It may therefore incorporate, in addition to the circuitry and software required for such a role, various hardware features that can make it more secure, such as a smartcard reader, RFID, or a keypad on which to type a PIN.

It may also include various biometric sensors to help identify the user. In the case of an optical scanner, for example, the scanning head may also be able to read a fingerprint. For a voice recorder, the voice pattern of the user may be used.

15.6. Device Associations

In some embodiments, the device is able to form an association with other nearby devices to increase either its own or their functionality. In some embodiments, for example, it uses the display of a nearby PC or phone to give more detailed feedback about its operation, or uses their network connectivity. The device may, on the other hand, operate in its role as a security and identification device to authenticate operations performed by the other device. Or it may simply form an association in order to function as a peripheral to that device.

An interesting aspect of such associations is that they may be initiated and authenticated using the capture facilities of the device. For example, a user wishing to identify themselves securely to a public computer terminal may use the scanning facilities of the device to scan a code or symbol displayed on a particular area of the terminal's screen and so effect a key transfer. An analogous process may be performed using audio signals picked up by a voice-recording device.

15.7. Integration with Other Devices

In some embodiments, the functionality of the capture device is integrated into some other device that is already in use. The integrated devices may be able to share a power supply, data capture and storage capabilities, and network interfaces. Such integration may be done simply for convenience, to reduce cost, or to enable functionality that would not otherwise be available.

Some examples of devices into which the capture functionality can be integrated include:
an existing peripheral such as a mouse, a stylus, a USB “webcam” camera, a Bluetooth™ headset or a remote control
another processing/storage device, such as a PDA, an MP3 player, a voice recorder, a digital camera or a mobile phone
other often-carried items, just for convenience—a watch, a piece of jewelry, a pen, a car key fob

15.7.1. Mobile Phone Integration

As an example of the benefits of integration, we consider the use of a modified mobile phone as the capture device.

In some embodiments, the phone hardware is not modified to support the system, such as where the text capture can be adequately done through voice recognition, where they can either be processed by the phone itself, or handled by a system at the other end of a telephone call, or stored in the phone's memory for future processing. Many modern phones have the ability to download software that could implement some parts of the system. Such voice capture is likely to be suboptimal in many situations, however, for example when there is substantial background noise, and accurate voice recognition is a difficult task at the best of times. The audio facilities may best be used to capture voice annotations.

In some embodiments, the camera built into many mobile phones is used to capture an image of the text. The phone display, which would normally act as a viewfinder for the camera, may overlay on the live camera image information about the quality of the image and its suitability for OCR, which segments of text are being captured, and even a transcription of the text if the OCR can be performed on the phone.

In some embodiments, the phone is modified to add dedicated capture facilities, or to provide such functionality in a clip-on adaptor or a separate Bluetooth-connected peripheral in communication with the phone. Whatever the nature of the capture mechanism, the integration with a modern cell phone has many other advantages. The phone has connectivity with the wider world, which means that queries can be submitted to remote search engines or other parts of the system, and copies of documents may be retrieved for immediate storage or viewing. A phone typically has sufficient processing power for many of the functions of the system to be performed locally, and sufficient storage to capture a reasonable amount of data. The amount of storage can also often be expanded by the user. Phones have reasonably good displays and audio facilities to provide user feedback, and often a vibrate function for tactile feedback. They also have good power supplies.

Most significantly of all, they are a device that most users are already carrying.

Part III—Example Applications of the System

This section lists example uses of the system and applications that may be built on it. This list is intended to be purely illustrative and in no sense exhaustive.

### 16. Personal Applications

16.1. Life Library

The Life Library (see also Section 6.1.1) is a digital archive of any important documents that the subscriber wishes to save and is a set of embodiments of services of this system. Important books, magazine articles, newspaper clippings, etc., can all be saved in digital form in the Life Library. Additionally, the subscriber's annotations, comments, and notes can be saved with the documents. The Life Library can be accessed via the Internet and World Wide Web.

The system creates and manages the Life Library document archive for subscribers. The subscriber indicates which documents the subscriber wishes to have saved in his life library by scanning information from the document or by otherwise indicating to the system that the particular document is to be added to the subscriber's Life Library. The scanned information is typically text from the document but can also be a barcode or other code identifying the document. The system accepts the code and uses it to identify the source document. After the document is identified the system can store either a copy of the document in the user's Life Library or a link to a source where the document may be obtained.

One embodiment of the Life Library system can check whether the subscriber is authorized to obtain the electronic copy. For example, if a reader scans text or an identifier from a copy of an article in the New York Times (NYT) so that the article will be added to the reader's Life Library, the Life Library system will verify with the NYT whether the reader is subscribed to the online version of the NYT; if so, the reader gets a copy of the article stored in his Life Library account; if not, information identifying the document and how to order it is stored in his Life Library account.

In some embodiments, the system maintains a subscriber profile for each subscriber that includes access privilege information. Document access information can be compiled in several ways, two of which are: 1) the subscriber supplies the document access information to the Life Library system, along with his account names and passwords, etc., or 2) the Life Library service provider queries the publisher with the subscriber's information and the publisher responds by providing access to an electronic copy if the Life Library subscriber is authorized to access the material. If the Life Library subscriber is not authorized to have an electronic copy of the document, the publisher provides a price to the Life Library service provider, which then provides the customer with the option to purchase the electronic document. If so, the Life Library service provider either pays the publisher directly and bills the Life Library customer later or the Life Library service provider immediately bills the customer's credit card for the purchase. The Life Library service provider would get a percentage of the purchase price or a small fixed fee for facilitating the transaction.

The system can archive the document in the subscriber's personal library and/or any other library to which the subscriber has archival privileges. For example, as a user scans text from a printed document, the Life Library system can identify the rendered document and its electronic counterpart. After the source document is identified, the Life Library system might record information about the source document in the user's personal library and in a group library to which the subscriber has archival privileges. Group libraries are collaborative archives such as a document repository for a group working together on a project, a group of academic researchers, a group web log, etc.

The life library can be organized in many ways: chronologically, by topic, by level of the subscriber's interest, by type of publication (newspaper, book, magazine, technical paper, etc.), where read, when read, by ISBN or by Dewey decimal, etc. In one alternative, the system can learn classifications based on how other subscribers have classified the same document. The system can suggest classifications to the user or automatically classify the document for the user.

In various embodiments, annotations may be inserted directly into the document or may be maintained in a separate file. For example, when a subscriber scans text from a newspaper article, the article is archived in his Life Library with the scanned text highlighted. Alternatively, the article is archived in his Life Library along with an associated annotation file (thus leaving the archived document unmodified). Embodiments of the system can keep a copy of the source document in each subscriber's library, a copy in a master library that many subscribers can access, or link to a copy held by the publisher.

In some embodiments, the Life Library stores only the user's modifications to the document (e.g., highlights, etc.) and a link to an online version of the document (stored elsewhere). The system or the subscriber merges the changes with the document when the subscriber subsequently retrieves the document.

If the annotations are kept in a separate file, the source document and the annotation file are provided to the subscriber and the subscriber combines them to create a modified document. Alternatively, the system combines the two files prior to presenting them to the subscriber. In another alternative, the annotation file is an overlay to the document file and can be overlaid on the document by software in the subscriber's computer.

Subscribers to the Life Library service pay a monthly fee to have the system maintain the subscriber's archive. Alternatively, the subscriber pays a small amount (e.g., a micro-payment) for each document stored in the archive. Alternatively, the subscriber pays to access the subscriber's archive on a per-access fee. Alternatively, subscribers can compile libraries and allow others to access the materials/annotations on a revenue share model with the Life Library service provider and copyright holders. Alternatively, the Life Library service provider receives a payment from the publisher when the Life Library subscriber orders a document (a revenue share model with the publisher, where the Life Library service provider gets a share of the publisher's revenue).

In some embodiments, the Life Library service provider acts as an intermediary between the subscriber and the copyright holder (or copyright holder's agent, such as the Copyright Clearance Center, a.k.a. CCC) to facilitate billing and payment for copyrighted materials. The Life Library service provider uses the subscriber's billing information and other user account information to provide this intermediation service. Essentially, the Life Library service provider leverages the pre-existing relationship with the subscriber to enable purchase of copyrighted materials on behalf of the subscriber.

In some embodiments, the Life Library system can store excerpts from documents. For example, when a subscriber scans text from a paper document, the regions around the scanned text are excerpted and placed in the Life Library, rather than the entire document being archived in the life library. This is especially advantageous when the document is long because preserving the circumstances of the original scan prevents the subscriber from re-reading the document to find the interesting portions. Of course, a hyperlink to the entire electronic counterpart of the paper document can be included with the excerpt materials.

In some embodiments, the system also stores information about the document in the Life Library, such as author, publication title, publication date, publisher, copyright holder (or copyright holder's licensing agent), ISBN, links to public annotations of the document, readrank, etc. Some of this additional information about the document is a form of paper document metadata. Third parties may create public annotation files for access by persons other than themselves, such the general public. Linking to a third party's commentary on a document is advantageous because reading annotation files of other users enhances the subscriber's understanding of the document.

In some embodiments, the system archives materials by class. This feature allows a Life Library subscriber to quickly store electronic counterparts to an entire class of paper documents without access to each paper document. For example, when the subscriber scans some text from a copy of National Geographic magazine, the system provides the subscriber with the option to archive all back issues of the National Geographic. If the subscriber elects to archive all back issues, the Life Library service provider would then verify with the National Geographic Society whether the subscriber is authorized to do so. If not, the Life Library service provider can mediate the purchase of the right to archive the National Geographic magazine collection.

16.2. Life Saver

A variation on, or enhancement of, the Life Library concept is the “Life Saver,” where the system uses the text captured by a user to deduce more about their other activities. The scanning of a menu from a particular restaurant, a program from a particular theater performance, a timetable at a particular railway station, or an article from a local newspaper allows the system to make deductions about the user's location and social activities, and could construct an automatic diary for them, for example as a website. The user would be able to edit and modify the diary, add additional materials such as photographs and, of course, look again at the items scanned.

### 17. Academic Applications

Portable scanners supported by the described system have many compelling uses in the academic setting. They can enhance student/teacher interaction and augment the learning experience. Among other uses, students can annotate study materials to suit their unique needs; teachers can monitor classroom performance; and teachers can automatically verify source materials cited in student assignments.

17.1. Children's Books

A child's interaction with a paper document, such as a book, is monitored by a literacy acquisition system that employs a specific set of embodiments of this system. The child uses a portable scanner that communicates with other elements of the literacy acquisition system. In addition to the portable scanner, the literacy acquisition system includes a computer having a display and speakers, and a database accessible by the computer. The scanner is coupled with the computer (hardwired, short range RF, etc.). When the child sees an unknown word in the book, the child scans it with the scanner. In one embodiment, the literacy acquisition system compares the scanned text with the resources in its database to identify the word. The database includes a dictionary, thesaurus, and/or multimedia files (e.g., sound, graphics, etc.). After the word has been identified, the system uses the computer speakers to pronounce the word and its definition to the child. In another embodiment, the word and its definition are displayed by the literacy acquisition system on the computer's monitor. Multimedia files about the scanned word can also be played through the computer's monitor and speakers. For example, if a child reading “Goldilocks and the Three Bears” scanned the word “bear,” the system might pronounce the word “bear” and play a short video about bears on the computer's monitor. In this way, the child learns to pronounce the written word and is visually taught what the word means via the multimedia presentation.

The literacy acquisition system provides immediate auditory and/or visual information to enhance the learning process. The child uses this supplementary information to quickly acquire a deeper understanding of the written material. The system can be used to teach beginning readers to read, to help children acquire a larger vocabulary, etc. This system provides the child with information about words with which the child is unfamiliar or about which the child wants more information.

17.2. Literacy Acquisition

In some embodiments, the system compiles personal dictionaries. If the reader sees a word that is new, interesting, or particularly useful or troublesome, the reader saves it (along with its definition) to a computer file. This computer file becomes the reader's personalized dictionary. This dictionary is generally smaller in size than a general dictionary so can be downloaded to a mobile station or associated device and thus be available even when the system isn't immediately accessible. In some embodiments, the personal dictionary entries include audio files to assist with proper word pronunciation and information identifying the paper document from which the word was scanned.

In some embodiments, the system creates customized spelling and vocabulary tests for students. For example, as a student reads an assignment, the student may scan unfamiliar words with the portable scanner. The system stores a list of all the words that the student has scanned. Later, the system administers a customized spelling/vocabulary test to the student on an associated monitor (or prints such a test on an associated printer).

17.3. Music Teaching

The arrangement of notes on a musical staff is similar to the arrangement of letters in a line of text. The same scanning device discussed for capturing text in this system can be used to capture music notation, and an analogous process of constructing a search against databases of known musical pieces would allow the piece from which the capture occurred to be identified which can then be retrieved, played, or be the basis for some further action.

17.4. Detecting Plagiarism

Teachers can use the system to detect plagiarism or to verify sources by scanning text from student papers and submitting the scanned text to the system. For example, a teacher who wishes to verify that a quote in a student paper came from the source that the student cited can scan a portion of the quote and compare the title of the document identified by the system with the title of the document cited by the student. Likewise, the system can use scans of text from assignments submitted as the student's original work to reveal if the text was instead copied.

17.5. Enhanced Textbook

In some embodiments, capturing text from an academic textbook links students or staff to more detailed explanations, further exercises, student and staff discussions about the material, related example past exam questions, further reading on the subject, recordings of the lectures on the subject, and so forth. (See also Section 7.1.)

17.6. Language Learning

In some embodiments, the system is used to teach foreign languages. Scanning a Spanish word, for example, might cause the word to be read aloud in Spanish along with its definition in English.

The system provides immediate auditory and/or visual information to enhance the new language acquisition process. The reader uses this supplementary information to acquire quickly a deeper understanding of the material. The system can be used to teach beginning students to read foreign languages, to help students acquire a larger vocabulary, etc. The system provides information about foreign words with which the reader is unfamiliar or for which the reader wants more information.

Reader interaction with a paper, document, such as a newspaper or book, is monitored by a language skills system. The reader has a portable scanner that communicates with the language skills system. In some embodiments, the language skills system includes a computer having a display and speakers, and a database accessible by the computer. The scanner communicates with the computer (hardwired, short range RF, etc.). When the reader sees an unknown word in an article, the reader scans it with the scanner. The database includes a foreign language dictionary, thesaurus, and/or multimedia files (sound, graphics, etc.). In one embodiment, the system compares the scanned text with the resources in its database to identify the scanned word. After the word has been identified, the system uses the computer speakers to pronounce the word and its definition to the reader. In some embodiments, the word and its definition are both displayed on the computer's monitor. Multimedia files about grammar tips related to the scanned word can also be played through the computer's monitor and speakers. For example, if the words “to speak” are scanned, the system might pronounce the word “hablar,” play a short audio clip that demonstrates the proper Spanish pronunciation, and display a complete list of the various conjugations of “hablar.” In this way, the student learns to pronounce the written word, is visually taught the spelling of the word via the multimedia presentation, and learns how to conjugate the verb. The system can also present grammar tips about the proper usage of “hablar” along with common phrases.

In some embodiments, the user scans a word or short phrase from a rendered document in a language other than the user's native language (or some other language that the user knows reasonably well). In some embodiments, the system maintains a prioritized list of the user's “preferred” languages. The system identifies the electronic counterpart of the rendered document, and determines the location of the scan within the document. The system also identifies a second electronic counterpart of the document that has been translated into one of the user's preferred languages, and determines the location in the translated document corresponding to the location of the scan in the original document. When the corresponding location is not known precisely, the system identifies a small region (e.g., a paragraph) that includes the corresponding location of the scanned location. The corresponding translated location is then presented to the user. This provides the user with a precise translation of the particular usage at the scanned location, including any slang or other idiomatic usage that is often difficult to accurately translate on a word-by-word basis.

17.7. Gathering Research Materials

A user researching a particular topic may encounter all sorts of material, both in print and on screen, which they might wish to record as relevant to the topic in some personal archive. The system would enable this process to be automatic as a result of scanning a short phrase in any piece of material, and could also create a bibliography suitable for insertion into a publication on the subject.

### 18. Commercial Applications

Obviously, commercial activities could be made out of almost any process discussed in this document, but here we concentrate on a few obvious revenue streams.

18.1. Fee-Based Searching and Indexing

Conventional Internet search engines typically provide free search of electronic documents, and also make no charge to the content providers for including their content in the index. In some embodiments, the system provides for charges to users and/or payments to search engines and/or content providers in connection with the operation and use of the system.

In some embodiments, subscribers to the system's services pay a fee for searches originating from scans of paper documents. For example, a stockbroker may be reading a Wall Street Journal article about a new product offered by Company X. By scanning the Company X name from the paper document and agreeing to pay the necessary fees, the stockbroker uses the system to search special or proprietary databases to obtain premium information about the company, such as analyst's reports. The system can also make arrangements to have priority indexing of the documents most likely to be read in paper form, for example by making sure all of the newspapers published on a particular day are indexed and available by the time they hit the streets.

Content providers may pay a fee to be associated with certain terms in search queries submitted from paper documents. For example, in one embodiment, the system chooses a most preferred content provider based on additional context about the provider (the context being, in this case, that the content provider has paid a fee to be moved up the results list). In essence, the search provider is adjusting paper document search results based on pre-existing financial arrangements with a content provider. See also the description of keywords and key phrases in Section 5.2.

Where access to particular content is to be restricted to certain groups of people (such as clients or employees), such content may be protected by a firewall and thus not generally indexable by third parties. The content provider may nonetheless wish to provide an index to the protected content. In such a case, the content provider can pay a service provider to provide the content provider's index to system subscribers. For example, a law firm may index all of a client's documents. The documents are stored behind the law firm's firewall. However, the law firm wants its employees and the client to have access to the documents through the portable scanner so it provides the index (or a pointer to the index) to the service provider, which in turn searches the law firm's index when employees or clients of the law firm submit paper-scanned search terms via their portable scanners. The law firm can provide a list of employees and/or clients to the service provider's system to enable this function or the system can verify access rights by querying the law firm prior to searching the law firm's index. Note that in the preceding example, the index provided by the law firm is only of that client's documents, not an index of all documents at the law firm. Thus, the service provider can only grant the law firm's clients access to the documents that the law firm indexed for the client.

There are at least two separate revenue streams that can result from searches originating from paper documents: one revenue stream from the search function, and another from the content delivery function. The search function revenue can be generated from paid subscriptions from the scanner users, but can also be generated on a per-search charge. The content delivery revenue can be shared with the content provider or copyright holder (the service provider can take a percentage of the sale or a fixed fee, such as a micropayment, for each delivery), but also can be generated by a “referral” model in which the system gets a fee or percentage for every item that the subscriber orders from the online catalog and that the system has delivered or contributed to, regardless of whether the service provider intermediates the transaction. In some embodiments, the system service provider receives revenue for all purchases that the subscriber made from the content provider, either for some predetermined period of time or at any subsequent time when a purchase of an identified product is made.

18.2. Catalogs

Consumers may use the portable scanner to make purchases from paper catalogs. The subscriber scans information from the catalog that identifies the catalog. This information is text from the catalog, a bar code, or another identifier of the catalog. The subscriber scans information identifying the products that s/he wishes to purchase. The catalog mailing label may contain a customer identification number that identifies the customer to the catalog vendor. If so, the subscriber can also scan this customer identification number. The system acts as an intermediary between the subscriber and the vendor to facilitate the catalog purchase by providing the customer's selection and customer identification number to the vendor.

18.3. Coupons

A consumer scans paper coupons and saves an electronic copy of the coupon in the scanner, or in a remote device such as a computer, for later retrieval and use. An advantage of electronic storage is that the consumer is freed from the burden of carrying paper coupons. A further advantage is that the electronic coupons may be retrieved from any location. In some embodiments, the system can track coupon expiration dates, alert the consumer about coupons that will expire soon, and/or delete expired coupons from storage. An advantage for the issuer of the coupons is the possibility of receiving more feedback about who is using the coupons and when and where they are captured and used.

### 19. General Applications

19.1. Forms

The system may be used to auto-populate an electronic document that corresponds to a paper form. A user scans in some text or a barcode that uniquely identifies the paper form. The scanner communicates the identity of the form and information identifying the user to a nearby computer. The nearby computer has an Internet connection. The nearby computer can access a first database of forms and a second database having information about the user of the scanner (such as a service provider's subscriber information database). The nearby computer accesses an electronic version of the paper form from the first database and auto-populates the fields of the form from the user's information obtained from the second database. The nearby computer then emails the completed form to the intended recipient. Alternatively, the computer could print the completed form on a nearby printer.

Rather than access an external database, in some embodiments, the system has a portable scanner that contains the user's information, such as in an identity module, SIM, or security card. The scanner provides information identifying the form to the nearby PC. The nearby PC accesses the electronic form and queries the scanner for any necessary information to fill out the form.

19.2. Business Cards

The system can be used to automatically populate electronic address books or other contact lists from paper documents. For example, upon receiving a new acquaintance's business card, a user can capture an image of the card with his/her cellular phone. The system will locate an electronic copy of the card, which can be used to update the cellular phone's onboard address book with the new acquaintance's contact information. The electronic copy may contain more information about the new acquaintance than can be squeezed onto a business card. Further, the onboard address book may also store a link to the electronic copy such that any changes to the electronic copy will be automatically updated in the cell phone's address book. In this example, the business card optionally includes a symbol or text that indicates the existence of an electronic copy. If no electronic copy exists, the cellular phone can use OCR and knowledge of standard business card formats to fill out an entry in the address book for the new acquaintance. Symbols may also aid in the process of extracting information directly from the image. For example, a phone icon next to the phone number on the business card can be recognized to determine the location of the phone number.

19.3. Proofreading/Editing

The system can enhance the proofreading and editing process. One way the system can enhance the editing process is by linking the editor's interactions with a paper document to its electronic counterpart. As an editor reads a paper document and scans various parts of the document, the system will make the appropriate annotations or edits to an electronic counterpart of the paper document. For example, if the editor scans a portion of text and makes the “new paragraph” control gesture with the scanner, a computer in communication with the scanner would insert a “new paragraph” break at the location of the scanned text in the electronic copy of the document.

19.4. Voice Annotation

A user can make voice annotations to a document by scanning a portion of text from the document and then making a voice recording that is associated with the scanned text. In some embodiments, the scanner has a microphone to record the user's verbal annotations. After the verbal annotations are recorded, the system identifies the document from which the text was scanned, locates the scanned text within the document, and attaches the voice annotation at that point. In some embodiments, the system converts the speech to text and attaches the annotation as a textual comment.

In some embodiments, the system keeps annotations separate from the document, with only a reference to the annotation kept with the document. The annotations then become an annotation markup layer to the document for a specific subscriber or group of users.

In some embodiments, for each capture and associated annotation, the system identifies the document, opens it using a software package, scrolls to the location of the scan and plays the voice annotation. The user can then interact with a document while referring to voice annotations, suggested changes or other comments recorded either by themselves or by somebody else.

19.5. Help in Text

The described system can be used to enhance paper documents with electronic help menus. In some embodiments, a markup layer associated with a paper document contains help menu information for the document. For example, when a user scans text from a certain portion of the document, the system checks the markup associated with the document and presents a help menu to the user. The help menu is presented on a display on the scanner or on an associated nearby display.

19.6. Use with Displays

In some situations, it is advantageous to be able to scan information from a television, computer monitor, or other similar display. In some embodiments, the portable scanner is used to scan information from computer monitors and televisions. In some embodiments, the portable optical scanner has an illumination sensor that is optimized to work with traditional cathode ray tube (CRT) display techniques such as rasterizing, screen blanking, etc.

A voice capture device which operates by capturing audio of the user reading text from a document will typically work regardless of whether that document is on paper, on a display, or on some other medium.

19.6.1. Public Kiosks and Dynamic Session IDs

One use of the direct scanning of displays is the association of devices as described in Section 15.6. For example, in some embodiments, a public kiosk displays a dynamic session ID on its monitor. The kiosk is connected to a communication network such as the Internet or a corporate intranet. The session ID changes periodically but at least every time that the kiosk is used so that a new session ID is displayed to every user. To use the kiosk, the subscriber scans in the session ID displayed on the kiosk; by scanning the session ID, the user tells the system that he wishes to temporarily associate the kiosk with his scanner for the delivery of content resulting from scans of printed documents or from the kiosk screen itself. The scanner may communicate the Session ID and other information authenticating the scanner (such as a serial number, account number, or other identifying information) directly to the system. For example, the scanner can communicate directly (where “directly” means without passing the message through the kiosk) with the system by sending the session initiation message through the user's cell phone (which is paired with the user's scanner via Bluetooth™). Alternatively, the scanner can establish a wireless link with the kiosk and use the kiosk's communication link by transferring the session initiation information to the kiosk (perhaps via short range RF such as Bluetooth™, etc.); in response, the kiosk sends the session initiation information to the system via its Internet connection.

The system can prevent others from using a device that is already associated with a scanner during the period (or session) in which the device is associated with the scanner. This feature is useful to prevent others from using a public kiosk before another person's session has ended. As an example of this concept related to use of a computer at an Internet café, the user scans a barcode on a monitor of a PC which s/he desires to use; in response, the system sends a session ID to the monitor that it displays; the user initiates the session by scanning the session ID from the monitor (or entering it via a keypad or touch screen or microphone on the portable scanner); and the system associates in its databases the session ID with the serial number (or other identifier that uniquely identifies the user's scanner) of his/her scanner so another scanner cannot scan the session ID and use the monitor during his/her session. The scanner is in communication (through wireless link such as Bluetooth™, a hardwired link such as a docking station, etc.) with a PC associated with the monitor or is in direct (i.e., w/o going through the PC) communication with the system via another means such as a cellular phone, etc.

### 20. Further Details

A software and/or hardware system for triggering actions, such as advertising, in response to optically or acoustically capturing keywords from a rendered document or in response to identifying a document based on the captured keywords is described (“the system”). In some cases, the system presents advertising, displays annotations, or modifies or applies actions to keywords. Keywords as used here mean one or more words, icons, symbols, or images. While the terms “word” and “words” are often used in this application, icons, symbols, or images can be employed in some embodiments. Keywords as used here also refer to phrases comprised of one or more adjacent symbols. Keywords as used here include words relating to topics or subjects identified in response to a capture and discussed with a rendered document or a portion of a rendered document. Keywords may optionally include classes of objects recognizable by regular expression algorithms or image processing. Such classes of objects may include email addresses, mailing addresses, phone numbers, URLs, hyperlinks and other pointers to content, quotations, trademarks, logos, proper names, times of day, dates, and so on.

Keywords can be considered to be “overloaded”—that is, they have some associated meaning or action beyond their common (e.g., visual) meaning to the user as text or symbols. In some embodiments the association between keywords and meanings or actions is established by means of markup processes or data. In some embodiments the association between keywords or documents and meanings or actions is known to the system at the time the capture or identification is made. In some embodiments the association between keywords or documents and meanings or actions is established after a capture or identification has been made.

In some embodiments, the system identifies a document and uses the content of the document to trigger and select advertising to be presented to a user. In some cases, the system may analyze the document and associate the content of the document with one or more keywords. In some cases, the system chooses the advertising (the actions) based on the content of the entire document. In some cases, the system chooses the advertising based on a portion of the document that contains or is near the captured text. In some cases, the system chooses the advertising based on content of the document not used when identifying the document.

In some embodiments of the described system interacting with keywords in a rendered document does not require that a capture from the document specifically contain the keyword, or that a keyword associated with an identified document is a specific keyword. A capture can trigger actions associated with a keyword if the capture includes the keyword entirely, overlaps (contains part of) the keyword, is near the keyword (for example in the same paragraph or on the same page), or contains information (e.g., words, icons, tokens, symbols, images) similar to or related to the information contained in the keyword. Actions associated with a keyword can be invoked when a user captures a synonym of a word included in the keyword or if a document is associated with a synonym of a keyword. For example, if a keyword includes the word “cat,” and a user captures text including the word “feline,” the actions associated with “cat” can optionally be invoked. Alternatively, if a user captures anywhere on a page containing the word “cat” or the word “feline,” the actions associated with a keyword containing “cat” can optionally be invoked.

Similarly, if the system identifies a document, analyzes the content of the document, and determines keywords of the document including “feline,” the system may invoke actions (such as advertising messages) associated with the keyword “cat.”

In some embodiments the specific instructions and/or data specifying how captures relate to keywords, and what specific actions result from these captures, are stored as markup within the system.

In some embodiments the actions taken in association with a keyword are in part determined by how a capture was made. Captures near a keyword, overlapping a keyword, containing a keyword plus other material, and containing exactly the keyword—may each result in a different set of actions. Capturing the keyword “IBM” with no surrounding material can send the user's browser to IBM's website. Capturing IBM within a surrounding sentence can cause an advertisement for IBM to be displayed while the system processes and responds to the other captured material. In some embodiments keywords can be nested or they can overlap. The system could have actions associated with “IBM data,” “data server,” and “data”—and the actions associated with some or all of these keywords can be invoked when a user captures the phrase “IBM data server.”

An example of a keyword is the term “IBM”—and its appearance in a document could be associated with directing the reader's web browser to the IBM website. Other examples of keywords are the phrase “Sony Headset,” the product model number “DR-EX151,” and the book title, “Learning the Bash Shell.” An action associated with these keywords could be consulting a list of objects for sale at Amazon.com, matching one or more of the terms included to one or more objects for sale, and providing the user an opportunity to purchase these objects through Amazon.

In some embodiments the system identifies an electronic counterpart based on the capture of text and then performs actions (such as presenting advertising) based on the identification. For example, a capture of the text “DR-EX151 Specification Sheet” may identify a product specification document for that product model. In this example, the system retrieves the electronic version of the document and presents the document along with related advertising, to the user. The system may present advertising separately from the document (such as by sending an email message providing information related to similar products) or may present advertising within the electronic counterpart (such as embedded within the electronic counterpart).

Some embodiments of the disclosed system perform contextual actions in response to a data capture from a rendered document. Contextual action refers to the practice of initiating or taking an action, such as presenting a menu of user choices or presenting an advertising message, in the context of, or in response to, other information, such as the information in or near text captured from a specific location in a rendered document.

One type of contextual action is contextual advertising, which refers to presenting to a user an advertisement that is chosen based on the captured information and some context. A subset of contextual advertising—referred to herein as “dynamic contextual advertising”—involves dynamically selecting one of a number of available advertising messages to present in connection with related content.

Contextual advertising can be particularly effective because it delivers advertising messages to people who have an interest in the advertiser's product, at a time when those people are exploring those interests. Dynamic contextual advertising can be especially effective, because it retains the flexibility to present, at the time the content is being read, advertising messages that were not available at the time the content was created or published.

Various embodiments provide contextual actions for rendered documents. Contextual actions can provide actions and responses appropriate to a specific context, i.e., the actions can vary as the context varies. An example of contextual action in the system is a menu that appears on a display associated with a portable capture device 302 when the user captures text from a document. This menu can vary dynamically depending upon the text captured, the location from which the text was captured, etc.

Actions may optionally include a verb, such as “display”, and an object, such as “advertising message”. Additional verbs supported by the system in some embodiments include send or receive (e.g., an email message, an instant message, a copy of the document containing a capture or keyword), print (e.g., a brochure), “browse” (e.g., a web page), and “launch” (e.g., a computer application).

In some embodiments, triggered actions include presenting advertising messages on behalf of an advertiser or sponsor. In some embodiments, actions may be associated with all documents, a group of documents, a single document, or a portion of a document.

In some embodiments the triggered actions include presenting a menu of possible user-initiated actions or choices. In some embodiments the menu of choices is presented on an associated display device, for example on a cell phone display, personal computer display 421, or on a display integrated into the capture device 302. In some embodiments the menu of choices is also available, in whole or in part, when a user reviews a capture at a later time from their user account history or Life Library. In some embodiments the menu of actions is determined by markup data and/or markup processes associated with keywords, with a rendered document, or with a larger group or class of documents.

In some embodiments a menu of actions can optionally have zero, one, or more default actions. In some embodiments the default actions are initiated if the user does not interact with the menu, for example if the user proceeds to a subsequent capture. In some embodiments default actions are determined by markup data and/or markup processes associated with keywords, with a rendered document, or with a larger group or class of documents.

In some embodiments a menu of actions is presented such that items more likely to be selected by a user appear closer to some known location or reference—such as the top of the menu list. The probability of selection can be determined, in some embodiments, by tracking those items selected in the past by this user and by other users of the system. In some embodiments a menu of actions can include a subset of standard actions employed by the system. Standard actions, along with menu items specific to a particular capture, can appear in different combinations in different contexts. Some standard actions can appear in menus when no keywords are recognized and/or the context of a capture is not known. Some standard actions can appear in menus generated when a capture device 302 is disconnected from other components of the system.

Standard actions can include, among others:
speak this word/phrase
translate this to another language (and speak, display, or print)
help function
tell be more about this
show me a picture of this
bookmark this
underline this
excerpt (copy) this
add this to my calendar
add this to my contacts list
purchase this
email me this
save this in my archive
add a voice annotation here
play any associated voice annotation
show me associated content
show me related content
find this subject in the index or table of contents
note this topic is of interest
take me to this website
please send me information about this
send me this form to be completed
complete this form for me
submit this form with my information
search for this on the web
print this document
bring this document up on my computer screen or associated display
show all occurrences of this word/phrase in the document on my display
search for and show me this word/phrase when used in other contexts
choose this item (e.g., multiple choice)
excerpt this to a linear file of notes.
show me what others have written or spoken about this document/page/line/phrase
dial this phone number
tell me when this document becomes available online
send me this information about this if/when it becomes available
send an email to this person/company/address
tell me if I am a winner of this context/prize/offer
register me for this event, prize/drawing/lottery
record that I have read this passage
record that I agree with this statement/contract/clause
tell me when new information on this topic becomes available
watch this topic for me
tell me when/if this document changes

In some embodiments a menu of actions is optionally presented for nearby content, as well as content specifically captured by the user. In some embodiments, the system uses choices selected in earlier captures to determine which items to present in subsequent interactions with a document and their order of presentation. Frequently selected menu items can appear at the top of a menu presentation. In some embodiments, menu items can optionally invoke additional sub-menus of related choices.

The following text makes reference to labels in the attached figures, which are described in further detail later. Where multiple actions are available for a single keyword, some embodiments of the system use a variety of behavior rules to select a subset of these actions to perform, e.g., the rules can specify a hierarchy for determining which actions take precedence over the others. For example, the rules can specify that the system selects actions in increasing order of the size of the body of content to which they apply. As an example, where a keyword is captured in a particular chapter of a particular textbook published by a particular publisher, the system may choose a first action associated with the chapter of the textbook, ahead of a second action associated with the particular textbook, ahead of a third action associated with all of the textbooks published by the publisher. The system may also select actions based upon a geographical region or location in which the capture device 302 resides at the time of capturing, a time or date range in which the keyword is captured, various other kinds of context information relating to the capture, various kinds of profile information associated with the user, and/or an amount of money or other compensation a sponsor has agreed to provide to sponsor the action.

In some embodiments, the system utilizes a handheld optical and/or acoustical capture device, such as a handheld optical and/or acoustical capture device 302 wirelessly connected to a computer 212 system, or the acoustic and/or imaging components in a cell phone, or similar components integrated into a PDA (“Personal Digital Assistant”).

In some embodiments, the system includes an optical and/or acoustical capture device 302 used to capture from a rendered document and communicate with a keyword server 440 storing keyword registration information. In some embodiments keyword registration information is stored in a database of registered keywords. In some embodiments this information is stored in a database of markup data. In some embodiments this information is stored in a markup document associated with the rendered document.

In some embodiments, the capture device 302 is a portable or handheld scanner, such as “pen” scanner that has a scanning aperture suitable for scanning text line by line rather than a “flatbed” scanner that scans an entire page at a time. Flatbed scanners are generally not portable and are considerably more bulky than pen scanners. The pen scanner may have an indicator to indicate to the user when a keyword has been scanned in. For example, the scanner may illuminate an LED 332 to let the user know that a scanned word has been recognized as a keyword. The user might press a button on the scanner (or perform a gesture with the scanner) to initiate a process whereby an associated action is taken, for example where information related to the keyword is sent to the user.

The capture device 302 may have an associated display device. Examples of associated display devices include a personal computer display 421 and the display on a cell phone (216). Menus of actions and other interactive and informational data can be displayed on the associated display device. When the capture device 302 is integrated within, or uses the components of, a cell phone, the cell phone keypad can be used to select choices from a menu presented on the cell phone display, and to control and interact with the described system and functions.

In cases where the capture device 302 is not in communication with the keyword server 440 during the capture, it may be desirable to have a local cache of popular keywords, associated actions, markup data, etc., in the capture device 302 so that it may initiate an action locally and independently. Examples of local, independent actions are indicating acquisition of a keyword, presenting a menu of choices to the user, and receiving the user's response to the menu. Additional information about the keywords, markup, etc., can be determined and acted upon when the capture device 302 is next in communication with the keyword server 440.

In various embodiments, information associating words or phrases with actions (e.g., markup information) can be stored in the capture device 302, in the computer 212 system connected to the capture device 302, and/or in other computer systems with which the described system is able to communicate. A similarly broad range of devices can be involved in performing an action in response to the capturing of a keyword.

In combination with the capture device 302, the keyword server 440 may be able to automatically identify the document from which text has been captured and locate an electronic version of the rendered document. For example, the text content in a capture can be treated as a document signature. Such a signature typically requires 10 or fewer words to uniquely identify a document—and in most cases 3 to 8 words suffice. When additional context information is known, the number of words required to identify a document can be further reduced. In cases where multiple documents match a signature, the most probable matches (for example, those containing the most captures by this or other users) can be presented to the user specially—for example as the first items in a list or menu. When multiple documents match a signature, previous or subsequent captures can be used to disambiguate the candidates and correctly identify the rendered document in the possession of the user—and, optionally, correctly locate its digital counterpart.

For users who are subscribers to a document retrieval service provided in some embodiments of the system, the keyword server 440 can deliver content related to the captured text, or related to the subject matter of the context (e.g., paragraph, page, magazine article) within which the capture was performed. The response to a capture can therefore be dynamic depending on the context of the capture, and further depending on the user's habits and preferences that are known to the keyword server 440.

The system allows the efficient delivery of electronic content that is related to text or other information (trademarks, symbols, tokens, images, etc.) captured from a rendered publication. It enables a new way to advertise and sell products and services based on rendered publications such as newspapers and magazines. In a traditional newspaper, the news stories do not themselves contain advertisements. This system allows the text of any article to potentially include advertisements through the use of keywords associated with products, services, companies, etc.

One of the ways the system delivers enhanced content for a rendered publication is by the use of keywords in the rendered text. When a predetermined keyword is captured by a user, the captured keyword triggers the delivery of content associated with the keyword. In some embodiments the keyword is recognized by the keyword server 440, causing content to be extracted from a database and sent to a device (optionally an output device such as a display or speaker) associated with the user. The associated device may be a nearby display or printer. The system may associate each rendered keyword (or combinations of keywords) with an advertisement for a product or service. As an example, if the user captured the words “new car” from a rendered document (such as an automotive magazine) the system can be triggered to send an advertisement for a local Ford dealership to a display near the location of the portable capture device 302.

Similarly, if the user uses a capture device 302 to capture a trademark from a rendered document, the system could send information about the trademark holder's product lines to the user. If the user captured a trademark and a product name, the information sent to the user would be further narrowed to provide information specific to that product. For example, if the user captured the word “Sanford” then the system might recognize this word as a trademark for the Sanford office supply company and provide the user with an electronic copy of the Sanford office supply catalog (or instead the system can provide a link to the Sanford webpage having an online copy of the catalog). As another example, if the user captured “Sanford uniball” the system might be programmed to relate those keywords to uniball inkpens from the Sanford Company. If so, then the system would deliver information about Sanford's line of uniball inkpens to the user. The system might deliver this information in the form of an email (having information about Sanford uniball inkpens or hotlinks to webpages having information about the pens) to the user's email account, as a push multimedia message to a display near the user, as a brochure sent to the nearby printer, etc.

This method of associating keywords that are captured from a rendered publication with the delivery of additional content to the user is extremely useful for efficiently providing advertisements and other materials to a targeted. By identifying keywords captured by a user, the system can supply timely and useful information to the user. A printer manufacturer may pay to have advertisements for the manufacturer's printers sent to a user when the user captures the keyword “computer printer.” Further, the rights to a particular keyword may be sold or leased with respect to one or more types of content (e.g., within a particular magazine; within articles associated with particular topics or near other keywords that apply to topics). The system could exclusively associate the keyword “computer printer” with a single printer manufacturer, or could associate those keywords with a number of printer manufacturers (or the word keyword “printer” in the context of an article whose topic is associated with the keyword “computer”). In the case where several printer manufacturers are associated with the keywords, the system could deliver advertisements, coupons, etc., from each manufacturer (or each manufacturer could acquire keyword rights in separate contexts). If the user clicks through to take advantage of any of the offers or to visit the manufacturer's website, the manufacturer could be charged a small payment (often referred to as a micropayment) by the operator of the system. In some embodiments, the capture device 302 or an associated computer 212 can store coupons for later use.

The system can also use context about the circumstances in which the user captured the text to further categorize keywords and captures. Keywords can be separately processed based on system knowledge/recognition of context about the capture. Examples of context are knowledge of the user's capturing history and interests, the capturing history of other users in the same document, the user's location, the document from which the text is captured, other text or information near the capture (for example in the same paragraph or on the same page as the capture), the time of day at which the capture is performed, etc. For example, the system could react differently to the same keywords depending upon the location of the user, or depending on the surrounding text in which the keyword appears. The service provider could sell or lease the same keyword in different markets by knowing the location of the capture device 302. An example is selling the same keyword to advertiser #1 for users in New York and to advertiser #2 for users in Seattle. The service provider could sell the “hammer” keyword to local hardware stores in different cities.

There are many ways to “lease” or sell keywords in rendered documents. The system could partition keyword leases based on time of capture, location of capture, document from which captured, in combination with other keywords (e.g., “Hammer” when it appears near the terms “Nail” or “Construction”). As one example of leasing a generic product description, the keywords “current book titles” and “Bestsellers” could be sold to a book seller. When a user captures the words “current book titles” or “bestsellers” from a rendered document (such as a newspaper), a list of the top-sellers could be sent along with a link to the bookseller webpage so that the user may purchase them. Alternatively, the link may be a “pass-through” link that is routed through the keyword server 440 (thereby allowing the system to count and audit click-through transactions) so that the bookseller can share revenue for click-through sales with the operator of the system and so that bookseller can pay for advertising on a performance basis (i.e., a small payment for each click-through generated by the service, regardless of whether a sale results). Similarly, advertisers in printed documents can pay based on captures in or near their advertisements.

Capturing keywords in combination could result in the delivery of different content. For example, capturing the keyword “hammer” near (for example, near in time or in number of intervening words) the keyword “nail” might result in the delivery of advertising content from a hardware store. Whereas the keyword “hammer” captured near the keyword “M. C.” would result in the delivery of content related to the entertainer M. C. Hammer.

Trademark holders can use the system to deliver advertisements and messages about their products and services when a user scans their trademark from a rendered document.

Keyword leases could be divided based upon geography. For example, the keyword “buy new car” could be leased nationally to a large automobile manufacturer, and/or could be leased regionally to local auto dealers. In the case where “buy new car” is associated with content from a local auto dealer, the act of capturing “buy new car” in New York City might result in the delivery of an advertisement from a New York City car dealer but the same phrase “buy new car” captured in Paris, France would result in delivery of an advertisement from a car dealer near Paris.

Keyword leases could be divided based upon the document from which the text is captured. For example, capturing the keyword “Assault Weapon Ban” from a firearms magazine might result in the delivery of pro-gun content from the National Rifle Association. Capturing the same keyword “Assault Weapon Ban” from a liberal magazine might result in the delivery of anti-gun content from The Brady Center for Handgun Violence.

Celebrity names could be used to assist the celebrity in delivering news and messages to fans. For example, the phrase “Madonna” could be associated with content related to the performer Madonna. When a user captures the word “Madonna” from a rendered document, the system could send Madonna concert information for venues near the location of the capture, links to purchase Madonna music at Amazon.com, the latest promotional release from Madonna's marketing company, a brief MP3 clip from her latest hit song, etc.

The cost of associating an advertisement with certain captured text may vary according to the time of capture. A term may cost more to lease at certain peak hours and less at off hours. For example, the term “diamond” might cost a diamond seller more to lease during the peak Christmas shopping season than during the time that yearly income taxes are due. As another example, a term such as “lawnmower” might cost less to lease between midnight and 5:00 AM than between 9:00 AM and 7:00 PM because the late-night audience (of users capturing text from a rendered document) is presumably smaller.

A particular advertisement or message could be associated with many keywords. For example, an advertisement for Harley Davidson motorcycles could be associated with the keywords “Harley,” “Harley Davidson,” “new motorcycle,” “classic motorcycle,” etc.

An advertisement or message could be associated with a relation between certain keywords, such as their relative positions. For example, if a user captures the word “motorcycle” from a rendered document, and if the keyword “buy” is within six words of the keyword “motorcycle,” then an advertisement or message related to motorcycles would be delivered to the user. When the document context is known, the fact that the keyword “buy” is within a certain distance of the captured word “motorcycle” is known to the system even when only the word “motorcycle” is captured. Thus the action associated with the keywords “buy motorcycle” can be triggered by capturing only the word “motorcycle” and applying context about the document to further interpret the captured word.

### Additional Functionality

The Nature of an Annotation

The facility described here allows both the creation of annotations, and interactions with annotations, as presented on dynamic displays. Some aspects of the described facility relate to one user creating annotations for other users to see or interact with. Other aspects of the described facility relate to the automatic creation—by the facility itself—of various kinds of associations with portions of electronic documents other than annotations. Additional aspects of the described facility relate to users interacting with associations—both those created by other users, and those created by the facility itself. It is helpful to note that there are both creation aspects and interaction aspects associated with associations. And in some cases interacting with one association can result in the creation of additional associations.

An association associated with target material and/or anchor material (both described below) can be any object capable of being pointed to, indicated, invoked, etc. Associations are often selected or invoked when the facility user clicks on a visual indication of the annotation with a mouse, or selects a menu item associated with the annotation via the user's keyboard or mouse. Associations as used here can include dynamically (programatically) generated or statically (manually) generated actions for any location or region on a dynamic display—either as selected by the user, or as indicated by the facility. The user-selected form of annotation is often invoked when the user clicks with a mouse at a location or highlights/selects a region on their display, then right-clicks with their mouse to bring up a menu of possible actions, and finally selects one of the actions presented to invoke it.

A few of the many possible examples of annotations include a link to additional text or graphic content, a pointer or link to another document, a textual comment, a link to a discussion group or forum, a link to a website, blog, or other web content (e.g., a hyperlink), or an audio or video clip that plays when the annotation is selected. Additional examples of associations include:
Initiate an internet chat session with a person mentioned in the displayed content
Initiate an email addressed to the author of the displayed content
Email a copy of the displayed or selected content to the user
Participate in a poll about the displayed or selected content
Acknowledge that the user has read and/or agrees with the displayed content
Initiate an internet search
Post displayed or selected content to the user's blog
Leave a new track-back annotation to the user's blog
Purchase the annotated or selected object at an e-commerce web-site
Enter the selected or highlighted date or time or event information in the user's calendar
Enter contact information in the user's contact database
Look up the displayed or selected word or phrase on Wikipedia or another dictionary or encyclopedia website
Speak/pronounce the selected content
Create a telephone connection between the indicated phone number and the user's phone
Bookmark the indicated content for the user
Add the indicated content to the user's archive of captured content
Underline or highlight the region selected by the user (i.e., create a new static visual annotation)
Add a new voice annotation; associated with the indicated location or selection
Copy the selected content to the user's clipboard
Direct the user's web browser to the indicated URL or website
Fill in this form with the user's personal information
Add a purchasable item to the user's wish-list of possible purchases
Purchase the indicated item or product
Confirm the purchase of the displayed or selected item or product
Register that the indicated product or service is of interest to the user
Send additional information about the displayed or selected product or service to the user
Display other user's comments or annotations about the indicated or selected content
Display contact information for the indicated/selected individual, organization, etc.
Translate the selected content to another language
Check the spelling of the displayed or selected word
Highlight all occurrences of this word/phrase when they subsequently appear on the user's display
Forward a copy of the document containing the displayed content via email
Purchase a copy of the document containing the displayed content
Notify the user when the displayed content or containing document is changed
Notify the user when the displayed content or containing document is further annotated
Present an advertisement to other users when the indicated content is displayed
Play audio or video appropriate for or synchronized to the indicated location
Show pictures related to the indicated content

It is important to note that, while some of these activities and functions are available in the many software applications and utilities available today, the described facility makes these activities and functions available for any displayed content, regardless of whether a particular application supports the activity, and without requiring explicit support or cooperation from either the application or the user's operating facility. For example, the described facility could in theory be installed directly in the user's display, and having no communication with the user's computer except to receive its display output.

Associations associated with content presented on a dynamic display may have a visual representation. For example, an annotation may be indicated by an icon, or by a region of text presented on the display with special attributes—underlining, highlighting, etc. —different from the attributes of neighboring text.

Blogging and Track-Backs

In some embodiments of the described facility, bloggers can manually create links or track-backs in any content—even if the target content or host site doesn't provide explicit support for track-backs. Indeed, the technology described here allows bloggers to leave track-backs and to create links in any document or any presented material—whether the material is from a website, a static document, the text of a book or magazine, a private document, a personal email, etc. It is also possible to create links and annotations to content that isn't yet available in digital form (e.g., that isn't yet published on the internet)—and even to content that doesn't yet exist. To accomplish this the annotation author specifies target material and/or anchor material that will be used whenever in future the target and/or anchor appear. As an example, an annotation author can specify target and anchor material taken from the print version of a book—which annotation will be invoked at such time as the book's content is presented to a user of the facility on a dynamic display.

In some embodiments of the described facility, targets and anchors can optionally include wild-cards and/or fuzzy-matching elements. Thus one can create an annotation associated with “IBM is a * company”—where the “*” character here represents any combination of words or characters.

A well-known means for accomplishing fuzzy matching is the use of regular expressions. Taking the example above, we can construct a proper regular expression for “IBM is a * company” as: “(IBM is a)([[:̂alnum:]].+?[[:̂alnum:]])(company)”. This regular expression locates the exact string “IBM is a”—followed by one non-alphanumeric character (e.g., whitespace or punctuation)—followed by an arbitrary string of characters—followed by one non-alphanumeric character—followed by the exact string “company”.

Tooltips and Tooltip Menus

A very useful user UI model is the use of a “tooltip” type pop-up annotation, and in some cases the described facility extends this model to include a menu within the tooltip pop-up. In one embodiment the logic for presenting this UI interaction is:

```
if(user-mouse is over target)
{
  display tool-tip with menu;
  while(user-mouse is over target or user-mouse is over associated tool-
  tip)
  {
    if(tool-tip-menu-item is selected by user)
    {
      perform selected menu action;
      break;
    }
  }
  dismiss tool-tip with menu;
}
```

Linking by Annotation

One use of the described annotation technology is as a means for forwarding references. Thus, instead of copying the content of an interesting article and forwarding it to an associate by email (in many cases a violation of copyright), and instead of forwarding a hyperlink to the desired article (which link may change, making the hyperlink unusable), a user can instead capture a small region containing specific content of interest and forward this presentation-association. Since the forwarded link is to the content (and/or it's anchor), the recipient is able to view the intended content—plus any associated annotations—regardless of how or where the intended content and/or anchors are stored.

In some embodiments the recipient of a forwarded annotation reference can manually search for the subject/target content of interest (and optionally its anchors) and thus view a copy of the intended content without receiving a copyright-infringing copy. In an alternative embodiment, the annotation reference is registered with a network-based server, which server keeps track of and/or searches for instances of the annotation content. Thus, the recipient of a forwarded annotation reference can query this network server to discover and view the intended content.

Connections Between Documents

The described facility can also be used to establish connections between documents and between document regions. In some embodiments an annotation associated with a location or range of material in one document is comprised of one or more pointers to locations or ranges of content in other documents (or to sub-regions of the same document). Thus the facility can be used to establish a rich linking of related elements across multiple “parallel” documents.

A special case of annotations representing document-to-document linking is the application of the described technology to varying versions of a single document. In this case the linking annotations indicate where content from a first document appears—perhaps in changed form—in a second version of the same document.

Another special case of annotations representing document-to-document linking is for translations. In one example, a first document in English with annotation links to a second document in Spanish. Note that the second, Spanish language document also has annotations links showing where the same or similar material appears in the English document.

Because some embodiments of the described facility allow the user to specify that target material and/or associated anchors can be approximate (i.e., the facility supports “fuzzy” matching), connections to any annotation, including the above-mentioned connections between “parallel” documents are quite robust against modest changes to the annotated material and associated anchors.

Automatic Document Connections

Many documents already carry implicit links or annotations. For example, many documents contain elements that refer to other elements in the same document. And many documents contain references to content in other documents, often in the form of quotations, specific chapter, section, or page references, etc. Citations are another example of where one document can often link to or reference another document.

Pre-existing links between documents can be automatically discovered by the described facility and converted to active annotations. Thus converted, a user could for example click with their mouse on a citation in one document and cause the cited document to me opened and displayed at the location cited, with the subject material of the citation specifically highlighted.

Reverse annotations are also supported by some versions of the described facility. Thus the citation subject material in the above example is also converted to an active annotation that links back to, and has as its subject, the original citation.

Similarly, much blog content is about other text material appearing in documents that do not appear in the blog itself. The described facility can automatically create annotations from references in a blog to the subject material in another document, and annotations in the referenced document can link back to the blog post. Note that this last form of annotation is a form of track-back—yet it can be accomplished by the described facility, using subject material and/or anchor material, even for sites or content that do not natively support track-back technology.

The table of contents, index, and bibliography in a document are other examples of where automatic annotations can be created by the described facility. Entries in a document's table of contents, index, or bibliography can be automatically or manually associated with annotations pointing to the content referenced, while the referenced content can be associated with annotations pointing to the table of contents, index, or bibliography entries.

Regular expressions and expert facility technology are two means by which the described facility can automatically recognize and create bi-directional annotations between a document's table of contents, index, or bibliography, and the material referenced in these elements.

In some embodiments the described facility will have cooperation from the user's operating facility to determine the text presented on the user's display, and optionally an indication of which portion of the presented text as been highlighted or otherwise selected by the user, as well as the location of that text on the display. Alternatively the application responsible for generating the presented text and for identifying the portions selected by the user will provide an API through which these details can be determined. As a further alternative, and in some cases where the source application does not expose an appropriate API, an “accessibility API” can be queried. Several modern operating facilities provide information about content presented on the user's display by means of an accessibility API for use by persons with visual disabilities. Such an API can communicate information about displayed text and other content, and this information can in turn be the source for queries to the described annotation server to obtain any related annotations.

In some embodiments, no cooperation from the Operating Facility or display-generating application is available or required. In these cases, one option is for the described facility to capture the displayed content from the host facility's display buffer (e.g., specific information about the individual pixels shown on the user's display), and then to use OCR or other display analysis/recognition techniques to establish the content being viewed by the user. In this situation, content selected by the user is discovered by analyzing the background color, underlining, etc., appearing with the displayed content.

Alternatively, the described annotation facility itself can provide selection and highlighting capabilities independent of the application displaying the content being viewed. For example, when the user of the facility wishes to select target content for annotation they can enter a mode (e.g., by a special keystroke combination or mouse/mouse button action) which then allows them to indicate (for example by highlighting) the target content of interest. In these embodiments the target of interest can be shown by highlighting specific areas of text or rectangular regions of interest, where the described facility creates semi-transparent overlays in the display buffer using widely available “alpha-layer” technology available in many computer video facilities.

Once the viewed content is discovered, an annotation server can be queried to locate any associations related to the displayed content.

Annotation Compensation Models

In order to motivate a large community to participate in providing rich annotation for a document, in some embodiments the various revenues associated with the document's use can be in some part distributed to the contributors of annotation. Thus advertising revenue, reprint or copyright-related revenues, click-though and other traffic-related revenues, etc., an be apportioned and shared across various contributors. In some embodiments the authors or sources of the most-viewed, or most-commented-on annotations receive a larger portion of these revenues. In some embodiments the reputation of the annotation source is also a factor in calculation shared revenues.

Separate Digital and Paper Experiences

In some embodiments it is useful to view the annotations of the described facility as being similar to the static and dynamic markup processes and layers described elsewhere herein. There is thus a strong similarity between the described annotations is the presentation of digital documents and the markup/annotations associated with rendered documents in the cited materials. In some embodiments of the described facility, the annotations associated and presented when digitally rendering documents are the same as, or similar to, those annotations shown when a user is capturing from and interacting with a printed or paper form of the document. In these embodiments it is often useful for the facility to distinguish between the paper/printed and the digitally-rendered user experiences. For example, in a digitally-rendered document, when the user highlights or selects a portion of text for which there are associated purchase opportunities, the user might be offered the opportunity to immediately visit Amazon.com and make a purchase; However, if the same portion of text is captured from a paper version of the same document using a portable hand-held optical scanner, the menu on the scanner might instead offer to remind the user of this purchase opportunity when they return to their desktop and synchronize their scanner to their Life Library. Thus in some embodiments it is useful if the described facility distinguishes between annotations and actions to be presented in a digitally-rendered context, from those to be presented in a printed or paper context.

Bi-Directional Annotation

In some embodiments it is useful if the same application that displays annotation content to the user is also used for receiving and adding new annotation content from the user. If considered as a “portal,” the described facility can, in some embodiments, function as a portal viewer that displays annotations for displayed content, and also as an editable “input-portal” for adding annotations to content being displayed. In some embodiments the described facility appears as one or more windows on the user's display, where annotations associated with any content displayed in these windows is made available for viewing. In some embodiments these same windows can serve as input means. In these cases the windows may have an associated “Edit” or “Annotate” button which, when selected, allows the user to add his or her annotations to the displayed content.

An alternative means for entering content in some embodiments is to select a point in the displayed content (e.g., by clicking at that point with a mouse), or to select a region of text in the displayed content (e.g., by clicking and dragging with a mouse), or to select a rectangular region containing various text and/or graphic elements of the displayed content (e.g., by clicking and dragging with a mouse to set a “rubber-band rectangle)—and then to enter a special keystroke or right-click with the mouse and select “add annotation.”

When adding annotations, some embodiments of the described facility also indicate to the user the automatically selected anchor text which can be used to retrieve the user's annotation when its target appears in subsequent rendering. Optionally, the user can manually set the anchor text.

Anchor Material and Target Material

“Anchor material” is content associated with an annotation which can be used both to trigger the presentation of an annotation and to trigger an indication that the annotation is present. Anchor material can optionally include the subject of the annotation itself, and it can optionally include surrounding or nearby content—often including material that appears just before and/or just after the annotation target material.

“Target Material” (here sometimes referred to simply as the “target” or the “subject”) is the specific material to which an annotation is meant to apply, or with which it is meant to be associated. Target material can be a contiguous range of text, a set of keywords (optionally in a specific order or within a specific distance of each other), an image or set of images, a specific location in a document, a geographical region or range-of-text region within a document, an entire document, a document or collection of content on a specific subject, etc.

One use of the anchor and subject materials is to trigger the indication or presentation of an annotation when the subject material for the annotation is itself not fully visible or presented. As one example, a user associates the annotation text and link: [purchase this at Amazon|http://www.amazon.com/item:CAPS-A520] with the subject material “Canon PowerShot A520 Digital Camera”. Also associated with this annotation is the pre-anchor “get started in digital photography: this package includes a” and the post-anchor “and a SELPHY CP510 Photo Printer, plus all required accessories”. As one example, a web site visitor scrolls their web-page view so that a portion of the pre-anchor and target material (“get started in digital photography: this package includes a Canon PowerShot”) are visible on their display, but the remainder of the anchor and subject material are not yet visible. Nonetheless, the associated annotation has correctly appeared.

In some cases, the target material or anchor material of an annotation may vary slightly in different presentations, but the user may desire that her or his annotation appear for some or all of these variations. Thus the subject text of an annotation may appear with different punctuation, capitalization, spelling, font, color, etc. In some embodiments the described facility allows the user to specify which variations should trigger the user's annotations and which should be ignored.

One useful means of describing how close to the original target material a specific rendering must be is to specify a limiting “edit distance,” which is a well-known metric for the similarity of two text samples. Optionally, the user may specify whether variations in punctuation, capitalization, spelling, etc., are to be accepted and thus trigger the presentation of a particular annotation.

Annotation Context

“Context selection” here refers to the process whereby a user of the described facility establishes the specific contexts or circumstances in which they wish their annotations to appear. Context selection can include specific volumes, issues, versions or copies of an article for which the annotation is to be displayed, specific users or groups of users who are to be allowed access to the annotation, a fee or charge which must be paid for viewing or accessing the annotation, the anchor text and target material that is required to be present for the annotation to be made available, etc.

In some embodiments, the described facility indicates to the user other documents and contexts which contain the user's selected target and/or have the same anchor text—i.e., those documents that would invoke the annotation when displayed. Some of these embodiments also allow the user to browse these alternative presentation contexts to see in exactly which contexts/situations their annotations would appear. Some embodiments further allow the user to select or de-select contexts in which they do or don't want their annotation to appear.

In some embodiments context selection includes logical operations and combinations. For example a user may want the above mentioned “[purchase this at Amazon|http://www.amazon.com/item:CAPS-A520]” annotation only to be presented if the subject material “Canon PowerShot A520 Digital Camera” occurs in a non-commercial context—e.g., if the web-page containing the reference does not include either of the keywords “buy” or “purchase,” and also does not include any direct links to an e-commerce site.

A further application of context for applications is the ability for the users of the described facility to specify how much (if any) anchor text or nearby content is required for the subject annotation to be displayed. In cases where a user is annotating a single word or short phrase, the described facility allows them to choose whether they only want their annotation to appear whenever the short phrase occurs, or only in certain documents, with specific anchor text, etc.

Interactions with a Handheld Scanner

One means of creating annotations for digitally-presented material is for the user to indicate target location or target material by means of a hand-held scanner that can interact with a digital display. Such a scanner might either read presented content directly from the viewable displayed content, or might instead first determine its position on the display and then establish the target content by querying the described facility for the content displayed at that position (to mention two of several possible means).

Similarly a handheld scanner can be used in some embodiments to interact with and respond to annotations displayed on a dynamic display, again using techniques such as those mentioned above.

One advantage of using a handheld scanner for either creating or interacting with dynamically displayed content is that the scanner itself, being a hardware device separate from the user's computer, can create a secure environment which makes computer and network related transaction both easy and secure. For example, because the described scanner can incorporate security, encryption, and authentication elements, etc., interactions involving annotations can avoid many of the classic dangers of a simple computer-and-network environment (phishing, spoofing, man-in-the-middle attacks, etc.).

In some cases a handheld-scanner creates a secure environment by communicating separately with a network based server to validate and authenticate any proposed transaction. For example in the case where the handheld scanner is a cellular phone, or a scanner communicating with a cellular phone, the separate communication can occur across the cellular network, separate from the internet connection used by the user's computer. In another embodiment the handheld scanner communicates using the same physical network connection as the user's computer, but using a separate secure channel (for example, an encrypted https session).

Annotation Privacy and Security

Whether a handheld scanner is used to interact with displayed annotations, or whether software executing on the user's computer is responsible for these interactions, the described facility of presentation-layer interactions has security advantages over conventional approaches for interacting with dynamically displayed content. In many conventional environments—for example when a user is viewing and interacting with web content through a web browser—the same application that presents the content and interaction opportunities (here, the web browser) is also responsible for completing or fulfilling the interaction (whether that interaction is the creation of an annotation or responding to the presentation of an existing annotation). By contrast, in the described facility these components can be separated—thus requiring anyone attempting to interfere or intervene in the interaction to infiltrate (and coordinate) both components of the facility.

An existing annotation interaction is being presented in a user's dynamic display it the form of a menu of choices. However, the facility that displayed the original content was a conventional web browser (it could just as well have been an email client, word processor, etc.), white the annotation interaction was generated and is being generated by an entirely separate facility or application executing on the user's computer. Moreover, any interactions with the presented annotation are captured by and communicated or executed by the separate application—so fraudulent activity or content in the web browser does not have access to the user's private data and purchasing/financial information controlled by the separate application.

An application such as a web browser displays content on the user's dynamic display. The described facility captures information being displayed to the user. At one or more signatures are derived from the captured information. The derived signatures are sent to annotation server to determine whether there exist any associated annotations for the content being displayed. An annotation associated with the phase “Canon PowerShot A520 Digital Camera” is returned to the application and displayed as a menu in association with the original content on the user's display.

A user's subsequent interaction with a displayed annotation may be as follows. The user has selected one of the displayed annotation menu items, “Buy at Amazon.” The user's selection choice is communicated by application via a secure communications channel to the annotation fulfillment server. The fulfillment server creates a secure connection to the amazon.com site, provides the user's private shipping and financial data, and presents the Amazon shopping cart view to the user. Note that the original web browser that presented the content being annotated is not required in the subsequent purchasing activities.

Logging Displayed Content

In some embodiments of the described facility a record is kept of various content displayed to the user. Typically this record is stored as a chronological log of all content presented. When available, the source application that presented the information is also recorded, as is the url or document locator for the source material itself. Additional context information, such as time of day, physical location of the user's computer, etc., is also captured. The log created by this process makes it possible for the user to search through material displayed or viewed in the past to locate items of interest.

In some embodiments the described facility only captures and logs material from the application that has the focus on the user's display. In some embodiments, only material that remained stationary for a fixed amount of time or that scrolled at less than a fixed rate (these times and rates indicating that the user would have had time to read or comprehend the displayed material) is captured to the log.

Logic elements are used to construct a meaningful history of viewed material, even when the user may have scrolled to arbitrary locations in a document in arbitrary order. When the document is known (e.g., when document metadata is available), the composition/content of the document is easily stored and the user's path through the document is then additionally recorded so that the chronological record indicates the order in which, and time at which, material was viewed. However, in cases where document metadata is not available, the serial order of the document content is logically constructed where possible by analyzing the overlapping portions of presented material as the user scrolls or pages up or down in the document.

Even when the complete serial composition of a document cannot be recovered from the material displayed to the user (as when the user jumps rapidly from place to place in the document) those elements that were the subject of the users attention—e.g., those views that were visible on the display for enough time for the user to have considered them, are captured into the log—along with temporal data indicating when and how long each view was presented.

Thus the described facility can keep track of every document a user opens/views, when this activity occurs, how much time was spent viewing which material, etc. With the additional feature that this historical content can be searched, the described facility becomes a valuable memory aid and repository of content having value for the user. In addition the described facility provides a layer of annotation interactions and supplemental annotation-based information for most or all of the content viewed by the user.

And because the proposed facility can optionally function without cooperation from an application displaying content to the user, without cooperation from the user's operating facility, without cooperation from the website host, website designer, document author, application developer, etc., it creates a rich and uniform computing experience that includes active annotations on any displayed content.

Notifications

Some embodiments of the described facility include a feature to notify a document author, annotation author, or other interested parties (e.g., publishers, editors, bloggers, etc.) when subsequent annotations are added to a document.

Some embodiments include a similar feature that provides notification when specific individuals or group members add annotations to specific documents.

For example these features would allow a user to be notified when a particular prominent blogger adds an annotation to any document, an author to be notified whenever annotations are added to their authored works, a periodical publisher to be notified when any annotation is added to the most recent online issue of their publication, etc.

Such notifications can be delivered by email, as RSS feeds of the annotated content and annotations, etc.

Additionally, the described facility supports notifications when annotations themselves are the subject of additional commentary or annotation.

Groups, Filtering, and Permissions

The described facility allows groups of individuals to share annotations, and to prevent individuals outside the group from viewing these annotations. Individual annotations can optionally include permissions describing who is allowed to view or receive them. Thus even when many annotations from many users are stored on a single annotations server, private annotations created by and viewable by individuals and groups are possible. Alternatively, user's can create and publish “public” annotations viewable by anyone.

Because annotations can potentially come from any source, the ability to add annotations in the described facility may be restricted to certain individuals. For example, only individuals having registered with the facility, or having paid a subscription fee, or having possession of a secure hardware device recognized by the facility (for example, a device containing a SIM card such as is used in mobile phones) may be allowed to annotate.

Also because annotations can potentially come from any source, some embodiments of the described facility include filtering technology that allows the user to select which annotations they want to receive. Filtering options include limiting received annotations to those authored by specific individuals or groups of individuals, those containing (or not containing) commercial opportunities (including advertisements), those belonging to a particular class (for example, including individual editorial comment and opinion, but excluding paid or corporate commentary), etc. In some embodiments, the facility provides an application preferences pane for setting some of these filtering options.

Encrypting Annotations and Anchors

Some embodiments of the described facility include means for completely private viewing of content and completely private sharing of annotations. User A creates an annotation for viewed content, an article they noticed on a public website. User A's annotation and its associated anchor is encrypted on User A's local machine with an encryption key known only to User A and User B. The encrypted annotation and encrypted anchor are transmitted to a central annotation server. User B receives an email of an article containing the content annotated by User A. The content being viewed by User B is also encrypted with the same private key used by User A, and the result is sent to the central annotation server. Since the annotation server is not in possession of the key it cannot determine what User B is reading. However, it determines that the encrypted result from User B matches the encrypted content annotated by User A. Accordingly, the annotation server delivers User A's (encrypted) annotation to User B, where User B's application decrypts it using the shared key and presents the decrypted annotation to User B.

In some embodiments a simple checksum (for example, MD5) is used to indicate the content being annotated by User A and read by User B without disclosing the nature of the content. When the annotation server determines that the checksums from User A and User B agree it delivers the appropriate annotation—never knowing the actual content that was annotated and subsequently read.

Dynamic Annotations

In some embodiments of the described facility annotations are created automatically and dynamically, rather than manually by an individual. In some cases the means for accomplishing this is via regular expressions, which can be used to identify various classes of content, with which appropriate annotations can be associated. Content objects that are particularly appropriate for this process are those that have a regular format or organization (and thus are identifiable by regular expressions), and those that belong to a finite set (and thus can be entered in a list or database).

In the regular expression group are content elements such as phone numbers, email addresses, URLs, physical addresses, concerts and other events, proper names (first, middle, and last—and often identifiable by titles and capitalization), etc. In the list/database group are company names, personal names (first, middle, last), geographical place names, book titles, movie titles, product names and part/model numbers, infrequent or esoteric words, etc.

For each class of object in the above regular expression and list/database groups the described facility can provide one or more standard annotations that can optionally be presented when the associated objects and/or their associated anchors are displayed. For example, any book title can automatically trigger an annotation that includes a link to recent reviews of that book and to opportunities to purchase the book from an e-commerce or conventional bookstore. Similarly, any presentation of a phone number can automatically generate an annotation offering to add that phone number to the user's contact list, or to automatically dial the number from a network-based phone facility and connect the call to whichever phone is nearest the user. And each infrequent or esoteric word can generate an annotation that offers to provide a dictionary definition, pronunciation, or to display the word is alternative contexts.

In some cases the described facility can automatically find related information for displayed content. For example any displayed reference to a company name can optionally be displayed as a hyperlink, where the described facility has searched for the website associated with the mentioned company and automatically generated an annotation with a link pointing to that URL.

Update Notifications

In some embodiments the described facility makes use of display update notifications from an operating facility or application to determine which regions of the user's display have been updated with new information. In this way only changed regions need to be analyzed by the facility to determine if new content is available and new annotation queries to the annotation server are potentially required.

Alternatively, the entire display—or that region of the display selected by the user for annotations—can be checked periodically by the described facility. One means of such checking is by comparing portions of the display buffer to an earlier copy of itself—typically a copy cached when the annotation server was last queried.

To avoid comparing every pixel of a display buffer to an earlier cached version of itself, some embodiments of the facility employ a sparse testing approach: only selected pixels are tested to see if they have changed. In some embodiments these test pixels are selected for their high likelihood of changing. For example, pixels on the boundary between foreground characters and the displayed background are very likely to change when new text is displayed.

In some embodiments, the facility pre-fetches annotations for entire document if metadata is known.

Temporal Attributes of Annotations

Some embodiments of the described facility make use of the temporal relationship and source address (e.g., IP address) of queries received by the annotation server to infer relationships between otherwise independent annotations. For example, when a sequence of queries is received by the annotation server from a single IP address or proximate in time, it is likely that these queries come from a single document. Keeping track of this implied relationship then allows the annotations server to deliver annotations for local caching on the user's machine, even in the absence of document metadata—i.e., even when the queries to not include this information.

Manually Establishing Annotations

Highlight in document using native highlight mode.

Right-click on highlight, menu option includes question/option: Annotate.

Target of annotation is taken as highlighted region.

May optionally simply click at any point and add an annotation—here the assumed range is zero.

If the “Annotate” menu item is selected, optionally the extent of the anchor text before and/or after the annotation is also indicated—for example, in another highlight color. A dialog box is then presented to accept text or other annotations. Within the same dialog box are optionally other annotation choices, such as:
Create a link to other content (e.g., add one or more hyperlinks)
Record a voice annotation, or create a link pointing to audio content
Create a link to video content
Create a link or association to image content one or more pictures
Create a link to a commercial opportunity (e.g., the web address at Amazon.com where an item associated with the annotation can be purchased.

### CONCLUSION

From the foregoing, it will be appreciated that specific embodiments of the invention have been described herein for purposes of illustration, but that various modifications may be made without deviating from the spirit and scope of the invention. For example, the capture, storage, and display capabilities of the facility may be utilized independent of each other. Accordingly, the invention is not limited except as by the appended claims.

We claim:

1. A system for receiving annotations from a user for placement on text that is viewable by the user on a viewing device, the system comprising:
a capture component for capturing an image that is viewable by the user on the viewing device;
an optical character recognition component for processing the image that is viewed on the viewing device and identifying any text contained in the image; and
an annotation capture component for receiving an annotation and a location of the annotation with respect to the image from a user, the annotation capture component determining a corresponding position of the annotation with respect to the identified text and storing the annotation and the corresponding position of the annotation with respect to the identified text in a manner that allows the annotation to be retrieved and displayed in conjunction with the identified text.

2. The system of claim 1, wherein the position of the annotation is characterized by a text segment.

3. The system of claim 2, wherein the text segment is comprised of a portion defined by the user and a portion defined by a viewing device.

4. The system of claim 2, wherein the text segment is defined by the user.

5. The system of claim 1, wherein the image is a proper subset of content that is viewable on the viewing device.

6. The system of claim 1, wherein the image is captured from a screen buffer of the viewing device.

7. A system for displaying annotations on content that is viewed by a user on a viewing device, the system comprising:
a capture component for capturing an image of content that is viewed by the user on the viewing device;
an optical character recognition component for processing the image of content that is viewed on the viewing device and identifying any text contained in the content; and
an annotation display component for displaying annotations on content, the annotation display component:
transmitting at least a portion of the identified text to an annotation service; and
receiving from the annotation service an annotation and a position of the annotation that is associated with the transmitted portion of identified text, the annotation display component determining a corresponding location of the received annotation with respect to the image of content and displaying the received annotation on the content.

8. The system of claim 7, wherein the position of the annotation is characterized by a text segment.

9. The system of claim 7, wherein the image is a proper subset of the content that is viewed on the viewing device.

10. The system of claim 7, wherein the image is captured from a screen buffer of the viewing device.

11. The system of claim 7, wherein the annotation display component displays the received annotation by superimposing the annotation over the image of the content.

12. The system of claim 11, wherein received annotation is displayed on a transparent layer that is overlaid on the image of the content.

13. A method of providing one or more annotations for display in association with content, the method comprising:
receiving an indication of a text sequence that is contained in content;
comparing the indication of the received text sequence with a plurality of stored text sequences, each of the plurality of stored text sequences having one or more annotations associated with the stored text sequence;
identifying one of the plurality of stored text sequences that is matched to the received text sequence based on the comparison of the received text sequence with the plurality of stored text sequences; and
providing one or more of the annotations associated with the identified stored text sequence so that the provided one or more annotations may be displayed in association with the received text sequence in the content.

14. The method of claim 13, wherein the content is a document.

15. The method of claim 13, wherein the content is a web page.

16. The method of claim 13, wherein the identified stored text sequence and the received text sequence are exact matches.

17. The method of claim 13, wherein the identified stored text sequence and the received text sequence are close matches.

18. A method of storing user annotations in an annotation data store for subsequent retrieval and display, the method comprising:
receiving an indication from a user of a position in first content for the placement of an annotation;
receiving the annotation from the user;
transmitting the received annotation and the received indicated position for the placement of the annotation to an annotation data store; and
storing the annotation in association with the indicated position for the placement of the annotation in the annotation data store, wherein the indicated position is represented by a text segment in the first content and the representation of the text segment is used to determine the placement of the annotation in second content other than the first content.

19. The method of claim 18, wherein the annotation data store is remote from the user.

20. A method in a computing system for displaying visual information indirectly associated with text displayed on a display device, comprising:
obtaining data representing an image displayed on the display device;
automatically recognizing text occurring in the image represented by the obtained data;
identifying visual information associated with a portion of the automatically recognized text; and
displaying the identified visual information in connection with a portion of the displayed image in which the portion of text occurs.

21. The method of claim 20 wherein the identifying uses an association between the portion of text and the associated visual information.

22. The method of claim 20, further including identifying a location in a document whose text occurs in the image represented by the obtained data, and wherein the identifying uses an association between (a) the identified document and location and (b) the associated visual information.

23. The method of claim 22 wherein a computer system is causing the display device to display the image,
and wherein the document and location are identified by querying a programmatic interface of a program executing on the computer system.

24. The method of claim 22 wherein the document and location are identified by comparing the portion of the automatically recognized text to text contained by a corpus of documents including the identified document.

25. The method of claim 20 wherein the displayed visual information indicates a user-generated annotation.

26. The method of claim 20 wherein the displayed visual information indicates an automatically-designated action that can be performed by a user viewing the displayed visual information.

27. The method of claim 26 wherein the indicated action is purchasing a product identified by the portion of the automatically recognized text.

28. The method of claim 26, further comprising:
receiving text captured by a user using a handheld text capture device, the captured text matching the portion of the automatically recognized text; and
in response to the receipt of the captured text, indicating the automatically-designated action to the user who captured the received text.

29. The method of claim 20 wherein the displayed visual information is an advertising message associated with the portion of the automatically recognized text.

30. A computer system for presenting application-independent annotations for displayed textual content, comprising:
a display device that dynamically displays an image; and
a processor executing programs, including:
a text-displaying program that causes the image dynamically displayed by the display device to include a distinguished body of text, and
an annotation program that, for any text-displaying program:
obtains a copy of the image dynamically displayed by the display device;
recognizes in the obtained copy of the image the distinguished body of text;
identifies one or more annotations, each of the identified annotations being associated with at least a portion of the distinguished body of text; and
for each identified annotation, causes the image dynamically displayed by the display device to include a visual indication of the annotation proximate to the portion of the distinguished body of text with which the annotation is associated.

31. The computer system of claim 30, wherein the annotation program further:
receives a selection of a portion of the distinguished body of text;
receives contents for a new annotation associated with the selected portion of the distinguished body of text;
creates a new annotation associated with the selected portion of the distinguished body of text having the received content; and
causes the image dynamically displayed by the display device to include a visual indication of the created annotation proximate to the selected portion of the distinguished body of text.

32. The computer system of claim 30 wherein the selection of a portion of the distinguished body of text and the new annotations contents are received from a distinguished user,
and wherein the annotation program presents the new annotation to at least one user other than the distinguished user.

33. A method in a computing system having a display device for portraying human reading activity of a user, comprising:
at each of a plurality of points in time during a period of time, while the computing system is being operated by the user:
obtaining data representing an image displayed on the display device;
automatically recognizing text occurring in the image represented by the obtained data;
storing in a log for the point in time information identifying the automatically-recognized text; and
using the contents of the log to display a visual depiction of at least a subrange of the plurality of points in time, organized in time-order, containing some information about the text identified by information stored in the log for each point in time.

34. The method of claim 33, further comprising:
receiving user input selecting from the visual depiction one of the plurality of points in time; and
displaying text including at least a portion of the automatically-recognized text identified by the information stored in the log for the point in time.

35. The method of claim 33, further comprising:
at each of a plurality of additional points in time during the period of time, while a handheld text capture device is being operated by the user:
receiving text captured from a paper document by a user; and
storing in the log information for the point in time identifying the received text,
and wherein the displayed visual depiction further depicts at least a subrange of the plurality of additional points in time.

36. The method of claim 33 wherein the information identifying the automatically-recognized text stored in the log is a copy of the automatically-recognized text.

37. The method of claim 33, further comprising identifying a location in an electronic document contained by a corpus of electronic documents at which the automatically-recognized text occurs,
and wherein the information identifying the automatically-recognized text stored in the log is information designating the identified location in the identified electronic document.

38. The method of claim 33 wherein the information stored in the log further indicates a length of time for which the automatically-recognized text occurred in the image displayed on the display device,
and wherein this amount of time is depicted in the visual depiction.
